(19) United States
(12) Patent Application Publication
(10) Pub. No.: US 2025/0258951 A1
(43) Pub. Date: Aug. 14, 2025

(54) SYSTEMS AND METHODS FOR ZERO-KNOWLEDGE PROOF (ZKP) MODELING

(71) Applicant: AS0001, Inc., Carmel, IN (US)

(72) Inventor: Jonathan J. Thompson, Carmel, IN (US)

(73) Assignee: AS0001, Inc., Carmel, IN (US)

(21) Appl. No.: 19/170,040

(22) Filed: Apr. 3, 2025

Related U.S. Application Data
(63) Continuation-in-part of application No. 19/044,418, filed on Feb. 3, 2025.
Application No. 19/044,418 is a continuation of application No. 18/627,926, filed on Apr. 5, 2024, now Pat. No. 12,216,786.
Application No. 18/627,926 is a continuation-in-part of application No. 18/203,630, filed on May 30, 2023.
(60) Provisional application No. 63/457,671, filed on Apr. 6, 2023.
(60) Provisional application No. 63/347,389, filed on May 31, 2022.

(51) Int. Cl. G06F 21/62; G06Q 40/08

(52) U.S. Cl. CPC G06F 21/6218; G06Q 40/08

(57) ABSTRACT

Systems, methods, and/or computer readable storage media for protecting data. A system can include one or more processing circuits configured to receive or identify at least one token including cyber resilience data of at least one entity and corresponding with at least one posture or compliance parameter of at least one third party The one or more processing circuits can perform a zero-knowledge proof (ZKP) on the cyber resilience data, determine at least one posture or compliance parameter of the at least one third party is satisfied based on the cyber resilience data, and/or generate at least one ZKP including at least one cryptographic commitment obfuscating the cyber resilience data. The one or more processing circuits can provide, to at least one third party computing system of the at least one third party, the at least one ZKP or indication of performance of the at least one ZKP.

### CROSS-REFERENCE TO RELATED PATENT APPLICATIONS

The present application is a Continuation-In-part of U.S. Non-Provisional patent application Ser. No. 19/044,418, filed Feb. 3, 2025, which is a continuation of U.S. Non-Provisional patent application Ser. No. 18/627,926, filed Apr. 5, 2024, which is a Continuation-In-Part of U.S. Non-Provisional patent application Ser. No. 18/203,630, filed May 30, 2023, which claims the benefit of U.S. Provisional Patent Application No. 63/457,671, filed Apr. 6, 2023 and U.S. Provisional Patent Application No. 63/347,389, filed May 31, 2022, each of which is incorporated herein by reference in its entirety and for all purposes.

### BACKGROUND

The present disclosure relates generally to computer security architecture and software for information security and cybersecurity. In a computer networked environment, entities such as people or companies have vulnerabilities that can result in security incidents. Some entities can desire to implement protections, and some entities can desire to offer protections.

### SUMMARY

Some implementations relate to a method including receiving or identifying, by one or more processing circuits, at least one token including cyber resilience data of at least one entity, the cyber resilience data corresponding with at least one posture or compliance parameter of at least one third party. In some implementations, the method can include performing, by the one or more processing circuits, a zero-knowledge proof (ZKP) on the cyber resilience data by determining at least one posture or compliance parameter of the at least one third party is satisfied based on the cyber resilience data and generating at least one ZKP of the cyber resilience data. In some implementations, the at least one ZKP includes at least one cryptographic commitment obfuscating the cyber resilience data. In some implementations, the method can include providing, by the one or more processing circuits to at least one third party computing system of the at least one third party, the at least one ZKP or indication of performance of the at least one ZKP.

In some implementations, the cyber resilience data corresponds with attestation data, safeguard data, incident data, effectiveness data, or protectability data of the at least one entity, and/or the at least one cryptographic commitment verifies the at least one posture or compliance parameter is satisfied and protects the attestation data, safeguard data, incident data, effectiveness data, or protectability data.

In some implementations, the at least one token includes at least one of a unified attestation token, a unified safeguard token, an incident readiness token, an effectiveness token, or a protectability token, and/or the cyber resilience data obfuscated by the at least one ZKP includes one or more configurations of security controls, internal compliance reports or assessments, or incident histories and responses.

In some implementations, the method can include receiving, by the one or more processing circuits via an application programming interface (API), a verification request including the at least one posture or compliance parameter of the at least one third party. In some implementations, the method can include transmitting, by the one or more processing circuits via the API, a response to the verification request including the at least one ZKP or the indication of performance of the at least one ZKP to a third party computing system of the at least one third party. In some implementations, the API restricts access between a public environment and the cyber resilience data of a protected environment, the public environment corresponds to a plurality of third party computing systems, the protected environment includes the one or more processing circuits and communication is restricted based at least on (i) transmitting the response including the ZKP and (ii) protecting the cyber resilience data from the public environment.

In some implementations, determining the at least one posture or compliance parameter is satisfied can be based at least on modeling, by the one or more processing circuits, one or more attributes of the cyber resilience data and one or more values or conditions corresponding with the at least one posture or compliance parameter to determine the one or more attributes satisfy the one or more values or conditions.

In some implementations, generating the at least one ZKP includes determining, by the one or more processing circuits, one or more attributes of the cyber resilience data corresponding to the at least one posture or compliance parameter. In some implementations, generating the at least one ZKP includes applying, by the one or more processing circuits, one or more transformations, logical operations, or aggregations to one or more attributes. In some implementations, generating the at least one ZKP includes hashing, by the one or more processing circuits, the one or more attributes. In some implementations, generating the at least one ZKP includes generating, by the one or more processing circuits, the at least one cryptographic commitment based on the one or more attributes and the one or more transformations, logical operations, or aggregations.

In some implementations, the method can include validating, by the one or more processing circuits, the at least one ZKP based at least one on cross-referencing the at least one cryptographic commitment with one or more expected values derived from the one or more transformations, logical operations, or aggregations.

In some implementations, generating the at least one ZKP includes applying, by the one or more processing circuits, at least one of a zero-knowledge succinct non-interactive arguments of knowledge (zk-SNARKs) protocol or a zero-knowledge scalable transparent arguments of knowledge (zk-STARKS) protocol.

In some implementations, the method can include generating, by the one or more processing circuits, the at least one token based at least on embedding the at least one ZKP into a structured data object. In some implementations, the method can include, responsive to a data exchange between one or more nodes of a decentralized network, centralized network, or data source, providing, by the one or more processing circuits, the at least one ZKP, wherein the data exchange corresponds to a transfer of at least a portion of the cyber resilience data.

Some implementations relate to a system including one or more processing circuits configured to receive or identify at least one token including cyber resilience data of at least one entity, the cyber resilience data corresponding with at least one posture or compliance parameter of at least one third party. In some implementations, the one or more processing circuits can be configured to perform a zero-knowledge proof (ZKP) on the cyber resilience data. In some implementations, the one or more processing circuits can determine at least one posture or compliance parameter of the at least one third party is satisfied based on the cyber resilience data and generate at least one ZKP of the cyber resilience data, and/or the at least one ZKP can include at least one cryptographic commitment obfuscating the cyber resilience data. In some implementations, the one or more processing circuits can be further configured to provide, to at least one third party computing system of the at least one third party, the at least one ZKP or indication of performance of the at least one ZKP.

In some implementations, the cyber resilience data corresponds with attestation data, safeguard data, incident data, effectiveness data, or protectability data of the at least one entity, and/or the at least one cryptographic commitment verifies the at least one posture or compliance parameter is satisfied and protects the attestation data, safeguard data, incident data, effectiveness data, or protectability data.

In some implementations, the at least one token includes at least one of a unified attestation token, a unified safeguard token, an incident readiness token, an effectiveness token, or a protectability token, and/or the cyber resilience data obfuscated by the at least one ZKP includes one or more configurations of security controls, internal compliance reports or assessments, or incident histories and responses.

In some implementations, the one or more processing circuits can be configured to receive, via an application programming interface (API), a verification request including the at least one posture or compliance parameter of the at least one third party. In some implementations, the one or more processing circuits can be configured to transmit, via the API, a response to the verification request including the at least one ZKP or the indication of performance of the at least one ZKP to a third party computing system of the at least one third party. In some implementations, the API restricts access between a public environment and the cyber resilience data of a protected environment, the public environment corresponds to a plurality of third party computing systems, the protected environment includes the one or more processing circuits and communication is restricted based at least on (i) transmitting the response including the ZKP and (ii) protecting the cyber resilience data from the public environment.

In some implementations, to determine the at least one posture or compliance parameter is satisfied the one or more processing circuits can be configured to model one or more attributes of the cyber resilience data and one or more values or conditions corresponding with the at least one posture or compliance parameter to determine the one or more attributes satisfy the one or more values or conditions.

In some implementations, to generate the at least one ZKP, the one or more processing circuits can be configured to determine one or more attributes of the cyber resilience data corresponding to the at least one posture or compliance parameter. In some implementations, to generate the at least one ZKP, the one or more processing circuits can be configured to apply one or more transformations, logical operations, or aggregations to one or more attributes; hash the one or more attributes. In some implementations, to generate the at least one ZKP, the one or more processing circuits can be configured to generate the at least one cryptographic commitment based on the one or more attributes and the one or more transformations, logical operations, or aggregations.

In some implementations, the one or more processing circuits can be configured to validate the at least one ZKP based at least one on cross-referencing the at least one cryptographic commitment with one or more expected values derived from the one or more transformations, logical operations, or aggregations.

In some implementations, to generate the at least one ZKP, the one or more processing circuits can be further configured to apply at least one of a zero-knowledge succinct non-interactive arguments of knowledge (zk-SNARKs) protocol or a zero-knowledge scalable transparent arguments of knowledge (zk-STARKS) protocol.

In some implementations, the one or more processing circuits can be configured to generate the at least one token based at least on embedding the at least one ZKP into a structured data object. In some implementations, the one or more processing circuits can be configured to, responsive to a data exchange between one or more nodes of a decentralized network, centralized network, or data source, provide the at least one ZKP, wherein the data exchange corresponds to a transfer of at least a portion of the cyber resilience data.

Some implementations relate to a non-transitory computer readable medium (CRM) including one or more instructions stored thereon and executable by one or more processors to receive or identify at least one token including cyber resilience data of at least one entity, the cyber resilience data corresponding with at least one posture or compliance parameter of at least one third party. In some implementations, the one or more instructions can be executable to perform a zero-knowledge proof (ZKP) on the cyber resilience data by determining at least one posture or compliance parameter of the at least one third party is satisfied based on the cyber resilience data and generating at least one ZKP of the cyber resilience data. In some implementations, the at least one ZKP includes at least one cryptographic commitment obfuscating the cyber resilience data. In some implementations, the one or more instructions can be executable to provide, to at least one third party computing system of the at least one third party, the at least one ZKP or indication of performance of the at least one ZKP.

In some implementations, the cyber resilience data corresponds with attestation data, safeguard data, incident data, effectiveness data, or protectability data of the at least one entity, and/or the at least one cryptographic commitment verifies the at least one posture or compliance parameter is satisfied and protects the attestation data, safeguard data, incident data, effectiveness data, or protectability data.

### BRIEF DESCRIPTION OF THE DRAWINGS

FIG. 1 depicts a block diagram of an implementation of a security architecture for posture-based modeling, according to some implementations.

FIGS. 2A-2B depicts a block diagram of a zero-knowledge proof (ZKP) model, according to some implementations.

FIG. 3 depicts a block diagram of a more detailed architecture of certain systems or devices of FIG. 1, according to some implementations.

FIG. 4 depicts a flowchart for protecting data, according to some implementations.

FIG. 5 depicts a block diagram of an implementation of a system for cyber resilience tokenization, according to some implementations.

FIG. 6 depicts a block diagram of another architecture of certain systems or devices of FIG. 5, according to some implementations.

FIG. 7 depicts a block diagram of another architecture of certain systems or devices of FIG. 5, according to some implementations.

FIG. 8 depicts a block diagram of a token dependency system for tokenized cyber resilience data, according to some implementations.

FIGS. 9A-9I depict an architecture for tokenized cyber resilience data, according to some implementations.

FIG. 10 depicts a flowchart for a method of modeling cyber resilience data using cyber resilience identities and associated metadata, according to some implementations.

FIG. 11 depicts a block diagram of an implementation of a system for zero-knowledge proof (ZKP) modeling, according to some implementations.

FIG. 12 depicts a block diagram of a system for zero-knowledge proof (ZKP) modeling, according to some implementations.

FIG. 13 depicts a flowchart for a method of zero-knowledge proof (ZKP) modeling, according to some implementations.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Referring generally to the FIGURES, systems and methods relate generally to implementing a cybersecurity framework. In some implementations, the system represents an implementation of a security architecture for zero-knowledge proof (ZKP) modeling.

Many existing cybersecurity systems and architectures face several challenges that limit effectiveness in securing data. In some implementations, the systems and methods described herein address technical challenges associated with existing cybersecurity frameworks through the implementation of a zero-knowledge proof (ZKP) architecture. For example, systems or networks can fail to protect sensitive data stored, transmitted, or shared between computing systems. That is, the transmission of cyber resilience data during data exchanges, verifications, or other operations can introduce privacy risks or data vulnerabilities. Some systems can expose, or share exchanged cyber resilience data to third parties for various purposes or operations, such as compliance verification or data validation. However, exposing data to third parties can increase risk of interception, unauthorized access, breaches, or misuse by reducing the confidentiality and security of the data transfer or operation. Additionally, some systems or networks can store entity data or compliance data for validation, but stored entity data can become vulnerable to unauthorized access or breaches during cyber incidents affecting the entity or a third party with access to the entity data.

The systems and methods of the present disclosure addresses these technical challenges by generating zero-knowledge proofs (ZKPs) to verify aspects or exchanges of cyber resilience data and protect underlying data used for verification. For example, the disclosed systems and methods can generate cryptographic commitments that obfuscate cyber resilience data, such as configuration data, implemented safeguards, or assets associated with an entity computing and networking infrastructure, which reduces the risk of data exposure or unauthorized access to the cyber resilience data during security incidents, data exchanges, or resilience operations. In another example, the disclosed systems and methods can provide verifiable proof (e.g., ZKPs) that one or more posture or compliance parameters are satisfied (e.g., an exchange is validated, an entity qualifies for protections, etc.) while safeguarding the underlying data used for the verification. That is, by embedding ZKPs into structured data objects or tokens, the systems and methods disclosed herein improve cybersecurity and resilience of entity computing devices or networks by providing proof or verifications to third party computing systems while preserving confidentiality and integrity of the underlying cyber resilience data. For example, a third party computing system can verify the satisfaction of compliance parameters through a provided ZKP without accessing attestation data, safeguard configurations, incident histories, or security control attributes used to determine the compliance parameters are satisfied, which improves cybersecurity by preventing direct disclosure of sensitive cybersecurity information and reducing risks of data breaches, inadvertent exposure, or misuse. That is, by implementing cryptographic protocols or structures (e.g., zero-knowledge proofs) that provide verifiable evidence of a fact of compliance while protecting or securing the underlying data used to determine the fact, the systems and methods presented herein address technical challenges associated with providing verifiable proof of compliance or validation without exposing underlying or sensitive data, thereby reducing the risk of unauthorized access, data breaches, or other security vulnerabilities during exchanges or operations.

Another technical challenge includes a lack of integrated incident response capabilities in cybersecurity frameworks. In particular, many existing systems operate in silos, with separate tools for threat detection, response, and/or recovery. This lack of integration can lead to delays in response times, miscommunication between teams, and/or a lack of overall visibility into the security posture of an organization. Another problem is the lack of streamlined processes for engaging with third party vendors for incident response services. Organizations often have to navigate through complex procurement processes during a cyber incident, losing crucial time that could be used to mitigate the incident. Additionally, organizations often struggle to accurately assess their readiness to respond to incidents. They lack clear visibility into their own capabilities and limitations, and/or often don't have an effective way to communicate this information to potential response providers. Yet another problem with existing cybersecurity systems and architectures is the inability to dynamically adapt to changes in the security landscape. Many existing systems employ static defenses that are unable to adjust to new threats as they arise. This leads to vulnerabilities as attackers continually evolve their strategies and methods. Moreover, static systems also fail to account for changes in the infrastructure and operations of the organization, such as the adoption of new technologies or changes in business processes, which can introduce new potential points of attack. This inability to dynamically adapt hampers the ability of the organization to maintain a robust security posture, leaving entity networks and devices exposed to a constantly evolving threat landscape.

Accordingly, the ability to prevent cyber threats, such as hacking activities, data breaches, and/or cyberattacks, provides entities and users (e.g., provider, institution, individual, and/or company) improved cybersecurity by creating a customized cybersecurity framework tailored to their specific needs. This framework not only helps entities understand their current cybersecurity vulnerabilities but also connects them with appropriate vendors offering targeted protection plans. The customized framework enhances the protection of sensitive data, such as medical records and financial information, proprietary business data, and/or also helps safeguard the reputation of the entity. In addition to improving protection, the tailored cybersecurity framework also has the potential to reduce financial costs associated with data breaches, such as falling stock prices, costs of forensic investigations, and/or legal fees. The detailed design and execution of cybersecurity models for detecting and addressing vulnerabilities facilitate dynamic monitoring of various parameters or relationships, such as network, hardware, device, and/or financial parameters or relationships, between entities and vendors. That is, providing a customized cybersecurity framework facilitates significant improvements in cybersecurity by improving network security, infrastructure security, technology security, and/or data security. With vendors actively monitoring entities, immediate response to potential threats can be facilitated, thus further enhancing the overall security posture of the entity. This approach mitigates existing vulnerabilities and anticipates potential threats, offering an adaptive and proactive solution to cybersecurity.

Furthermore, by utilizing a customized cybersecurity framework for entities and users, it is possible to understand existing vulnerabilities, link them to specific assets, and/or provide targeted protection strategies, offering the technical benefit of generating personalized remediation recommendations and avoiding and preventing successful hacking activities, cyberattacks, data breaches, and/or other detrimental cyber-incidents. As described herein, the systems and methods of the present disclosure can facilitate the connection of entities to suitable vendors, offering security plans tailored to their specific vulnerabilities and needs. An additional benefit from the implementation of a customized cybersecurity framework is the ability to streamline the process of identifying and addressing vulnerabilities. This optimization of resources not only facilitates risk reduction but also allows for the ongoing monitoring the cybersecurity status of the entity by the vendor, ensuring continuous protection and immediate response to potential threats. The implementation of such a framework not only allows entities to understand and address their current vulnerabilities but also empowers them to make informed decisions about their cybersecurity strategy. This includes selecting from a range of vendor plans and services, activating these plans as needed, and/or having the peace of mind that their cybersecurity is being actively monitored and managed by professionals.

Additionally, the present disclosure provides a technical enhancement of dynamic cybersecurity architecture comprehension. For instance, the cybersecurity vulnerabilities of the entity can be automatically understood and mapped within the process of implementing a customized cybersecurity framework, eliminating the need for maintaining separate inventories of network weaknesses, infrastructure vulnerabilities, operating systems susceptibilities, etc. In some implementations, the implementation of this customized cybersecurity framework includes identifying potential security gaps associated with a particular entity or device identifier, such as a domain identifier (e.g., a top-level domain (TLD) identifier, a subdomain identifier, or a URL string pointing to a particular directory), an IP address, a subnet, etc. As a result, rather than separately assessing at least one (e.g., each) subclass of vulnerabilities, a computing system can utilize a unified view into a computing environment of a particular target entity (e.g., via the readiness system of the security architecture) and centrally manage the understanding of different types of vulnerabilities and associated potential security threats. For instance, by initiating a comprehensive vulnerability assessment in a single operation. These vulnerability identification operations, described further herein, can include computer-executed operations to discern the cybersecurity status of the entity and potential threats, determine vulnerabilities based on this status and subsequently connect the entity to suitable vendors offering appropriate cybersecurity plans.

### Systems and Methods for Posture-Based Modeling

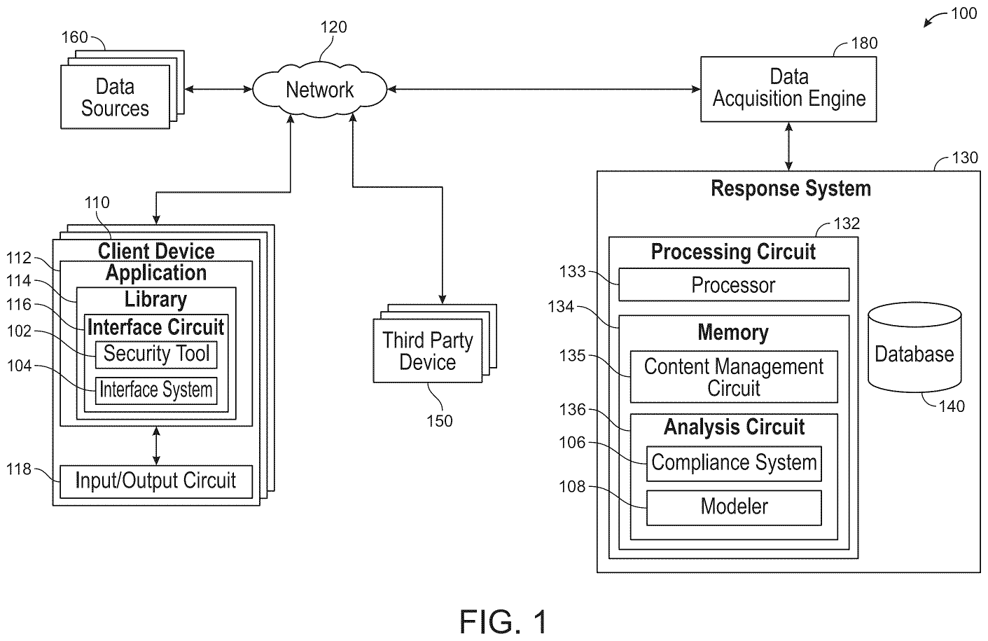

Referring to FIG. 1, a block diagram of an implementation of a security architecture for posture-based modeling is shown. The implementation shown in FIG. 1 includes a client device 110, response system 130, third party device 150, data sources 160, and/or data acquisition engine 180 for protecting data (e.g., entity data, cybersecurity posture data, etc.). These components can be interconnected through a network 120 that supports secure communications profiles (e.g., TLS, SSL, HTTPS, etc.). In some implementations, the client device 110 can include an application 112 and an input/output circuit 118. The application 112 can include a library 114, and/or the library 114 can include an interface circuit 116. The interface circuit 116 can further include a security tool 102 and an interface system 104. In some implementations, the response system 130 can include a processing circuit 132 and a database 140. The processing circuit 132 can include a processor 133 and memory 134. The memory 134 can further include a content management circuit 135 and an analysis circuit 136, and/or the analysis circuit 136 can include a compliance system 106 and a modeler 108, as further described herein.

In some implementations, one or more elements (computing systems, devices) of FIG. 1 can be communicably coupled (connected) to a distributed ledger (e.g., blockchain) or other authoritative data source to ensure data integrity and security. For example, the database 140 can be a private ledger and data source 160 can be a public ledger, and/or data transactions (e.g., updates to proof/posture state data, cybersecurity parameters, entity data, etc.) recorded on the database 140 can be validated against entries recorded on the data source 160 to ensure that updates to entries are accurately reflected and can be audited against an immutable record (e.g., ensuring that results can be traceable and linkable). In some implementations, the application 112 can be designed to integrate with technology and databases (e.g., database 140, response system 130, etc.) to access information used for posture-based modeling. The user can access the application 112 through a variety of devices, including client device 110.

In some implementations, the response system 130 can be operably connected to data acquisition engine 180 and includes analysis circuit 136 to democratize posture threats, incidents, and/or claim data (e.g., cyber security data, protection data, protection control schemas, historical protection data, etc.) for posture-based modeling. The analysis circuit 136 can use the democratized data in underwriting, claims, the resilience process, etc. Using the data acquisition engine 180, the response system 130 can collect and process data (e.g., unstructured data, entity data) from various sources, such as client device 110, third party devices 150 and data sources 160 for posture-based modeling.

In some implementations, the response system 130 can receive, via a vendor security tool (sometimes referred to herein as a “security tool”) application, a cybersecurity protection request from an entity. For example, the response system 130 can receive a request for cybersecurity protection (e.g., inquiry regarding cybersecurity protection plan, etc.) from the client device 110 (e.g., via the entity or other user interacting with the interface system 104), and/or the request can be transmitted via the network 120. In some implementations, the cybersecurity protection request can include entity data of the entity. For example, the cybersecurity protection request received by the response system 130 via the interface system 104 can include legal data (e.g., regulatory impact, privacy impact, etc.), firmographic data (e.g., industry, revenue, etc.), and/or cybersecurity data (e.g., safeguards, root cause, etc.) of the entity. In some implementations, the security tool 102 is a security tool application (e.g., vendor security tool application of a vendor) configured to receive cybersecurity protection requests from entities or users and provider the cybersecurity protection requests, as described regarding the response system 130. Furthermore, as used herein, a vendor can be a party or protection entity offering a product (e.g., cybersecurity tool), and/or the cybersecurity tool can allow a prospective entity (e.g., party seeking protection) to purchase cybersecurity protection using the cybersecurity tool.

As used herein, a “protection plan” and “cybersecurity protection plan” refers to any array of measures and strategies primarily focused on bolstering cybersecurity defenses, including cybersecurity monitoring and response services, digital infrastructure hardening programs, employee cyber awareness training, data protection and encryption techniques, insurance plans, all aimed at securing or covering computing and networking infrastructure of the entity against cyber threats, vulnerabilities, and/or incidents, while ensuring compliance with relevant standards and regulations.

In some implementations, the response system 130 can determine a cybersecurity posture with proof based on the entity data. For example, the compliance system 106 can receive, process, and/or model data received via the vendor security tool application (e.g., entity data related to firmographics, security measures, etc.) and output a cybersecurity posture with proof. In some implementations, the proof includes one or more digital signatures and authenticated data (e.g., of an entity, related to a security posture, etc.). In some implementations, a cybersecurity posture can be a data package encapsulating the cybersecurity disposition of the entity. This includes a mapping of compliances (e.g., regulatory and privacy impacts) and firmographic insights (e.g., industry classification and revenue metrics). Furthermore, the cybersecurity posture can include data related to protective measures (e.g., encryption standards, MDR, etc.) implemented by the entity and rationales for implementation. For example, the encoded posture state can integrate data reflecting the encryption protocols of the entity, thereby offering a “snapshot” of its technical safeguards. This data can be used by a vendor, provider, or protection entity to assess the alignment of the entity with cybersecurity benchmarks and standards, such as ISO 27001 certification. In some implementations, the cybersecurity posture can include a verifiable account of the cybersecurity measures of the entity, such as the implementation of advanced threat detection systems like MDR and endpoint detection and response solutions.

In some implementations, the response system 130 can determine, utilizing one or more protection parameters, at least one cybersecurity protection plan corresponding to a cybersecurity attribute to protect the entity based on the cybersecurity posture with the proof. For example, the compliance system 106 and modeler 108 can identify and generate a cybersecurity protection plan (e.g., ransomware protection plan, data breach compensation plan, etc.), and/or the cybersecurity protection plan can correspond to a cybersecurity attribute (e.g., confidentiality, integrity, authentication, etc.) of the entity. In some implementations, the cybersecurity protection plan determined by the response system 130 can be based on the cybersecurity posture of the entity and based on the proof (e.g., digital signatures, authenticated cybersecurity data, etc.). For example, the compliance system 106 and modeler 108 can identify and generate a cybersecurity protection plan by comparing and mapping compliances (e.g., regulatory and privacy impacts) of the entity, firmographic insights (e.g., industry classification and revenue metrics) of the entity, data related to protective measures (e.g., encryption standards, MDR, etc.) implemented by the entity, etc. to requirements (e.g., protection eligibility) of the cybersecurity protection plan (e.g., encryption standards, managed detection and response (MDR) system requirements, entity size/revenue requirements, etc.). This can include a comparison of rates tied to the effectiveness of current entity-implemented cybersecurity measures, such as encryption strength, endpoint security coverage, and/or MDR system efficiency.

In some implementations, the response system 130 can provide, via the vendor security tool application of the entity computing system of the entity, the at least one cybersecurity plan (e.g., to the entity). For example, the cybersecurity protection plan determined by the response system 130 can be transmitted to the client device 110 and displayed via the security tool 102 (e.g., using a graphical user interface (GUI)) of the application 112. In some implementations, the cybersecurity protection plan provided via the vendor security tool application can include at least one selectable element (e.g., digital button, drag-n-drop, etc.). For example, a user (e.g., the entity) can interact with the selectable element (e.g., via pressing, clicking, etc.) to select one or more options related to the cybersecurity protection plan (e.g., “Yes”/“No”, “I agree,” “Please modify,” “Please add,” etc.). For example, the entity can accept (e.g., digitally sign/approve) the cybersecurity protection plan using the selectable element.

In some implementations, the response system 130 can receive, from the vendor security tool application, an acceptance of the at least one cybersecurity protection plan. For example, the compliance system 106 and modeler 108 can receive an acceptance of the cybersecurity protection plan via the user (e.g., entity) interacting with the application 112 of the client device 110 (e.g., via the interface system 104, using a GUI, etc.). For example, the entity can accept the at least one cybersecurity protection plan by selecting an “Accept” button within the application 112 (e.g., via the interface system 104), by providing a digital signature, etc., and/or the acceptance of the entity can be received by the response system 130 via the network 120.

In some implementations, the response system 130 can record the acceptance with the proof embedded in a compliance dataset. That is, the proof can be embedded into the acceptance that is then recorded. For example, the response system 130 can store data related to the acceptance of the cybersecurity protection plan of the entity in a data store (e.g., database 140) for compliance verification, and/or the response system 130 can embed the proof (e.g., digital signatures, compliance certifications, etc.) within the stored data. Furthermore, the acceptance stored in the compliance dataset can be stored on a distributed ledger (e.g., using database 140 as a private ledger and data source 160 as a public ledger, as described above), or on an external data store (e.g., data sources 160, third party device 150). In some implementations, the acceptance recorded by the response system 130 can include the cybersecurity attribute and the accepted cybersecurity protection plan. For example, the data recorded in the compliance data set can include data related to the cybersecurity attribute (e.g., confidentiality, integrity, authentication, etc.) and the accepted cybersecurity protection plan (e.g., artifact/identifier of signed/accepted breach protection plan, etc.). Furthermore, the compliance dataset can be a dataset/data structure configured to be monitored to ensure ongoing compliance with the cybersecurity requirements (e.g., encryption protocol compliance, security patching cadence, and/or access control integrity, such as SSL/TLS standards for data in transit, frequency of security updates, implementation of least privilege principles, etc.) of the accepted cybersecurity protection plan. As such, the various computing elements of FIG. 1 can perform underwriting for any cybersecurity protection policy/plan matching predefined proof criteria.

It should be understood that while the response system 130 processes cybersecurity protection requests, its functions can also be applied to other areas. These include conducting risk assessments, identifying supply chain vulnerabilities, and/or ensuring compliance with regulatory standards. The system can analyze entity data to recommend technology upgrades or process optimizations, based on firmographic data, legal requirements, and/or cybersecurity posture. Additionally, it can offer monitoring and reporting services to track the effectiveness of implemented measures. Furthermore, the response system 130 can be utilized for disaster recovery planning, facilitating the development of strategies to ensure business continuity in the event of cyber-attacks, natural disasters, or other unforeseen incidents. The response system 130 can create incident response plans, model the assessment of potential impacts on business operations, and/or perform and prioritize recovery actions.

In some implementations, the response system 130 and client device 110 can further receive or collect environmental data from computing and networking structures of the entity for posture-based modeling. For example, the user (e.g., entity) can input environmental data via the interface system 104 of the application 112, and/or the interface system 104 (or other components of the client device 110, such as input/output circuit 118) can transmit the environmental data via the network 120, and/or the response system 130 (e.g., compliance system 106, modeler 108, etc.) can receive the environmental data. Furthermore, the environmental data can include information related to the computing and networking infrastructure of the entity such as hardware and software setups, security mechanisms, and/or network layouts (e.g., firewall rules, server specifications, network connections, etc.).

In some implementations, the response system 130 and client device 110 can further record the environmental data received/collected from the computing and networking structures of the entity in the compliance dataset. For example, the response system 130 (e.g., content management circuit 135, compliance system 106, modeler 108, etc.) can store/catalog environmental data (e.g., data related to network architecture, device configurations, security policies, etc.) in a data set (e.g., stored on database 140). Furthermore, the compliance dataset can be a structured dataset stored in a data store (e.g., database 140, data sources 160, etc.) and can be used (e.g., in compliance automation) by the computing elements of FIG. 1 (e.g., response system 130, compliance system 106, etc.) to determine the compliance by the entity with various requirements (e.g., protection parameters) of the cybersecurity plan (e.g., GDPR compliance, minimum data encryption standards, etc.).

In some implementations, determining the at least one cybersecurity protection plan can include executing a zero-knowledge proof (ZKP) model to determine the cybersecurity posture (e.g., readiness, resilience) of the entity against the one or more protection parameters. As described herein, zero-knowledge proofs (ZKPs) are a cryptographic method allowing one party (the prover) to prove to another party (the verifier) that a certain statement is true without revealing any information about the statement itself beyond its veracity. ZKP techniques can implement mathematical functions, such as elliptic curve cryptography or hash functions (e.g., SHA-256), to create a proof of knowledge (e.g., proving the possession of a secret key, such as a key proving the implementation of a specific cybersecurity requirement of a cybersecurity protection plan) without disclosing confidential and sensitive entity data. ZKPs can be implemented through interactive protocols (e.g., SHA-256, the Schnorr protocol, etc.), where the prover and verifier execute a sequence of exchanges (e.g., challenge-response cycles) to prove knowledge without revealing the underlying data. ZKPs can also be implemented via non-interactive schemes (e.g., e.g., zk-SNARKs (Zero-Knowledge Succinct Non-Interactive Arguments of Knowledge)) using a common reference string (e.g., a publicly agreed-upon set of values used in the cryptographic computation, other identifier, etc.).

In some implementations, the ZKP model used by the response system 130 to determine the cybersecurity of the entity posture can maintain anonymity of all or a portion of data used in determining the at least one cybersecurity protection plan. For example, the response system 130 (e.g., compliance system 106, modeler 108) can execute ZKPs to match entity posture to protectability (e.g., eligibility, regulatorability, insurability), allowing the entity to prove compliance with protection parameters (e.g., encryption standards, endpoint security) without revealing underlying data (e.g., sensitive user data, classified cybersecurity data, etc.) of the entity and data related to the security tool (e.g., proprietary source code used in cybersecurity product, etc.). Furthermore, the ZKP model can verify the adherence by the entity to required security measures (e.g., SHA-256 encryption for data at rest, TLS 1.3 for data in transit, etc.) without exposing actual encryption keys of data being encrypted. For example, the ZKP model can be used (e.g., by the response system 130, compliance system 106, modeler 108, some combination of various FIG. 1 elements, etc.) to confirm the deployment of next-generation firewalls (NGFWs) required by protection parameters of the cybersecurity protection plan. Further, in some implementations, the anonymity of the entity is maintained until acceptance. For example, the ZKP model used by the response system 130 to determine the cybersecurity posture of the entity can prevent a protection entity from learning the identity of a prospective entity prior to acceptance of the protection plan (e.g., before the prospective entity/the prospective representative of the entity accepts the provided security plan).

In some implementations, the modeler 108 can (1) determine at least one cybersecurity protection plan, (2) provide, to a graphical user interface (GUI), the at least one cybersecurity protection plan, (3) receive the acceptance, and/or (4) embed and record the acceptance can correspond to quoting, binding, and/or issue (QBI) of the cybersecurity protection plan. For example, the response system 130 can further analyze qualitative business impact (QBI) and resilience against cybersecurity threats of the computing infrastructure of the entity in performing the various steps described above. For example, the compliance system 106 and modeler 108 can unify and analyze data related to the QBI to assess the potential financial loss, reputation damage, and/or operational downtime associated with cybersecurity incidents (e.g., data breaches, ransomware attacks, DDoS attacks, etc.). In some implementations, determining the at least one cybersecurity protection plan further includes quoting the cybersecurity protection plan based on matching the cybersecurity posture of the entity to the cybersecurity attribute. For example, the response system 130 can compare the cybersecurity posture of the entity to cybersecurity attributes of one or more protection plans (e.g., by filtering based on protection parameters, by using GAI/ML techniques, etc.) to determine whether the entity meets various criteria (e.g., protection parameters) of the one or more protection plans and determine a protection quote (e.g., premiums, payments schedule, reimbursement, etc.) based on the identified protection plans and the cybersecurity posture of the entity. Further, in this example, the response system 130 can examine the robustness of security measures (e.g., deployment of redundant systems), determine the effectiveness of incident response plans (e.g., using historical/predictive datasets and models), and/or analyze other entity datasets and security tools and further generate a protection quote based on the above analysis. For example, the response system 130 can use an artificial intelligence (AI) or machine learning (ML) model (e.g., generative AI (GAI), large-language model, supervised learning model, etc.) to predict the impact of specific vulnerabilities within the network (e.g., unpatched software, outdated hardware) of the entity, simulate model potential attack paths (e.g., using cyber penetration testing tools), and/or determine potential business impacts based on the QBI. In some implementations, providing the at least one cybersecurity protection plan, receiving the acceptance, and/or recording the acceptance corresponds to binding and issuing the at least one cybersecurity protection plan based on (1) transmitting a first API call to create a protection binder and (2) transmitting a second API call to issue the at least one cybersecurity protection plan. For example, the response system 130 can bind (e.g., signify the commitment of the third party to the protection agreement before the actual protection policy is issued) and issue (e.g., finalize the protection coverage by preparing and sending the formal policy documents to the entity) the protection plan by executing API calls (e.g., for submitting an protection application, quoting an protection application, creating an protection binder, issuing a corresponding cyber plan, etc.), and/or the API calls executed by the response system 130 can include data payloads for various uses in aligning security posture to protection requirements. In some implementations, the first API call can include a first data payload including an entity identification, cybersecurity protection plan information, and/or a temporary protection agreement identifier. In some implementations, the second API call can include a finalized protection policy document, a permanent policy identifier, and/or confirmation of policy activation covering the entity under the at least one cybersecurity protection plan.

In some implementations, the response system 130 can further renew (e.g., automatically) the cybersecurity protection plan of the entity based on the modeled cybersecurity posture and resilience. For example, the compliance system 106 and modeler 108 can evaluate and update the cybersecurity protection plan parameters (e.g., encryption requirements, regulatory standards, coverage levels, deductible amounts) by analyzing the modeled cybersecurity posture and resilience to extend or renew the term (e.g., period of effect) of the cybersecurity protection plan. For example, the response system 130 (e.g., using compliance system 106, modeler 108, etc.) can process the renewal of the cybersecurity protection plan by assessing adherence to encryption standards (e.g., AES-256 for data at rest, TLS 1.3 for data in transit), compliance with regulatory standards (e.g., GDPR for data protection, SOC 2 for service organizations), and/or more. For example, the response system 130 can map data associated with the adherence by the entity to cybersecurity standards (e.g., based on the cybersecurity posture of the entity) to various protection parameters of a cybersecurity protection plan, and/or further update the cybersecurity protection plan (e.g., by changing/recalibrating the cybersecurity parameters of the plan, by generating a new plan, etc.) based on the adherence by the entity with the plan requirements, thereby unifying protectability tools for autorenewal.

In some implementations, the response system 130 can further dynamically update the at least one cybersecurity protection plan based at least on an update in a cybersecurity landscape or a change the protection preferences of the one or more entities. For example, the response system 130 can adjust the cybersecurity protection plan (e.g., by adjusting cybersecurity plan parameters) in response to emerging threats (e.g., zero-day exploits, advanced persistent threats), new compliance requirements (e.g., updates to international data protection laws), or other changes in the cybersecurity landscape identified by the compliance system 106. Furthermore, the response system 130 (e.g., using modeler 108) can update or refine the cybersecurity protection plan based on changes in the protection preferences of the entity. For example, an entity can change its protection preferences when implementing more enhanced data privacy measures in light of increasing regulatory scrutiny (e.g., changing protection preferences to a higher value associated with a higher degree of cybersecurity protection, etc.). Based on analyzing the update and changes, the response system 130 can adjust or update the cybersecurity protection plan to match the current risk profile and cybersecurity needs (e.g., extending coverage to new digital assets, recalibrating premiums based on risk assessment outcomes, renewing a plan, generating a new plan, etc.) of the entity. For example, the response system 130 can update one or more protection parameters to ensure the related protection plan is dynamically aligned with the evolving security requirements and the external cybersecurity environment of the entity.

In some implementations, the various computing elements of FIG. 1 (e.g., response system 130) can further perform bulk trading of entity policies matching proof criteria for posture-based modeling, as described in detail below. In some implementations, the response system 130 can receive, from a broker (e.g., provider) computing system, a bundle request from a protection broker. For example, the response system 130 can receive, from a broker computing system (e.g., client device 110, third party computing system 150, etc.), a bundle request for multiple protection policies that meet certain cybersecurity posture requirements (e.g., MDR system criteria). Furthermore, the bundle request can specify criteria (e.g., proof criteria) such as the presence of continuous monitoring tools, adherence to specific cybersecurity frameworks (e.g., ISO/IEC 27001, NIST), or a minimum score on cybersecurity posture assessments, and/or the response system 130 (e.g., utilizing modeler 108) can execute functions/algorithms to assess which policies in the market comply with these proof criteria. For example, the bundle request can be generated (e.g., by the response system 130) based on parsing through policy attributes, analyzing historical claims data for risk assessment, and/or evaluating compliance certifications that entities possess. Once a match between cybersecurity protection plans and a group of entities is identified, the response system 130 can facilitate the bulk trading of the matched policies to a cybersecurity protection broker.

In some implementations, the bundle request can include a set of cybersecurity parameters (e.g., cybersecurity protection plan criteria, such as incident response (IR) plan requirements). In some implementations, the response system 130 can determine a plurality of prospective entities satisfying the set of cybersecurity parameters. For example, the bundle request can include a set of cybersecurity parameters such as required intrusion detection system capabilities (e.g., signature-based, anomaly-based), data encryption levels (e.g., AES 256-bit encryption), and/or endpoint protection standards (e.g., real-time malware scanning, automated patch management). The response system 130 (e.g., using compliance system 106 and modeler 108) can process data from a database of entities (e.g., protected entities, insured entities, compliant entities) to identify the entities whose cybersecurity measures align with the set of cybersecurity parameters. For example, determining the entities satisfying the criteria can include the response system 130 querying a compliance database (e.g., stored on database 140, data source 160, etc.) for certifications held (e.g., SOC 2 Type II, PCI DSS compliance), checking configuration management databases for installed security software versions, and/or cross-referencing against security incident and event management logs to determine the efficacy of the cybersecurity implementations (e.g., cost-avoidance based determination, etc.) of the entities. Once the matching entities are identified, the response system 130 (or modeler 108) can group or bundle the identified entities that meet the bundle request of the protection provider criteria for cybersecurity protection.

In some implementations, the response system 130 can bundle the plurality of prospective entities and corresponding cybersecurity postures into a data package. For example, the response system 130 can bundle the identified prospective entities and corresponding postures into a data package by compiling (e.g., grouping, mapping, etc.) data of the selected entities with data of the security postures of the entities in a unified format (e.g., JSON, XML, etc.). Furthermore, the response system 130 can use data serialization techniques (e.g., converting data structures into JSON format for ease of transmission) and encrypt the package using advanced encryption standards (AES) to ensure data confidentiality and integrity. For example, the bundled package can be timestamped and digitally signed (e.g., by the modeler 108) using employing cryptographic hashing (e.g., SHA-256) to protect the data included in the package and to prepare the data package for secure transmission to the protection provider via encrypted communication channels.

In some implementations, the response system 130 can transmit to a plurality of protection entity computing systems (e.g., one or more third party device 150), the data package including information of the plurality of prospective entities and corresponding security postures. For example, the response system 130 can transmit the bundled data package to a broker computing system, such as a third party device 150, by establishing a secure connection utilizing various protocols (e.g., TLS (Transport Layer Security) for data in transit, VPN (Virtual Private Network) tunnel or a dedicated leased line for added security, etc.). Upon establishing the connection, the response system 130 can initiate and execute a secure file transfer protocol (e.g., SFTP or SCP) to send the encrypted and signed data package including information of the plurality of protection plans (e.g., coverage type, reimbursements, other data related to the cybersecurity protection plans and cybersecurity parameters, etc.). Furthermore, the broker computing system (e.g., third party device 150) can use decryption keys and digital signature verification tools (as per the shared security protocol with the response system 130) to decrypt, authenticate, and/or process the received data package, ensuring the integrity and confidentiality of the plurality of protection plans information during transit and upon receipt. In some implementations, the data package can include a customized implementation corresponding to an endorsement or a pricing coverage. For example, the data package can include specific terms (e.g., cyber protection terms) that offer enhanced cybersecurity protection coverage at preferential rates for prospective entities demonstrating strong cybersecurity postures (e.g., robust systems, organizational focus on cyber threats, implementation of specific cybersecurity tools, etc.). Alternatively, the data package can include terms demanding increased premiums or deductibles for entities identified as high-risk (e.g., based on cybersecurity posture, firmographic data of the prospective entity, weak cybersecurity measures implemented, etc.).

In some implementations, the various components of FIG. 1 (e.g., response system 130) can perform bulk trading of entity policies matching proof criteria according to the process outlined above, but by determining, bundling, or transmitting a plurality of protection plans instead of a plurality of prospective entities/corresponding cybersecurity postures. For example, the response system 130 can receive, from a broker computing system (e.g., third party device 150), the bundle request including a set of cybersecurity parameters and determine a plurality of entities (e.g., entities with cyber protection) satisfying the parameters. Further, the response system 130 can identify a plurality of protection plans of the plurality of entities. For example, the response system 130 can identify a plurality of protection plans by querying the compliance system 106 and modeler 108 to retrieve and analyze policy attributes from a secured database (e.g., database 140). For example, the response system 130 can execute database search operations (e.g., SQL JOIN queries across policyholder tables and protection plan tables) to cross-reference the protection parameters (e.g., using protection database logs, data on current cybersecurity certifications, risk assessments, etc.) to identify a plurality of protection plans implemented by the entities. The response system 130 can further transmit to a plurality of protection entity computing systems, the data package including information of the plurality of protection plans (e.g., plan type, coverage amount, term, entity cyber requirements/prerequisites, etc.), receive one or more bid requests for the bundled data package, and/or exchange the bundled data package for an amount. For example, the exchange can include the response system 130 assigning the plurality of protection plans of the bundled data package to a protection entity.

For example, the processes outlined above can allow a broker, after digitization of cybersecurity safeguards and configurations of an entity, to present (e.g., independently or by partnering with a security vendor) a set of qualified prospective entities to a protection entity. For example, the set of qualified prospective entities can include a list of entities (e.g., entities seeking cybersecurity protection) and corresponding cybersecurity posture data (e.g., entity firmographic data, data related to cyber implementations, etc.) to be used by a protection entity in determining whether to bid on a portion (e.g., a bulk amount) of the prospective entities. Furthermore, after receiving the entity and cybersecurity data, the protection entities can make special implementations (e.g., endorsements, pricing, coverage, etc.) to encourage the broker to provide the prospective entities included in the list of entities to the protection entity. For example, the protection entity can offer reduced pricing terms (e.g., lower premiums) or additional coverage options (e.g., DDoS coverage) after receiving the list of prospective entities and determining the corresponding cybersecurity postures of the entity are robust (e.g., implementation of multiple cybersecurity tools, compliance with latest industry standards, compliance with regulatory standards, etc.). Furthermore, the bid amount offered by the protection entity or the special implementations made to encourage the broker to send the plurality of entities to the protection entity can be based on a bulk pricing model designed to factor both the number of entities included in the bid (or the entities for which special implementations are offered) and corresponding cybersecurity postures of the entities.

In some implementations, the response system 130 can receive, from one or more broker computing systems (e.g., third party device 150), one or more bid requests for the bundled data package. For example, the response system 130 can receive bid requests that include specific parameters such as the desired level of cybersecurity coverage (e.g., coverage against data breaches, ransomware attacks, etc.), preferred premium ranges and payment criteria (e.g., payment periods, late fees, etc.), and/or criteria for cybersecurity compliance standards (e.g., compliance with ISO/IEC 27001, NIST Cybersecurity Framework, etc.). Furthermore, at least one (e.g., each) bid request received by the response system 130 via the one or more broker computing systems can specify the requirements of the broker for policy customization options (e.g., inclusion of cyber incident response services, coverage extensions for cloud-based assets, etc.) to match/align the protection plans with the market demand, cybersecurity landscape changes, and/or specific entity cybersecurity protection needs.

In some implementations, the response system 130 can exchange the bundled data package for an amount based on one of the one or more bid requests. For example, the response system 130 can evaluate and accept a bid request (e.g., offer of monetary sum) that offers improved terms for the exchange by evaluating various factors related to the one or more bid requests, including the proposed amount and the compliance by the bidder with required cybersecurity practices (e.g., data encryption standards, regulatory compliance, etc.). In some implementations, the exchange (e.g., process of exchanging bundled data package for amount) includes assigning the plurality of protection plans of the bundled data package to a broker. For example, the broker to whom the protection plans are assigned can be a specialized entity with a robust technological infrastructure capable of handling complex data transactions securely (e.g., intermediator). Furthermore, in assigning the protection plans to the broker, the response system 130 can update a transaction ledger (e.g., stored within database 140) to reflect the transfer of ownership (e.g., the exchange of the bundled data package for amount).

In some implementations, the set of cybersecurity parameters can include proof criteria, and/or the proof criteria can include cybersecurity measures and technologies (SMT) of the plurality of entities. For example, the response system 130 (e.g., using the modeler 108) can evaluate the bundled data package against the bid requests by applying proof criteria that encompass specific cybersecurity measures and technologies (SMT) of the entities. For example, these proof criteria can include verifying the implementation of entity-implemented Multi-Factor Authentication (MFA) to bolster access control, assessing the effectiveness of Endpoint Detection and Response (EDR) systems in identifying and mitigating cyber threats, evaluating the coverage provided by Managed Detection and Response (MDR) services for comprehensive threat management, etc. In some implementations, determining the at least one cybersecurity protection plan corresponding to the cybersecurity attribute can further includes using the proof to ensure compliance with required cybersecurity measures and technologies. Furthermore, the proof used to ensure compliance can include documentation (e.g., security policy documents, incident response plans, employee training completion certificates), compliance proof (e.g., ISO/IEC 27001 certification, GDPR compliance reports), network security proof (e.g., firewall and IDS/IPS configuration snapshots, VPN usage logs), access control proof (e.g., MFA deployment records, access control lists), data protection proof (e.g., encryption protocol details, data backup and recovery audit trails), threat detection and response proof (e.g., EDR alerts history, malware removal reports), and/or vendor risk management proof (e.g., third party security assessment reports, vendor SLAs). For example, the response system 130 can incorporate digital certificates or blockchain-based records as proof (e.g., stored via database 140/data source 160 acting as private and public ledgers, respectively, of a distributed ledger). For example, these proofs can validate that a cybersecurity implementations of the entity, such as MFA, EDR, and/or MDR, meet specific standards set by the cyber protection plan. For example, a digital certificate could be issued to an entity upon successful implementation of MFA, and/or the response system 130 can use this proof of implementation in determining potential cybersecurity plans for which the entity is qualified. In some implementations, determining the at least one cybersecurity protection plan corresponding to the cybersecurity attribute further can include using one or more tokens to align the entity with the cybersecurity attributes. For example, one or more tokens can serve as digital representations of the compliance by the entity with required cybersecurity measures and technologies, and/or holding a token can indicate that an entity has implemented certain cybersecurity measures (e.g., those that have been validated and are in active use). For example, a token could represent the active and effective use of EDR systems within the network of the entity and be issued following an audit or assessment by a trusted third party or through automated systems capable of independently verifying the presence and effectiveness of EDR systems. In some implementations, the tokens correspond to a verified and authenticated state of the security posture and resilience of the entities. For example, the verified/authenticated state can indicate that the security implementations of the entity have been thoroughly checked for effectiveness and compliance (e.g., verification that a cybersecurity measure is implemented by the entity, that the implemented cybersecurity measure is correctly configured and fully operational (e.g., active), etc.).

In some implementations, the cybersecurity protection plan provided is based on the determined security posture of the entity, and/or the cybersecurity protection plan corresponds to one or more coverage options aligning with the protection preferences of the entity. For example, the response system 130 (e.g., using the compliance system 106 and modeler 108) can analyze the digital infrastructure vulnerabilities (e.g., utilizing data collected from security tools 102, such as data regarding recent cyber incidents, current defense mechanisms, etc.) of the entity, the cybersecurity needs (e.g., coverage type, amount of coverage, etc.) of the entity, and/or other entity data (e.g., firmographic data such as entity size, revenue, etc.) to determine a cybersecurity protection plan aligning with the cybersecurity needs (e.g., type of protection, integrations, etc.), preferences, technical implementations, etc. of the entity. For example, the response system 130 can process entity data to generate an entity risk profile that includes potential attack vectors (e.g., susceptibility to phishing, ransomware attack history), existing safeguards (e.g., deployment of firewalls, use of secure sockets layer (SSL) encryption for data transmission), and/or areas of compliance (e.g., adherence to the General Data Protection Regulation (GDPR) or the Health Insurance Portability and Accountability Act (HIPAA)). Based on entity risk profiles and the stated cybersecurity needs of the entity, the response system 130 can dynamically configure protection coverage options by providing different cybersecurity protection plans in response to different entity protection preferences/needs/implementations (e.g., necessity of Endpoint Detection and Response (EDR) systems, desire for phishing protection, entity size/revenue, etc.).

In some implementations, the security tool 102 of the client device 110 can be configured to collect and transmit data to the response system 130 for various actions (e.g., submitting cybersecurity protection requests). The response system 130 can collect and submit entity data, including environmental data about the computing and networking infrastructure of the entity. This data can be used by the response system 130 in posture-based modeling. Users can input relevant environmental information through the interface of the application, which can then be securely transmitted to the response system for analysis. Furthermore, the security tool 102 can be a conduit for receiving updates from the response system 130 regarding cybersecurity protection plans, modifications based on ongoing risk assessments, and/or feedback on the cybersecurity posture of the entity.

In some implementations, the security tool 102 can a software application embedded within the client device 110, designed to facilitate secure communication and data exchange with the response system 130 for cybersecurity management tasks. The security tool 102 can include functionalities for initiating cybersecurity protection requests, submitting entity-specific data (e.g., including cybersecurity posture data and environmental data pertaining to the IT infrastructure of the entity), and/or receiving updates or feedback on cybersecurity protection plans. The security tool 102 can be integrated with the application layer of the device, utilizing secure communication protocols (e.g., TLS/SSL) for data transmission over networks. For example, the security tool 102 can provide a user interface (e.g., graphical user interface (GUI)) for entities to interact with the system, input data, and/or make selections regarding protection options. Additionally, the tool can incorporate features for real-time monitoring and alerts.

In some implementations, the compliance system 106 can prepare and report cyber incidents according to various governmental regulations. In some implementations, the compliance system 106 can determine when a cyber incident is substantial based on a government regulation, which could range from significant losses in the confidentiality, integrity, or availability of information systems, to serious impacts on operational safety, disruptions in business activities, or unauthorized access stemming from third party compromises. Upon identifying such incidents, the compliance system 106 can gather a set of data necessary for reporting. This data collection can encompass all correspondence with threat actors, indicators of compromise, relevant log entries, forensic artifacts, network data, and/or information on how the threat actor compromised the system, among others. Additionally, the compliance system 106 can track and document all details related to any ransom payments, including the amount, the decision process, and/or the aftermath of the payment.

For example, a substantial cyber incident can lead to one or more of the following: a substantial loss of confidentiality, integrity or availability of the information system or network of the covered entity, a serious impact on the safety and resiliency of the operational systems and processes of the covered entity, a disruption of the ability of the covered entity to engage in business or industrial operations, or deliver goods or services, unauthorized access to the information system or network of the covered entity, or any nonpublic information contained therein, that is facilitated through or caused by a: compromise of a cloud service provider, managed service provider, or other third party data hosting provider; or supply chain compromise.

Furthermore, in some implementations, the compliance system 106 can also be configured to manage and submit follow-up reports as required. This can include generating supplemental reports when new or different information about a cyber incident becomes available or if additional ransom payments are made. Thus, the compliance system 106 can provide all relevant data such that it is accurately preserved and maintained for a minimum period (e.g., set at two years), following the submission of the most recent report. This data preservation can include the initial detection of a compromise to the full resolution and analysis of the incident, including any payments made and the identification of exploited vulnerabilities.

In some implementations, the operational framework of the compliance system 106 aligns with the need for timely and detailed incident reporting and data preservation to assist organizations in maintaining compliance with regulatory requirements. By automating the process of collecting, preserving, and/or reporting detailed information about cyber incidents and ransom payments, the compliance system 106 reduces the manual effort required and enhances the accuracy of the information reported. This approach can be used to fulfil legal and regulatory obligations and strengthen the overall cybersecurity posture of organizations by ensuring a structured response to incidents and facilitating continuous improvement through detailed incident analysis and feedback.

In some implementations, the preservation requirement of the compliance system 106 can include all correspondence with the threat actor, regardless of the forum or method; indicators of compromise; relevant log entries; relevant forensic artifacts; network data; data and information that can help identify how a threat actor compromised or potentially compromised an information system; system information that can help identify exploited vulnerabilities; information about exfiltrated data; all data or records related to the disbursement or payment of any ransom payment; and any forensic or other reports concerning the incident, whether internal or prepared for the covered entity by a cybersecurity company or other third party vendor.

In various implementations, components of system 100 communicate over network 120. Network 120 can include computer networks such as the Internet, local, wide, metro or other area networks, intranets, satellite networks, other computer networks such as voice or data mobile phone communication networks, combinations thereof, or any other type of electronic communications network. Network 120 can include or constitute a display network. In various implementations, network 120 facilitates secure communication between components of system 100. As a non-limiting example, network 120 can implement transport layer security (TLS), secure sockets layer (SSL), hypertext transfer protocol secure (HTTPS), and/or any other secure communication protocol.

In general, the client devices 110 and third party devices 150 can execute a software application (such as application 112, e.g., a web browser, an installed application, or other application) to retrieve content from other computing systems and devices over network 120. Such an application can be configured to retrieve an interfaces and dashboards from the response system 130. In one implementation, the client device 110 and third party device 150 can execute a web browser application, which provides the interface (e.g., from content management circuit 135) on a viewport of the client device 110 or third party device 150. The web browser application that provides the interface can operate by receiving input of a uniform resource locator (URL), such as a web address, from an input device (such as input/output circuit 118, e.g., a pointing device, a keyboard, a touch screen, or another form of input device). In response, one or more processors of the client device 110 or third party device 150 executing the instructions from the web browser application can request data from another device connected to the network 120 referred to by the URL address (e.g., the response system 130). The other device can then provide webpage data and other data to the client device 110 or third party device 150, which causes the interface (or dashboard) to be presented by the viewport of the client device 110 or third party device 150. Accordingly, the browser window presents the interface to facilitate user interaction with the interface. In some implementations, the interface (or dashboard) can be presented via an application stored on the client device 110 and third party device 150.

The network 120 can facilitate communication between various nodes, such as the response system 130, third party device 150, client device 110, and/or data sources 160. In some implementations, data flows through the network 120 from a source node to a destination node as a flow of data packets, e.g., in the form of data packets in accordance with the Open Systems Interconnection (OSI) layers. A flow of packets can use, for example, an OSI layer-4 transport protocol such as the User Datagram Protocol (UDP), the Transmission Control Protocol (TCP), or the Stream Control Transmission Protocol (SCTP), transmitted via the network 120 layered over an OSI layer-3 network protocol such as Internet Protocol (IP), e.g., IPv4 or IPv6. The network 120 is composed of various network devices (nodes) communicatively linked to form one or more data communication paths between participating devices. At least one (e.g., each) networked device includes at least one network interface for receiving and transmitting data, typically as one or more data packets. An illustrative network 120 is the Internet; however, other networks can be used. The network 120 can be an autonomous system (AS), e.g., a network that is operated under a consistent unified routing policy (or at least appears to from outside the AS network) and is generally managed by a single administrative entity (e.g., a system operator, administrator, or administrative group).

Client device 110 (sometimes referred to herein as a “mobile device,” “client devices 110,” or user computing system(s) 110″) can be a mobile computing device, smartphone, tablet, smart watch, smart sensor, or any other device configured to facilitate receiving, displaying, and/or interacting with content (e.g., web pages, mobile applications, etc.). Client device 110 can include an application 112 to receive and display content and to receive user interaction with the content. For example, application 112 can be a web browser. Additionally, or alternatively, application 112 can be a mobile application. Client device 110 can also include an input/output circuit 118 for communicating data over network 120 (e.g., receive and transmit to response system 130).

In various implementations, application 112 interacts with a content publisher to receive online content, network content, and/or application content. For example, application 112 can receive and present various dashboards and information resources from distributed by the content publisher (e.g., content management circuit 135). Dashboards and information resources can include web-based content such as a web page or other online documents. The dashboards information resources can include instructions (e.g., scripts, executable code, etc.) that when interpreted by application 112 cause application 112 to display a graphical user interface such as an interactable web page and an interactive mobile application to a user (e.g., dashboards). In various implementations, application 112 can include one or more application interfaces for presenting an application (e.g., mobile application, web-based application, virtual reality/augmented reality application, smart TV application and so on).

Application 112 is shown to include library 114 having an interface circuit 116. The library 114 can include a collection of software development tools contained in a package (e.g., software development kit (SDK), application programming interface (API), integrated development environment (IDE), debugger, etc.). For example, library 114 can include an application programming interface (API). In another example, library 114 can include a debugger. In yet another example, the library 114 can be an SDK that includes an API, a debugger, and/or IDE, and/or so on. In some implementations, library 114 includes one or more libraries having functions that interface with a particular system software (e.g., iOS, and/or Android, Linux, etc.). Library 114 can facilitate embedding functionality in application 112. For example, a user can use library 114 to automatically transmit event logs whenever an event occurs on application 112. As a further example, library 114 can include a function configured to collect and report device analytics and a user can insert the function into the instructions of application 112 to cause the function to be called during specific actions of application 112 (e.g., during testing as described in detail below). In some implementations, interface circuit 116 functionalities are provided by library 114.

In various implementations, interface circuit 116 of system 100 can provide one or more interfaces to users, which can be accessed through an application interface presented in the viewport of client device 110. In another example implementation, the application 112 executed by the client device 110 can cause a web browser to the display the interfaces (e.g., dashboards) on the client device 110. For example, the user can connect (e.g., via the network 120) to a website structured to host the interfaces. In various implementations, interface can include infrastructure such as, but not limited to, host devices (e.g., computing device) and a collection of files defining the interface and stored on the host devices (e.g., in database 140). The web browser operates by receiving input of a uniform resource locator (URL) into a field from an input device (e.g., a pointing device, a keyboard, a touchscreen, mobile phone, or another form of input device). In response, the interface circuit 116 executing the interface in the web browser can request data such as from content (e.g., vendor information, settings, current incident response, other dashboards, etc.) from database 140. The web browser can include other functionalities, such as navigational controls (e.g., backward and forward buttons, home buttons). In some implementations, the debugging interface can include both a client-side interface and a server-side interface. For example, a client-side interface can be written in one or more general purpose programming and can be executed by client device 110. The server-side interface can be written, for example, in one or more general purpose programming languages and can be executed by the response system 130.

Interface circuit 116 can detect events within application 112. In various implementations, interface circuit 116 can be configured to trigger other functionality based on detecting specific events (e.g., transactions, in-app purchases, performing a test of a vendor, scrolling through an incident response plan, sending a contract to a vendor, spending a certain amount of time interacting with an application, etc.). For example, interface circuit 116 can trigger a pop-up window (overlayed on an interface) upon selecting an actionable object (e.g., button, drop-down, input field, etc.) within a dashboard. In various implementations, library 114 includes a function that is embedded in application 112 to trigger interface circuit 116. For example, a user can include a function of library 114 in a transaction confirmation functionality of application 112 that causes interface circuit 116 to detect a confirmed transaction (e.g., purchase cybersecurity protection plans, partnering). It should be understood that events can include any action important to a user within an application and are not limited to the examples expressly contemplated herein. In various implementations, interface circuit 116 is configured to differentiate between different types of events. For example, interface circuit 116 can trigger a first set of actions based on a first type of detected event (e.g., selecting actionable objects within the static response plan) and can trigger a second set of actions based on a second type of detected event (e.g., running a test). In various implementations, interface circuit 116 is configured to collect event logs associated with the detected event and events and transmit the collected event logs to content management circuit 135.

In various implementations, the interface circuit 116 can collect events logs based on a designated session. In one example, the designated session can be active from when application 112 is opened/selected to when application 112 is closed/exited. In another example, the designated session can be active based on a user requesting a session to start and a session to end. At least one (e.g., each) session, the interface circuit 116 can collect event logs while the session is active. Once completed, the event logs can be provided to any system described herein. During the session, the event logs can trace at least one (e.g., each) event in the session such that the events are organized in ascending and descending order. In some implementations, the events can be organized utilizing various other techniques (e.g., by event type, by timestamp, by malfunctions, etc.).

In various implementations, the interface circuit 116 of the client device 110 (or third party device 150) can start collecting event logs when application 112 is opened (e.g., selected by the user via an input/output circuit 118 of the client device 110), thus starting a session. In some implementations, once the application is closed by the user the interface circuit 116 can stop collecting event logs, thus ending the session. In various implementations, the user can force clear event logs or force reset application 112 such that the current session can reset, thus ending a particular session and starting a new session.

The input/output circuit 118 is structured to send and receive communications over network 120 (e.g., with response system 130 and third party device 150). The input/output circuit 118 is structured to exchange data (e.g., bundled event logs, content event logs, interactions), communications, instructions, etc. with an input/output component of the response system 130. In one implementation, the input/output circuit 118 includes communication circuitry for facilitating the exchange of data, values, messages, and/or the like between the input/output circuit 118 and the response system 130. In yet another implementation, the input/output circuit 118 includes machine-readable media for facilitating the exchange of information between the input/output device and the response system 130. In yet another implementation, the input/output circuit 118 includes any combination of hardware components, communication circuitry, and/or machine-readable media (e.g., a non-transitory computer readable medium (CRM)).

In some implementations, the input/output circuit 118 includes suitable input/output ports and uses an interconnect bus (not shown) for interconnection with a local display (e.g., a touchscreen display) and keyboard/mouse devices (when applicable), or the like, serving as a local user interface for programming and data entry, retrieval, or other user interaction purposes. As such, the input/output circuit 118 can provide an interface for the user to interact with various applications (e.g., application 112) stored on the client device 110. For example, the input/output circuit 118 includes a keyboard, a keypad, a mouse, joystick, a touch screen, a microphone, a haptic sensor, a car sensor, an IoT sensor, a biometric sensor, an accelerometer sensor, a virtual reality headset, smart glasses, smart headsets, and/or the like. As another example, input/output circuit 118, can include, but is not limited to, a television monitor, a computer monitor, a printer, a facsimile, a speaker, and/or so on. As used herein, virtual reality, augmented reality, and/or mixed reality can at least one (e.g., each) be used interchangeably yet refer to any kind of extended reality, including virtual reality, augmented reality, and/or mixed reality.

In some implementations, input/output circuit 118 of the client device 110 can receive user input from a user (e.g., via sensors, or any other input/output devices/ports described herein). A user input can be a plurality of inputs, including by not limited to, a gesture (e.g., a flick of client device 110, a shake of client device 110, a user-defined custom gesture (e.g., utilizing an API), biological data (e.g., stress level, heart rate, hand geometry, facial geometry, psyche, and/or so on) and behavioral data (e.g., haptic feedback, gesture, speech pattern, movement pattern (e.g., hand, food, arm, facial, iris, and/or so on), or combination thereof, etc. In some implementations, one or more user inputs can be utilized to perform various actions on client device 110.

For example, a user can use a gesture, such as a flick or a shake, to quickly invoke an incident response through the response system 130 from client device 110. With the use of biological and behavioral data, a user could trigger an incident response, access the vendor marketplace, or recall proof of state using custom-defined gestures via an API with input/output circuit 118. The drag and drop file tokenization feature can also be activated by a gesture, allowing a user to seamlessly tokenize files and secure them on the blockchain with a simple motion or touch on client device 110.

Input/output circuit 118 can exchange and transmit data information, via network 120, to all the devices described herein. In various implementations, input/output circuit 118 transmits data via network 120. Input/output circuit 118 can confirm the transmission of data. For example, input/output circuit 118 can transmit requests and information to response system 130 based on selecting one or more actionable items within the interfaces and dashboards described herein. In another example, input/output circuit 118 can transmit requests and information to third party devices 150 operated one or more vendors. In various implementations, input/output circuit 118 can transmit data periodically. For example, input/output circuit 118 can transmit data at a predefined time. As another example, input/output circuit 118 can transmit data on an interval (e.g., every ten minutes, every ten hours, etc.).

The response system 130 can include a logic device, which can be a computing device equipped with a processing circuit that runs instructions stored in a memory device to perform various operations. The processing circuit can be made up of various components such as a microprocessor, an ASIC, or an FPGA, and/or the memory device can be any type of storage or transmission device capable of providing program instructions. The instructions can include code from various programming languages commonly used in the industry, such as high-level programming languages, web development languages, and/or systems programming languages. The response system 130 can also include one or more databases for storing data and an interface, such as a content management circuit 135, that receives and provides data to other systems and devices on the network 120.

The response system 130 can be run or otherwise be executed on one or more processors of a computing device. In broad overview, the response system 130 can include a processing circuit 132, a processor 133, memory 134, a content management circuit 135, an analysis circuit 136, and/or a database 140. The interface and dashboards generated by content management circuit 135 can be provided to the client devices 110 and third party devices 150. Generally, the interfaces and dashboards can be rendered at the client devices 110 and third party devices 150. The interfaces and dashboards can execute at the response system 130, the client device 110, the third party devices 150, or a combination of the three to provide the interfaces and dashboards. In some implementations, the interfaces and dashboards generated and formatted by content management circuit 135 can be provided within a web browser. In another implementation, the content management circuit 135 executes to provide the interfaces and dashboards at the client devices 110 and third party devices 150 without utilizing the web browser.

The response system 130 can be a server, distributed processing cluster, cloud processing system, or any other computing device. Response system 130 can include or execute at least one computer program or at least one script. In some implementations, response system 130 includes combinations of software and hardware, such as one or more processors configured to execute one or more scripts. Response system 130 is shown to include database 140. Database 140 can store received data. For example, the database 140 can include data structures for storing information such as, but not limited to, the front end information, interfaces, dashboards, incident information, claim information, user information, vendor information, contract information, invoices, a blockchain ledger, etc. The database 140 can be part of the response system 130, or a separate component that the response system 130, the client device 110, or the third party device 150 can access via the network 120. The database 140 can also be distributed throughout system 100. For example, the database 140 can include multiple databases associated with the response system 130, the client device 110, or the third party device 150, or all three. Database 140 can include one or more storage mediums. The storage mediums can include but are not limited to magnetic storage, optical storage, flash storage, and/or/or RAM. Response system 130 can implement or facilitate various APIs to perform database functions (e.g., managing data stored in database 140). The APIs can be but are not limited to SQL, ODBC, JDBC, NOSQL and any other data storage and manipulation API.

Processing circuit 132 includes processor 133 and memory 134. Memory 134 can have instructions stored thereon that, when executed by processor 133, cause processing circuit 132 to perform the various operations described herein. The operations described herein can be implemented using software, hardware, or a combination thereof. Processor 133 can include a microprocessor, ASIC, FPGA, etc., or combinations thereof. In many implementations, processor 133 can be a multi-core processor or an array of processors. Memory 134 can include, but is not limited to, electronic, optical, magnetic, or any other storage devices capable of providing processor 133 with program instructions. Memory 134 can include a floppy disk, CD-ROM, DVD, magnetic disk, memory chip, ROM, RAM, EEPROM, EPROM, flash memory, optical media, or any other suitable memory from which processor 133 can read instructions. The instructions can include code from any suitable computer programming language.

The data sources 160 can provide data to the response system 130. In some implementations, the data sources 160 can be structured to collect data from other devices on network 120 (e.g., client devices 110 and third party devices 150) and relay the collected data to the response system 130. In one example, a user and entity can have a server and database (e.g., proxy, enterprise resource planning (ERP) system) that stores network information associated with the user and entity. In this example, the response system 130 can request data associated with specific data stored in the data source (e.g., data sources 160) of the user or entity. For example, in some implementations, the data sources 160 can host or otherwise support a search or discovery engine for Internet-connected devices. The search or discovery engine can provide data, via the data acquisition engine 180, to the response system 130. In some implementations, the data sources 160 can be scanned to provide additional data. The additional data can include newsfeed data (e.g., articles, breaking news, and/or television content), social media data (e.g., Facebook, Twitter, Snapchat, and/or TikTok), geolocation data of users on the Internet (e.g., GPS, triangulation, and/or IP addresses), governmental databases, generative artificial intelligence (GAI) data, and/or any other intelligence data associated with the specific entity of interest.

The system 100 can include a data acquisition engine 180. In various implementations, the response system 130 can be communicatively and operatively coupled to the data acquisition engine 180. The data acquisition engine 180 can include one or more processing circuits configured to execute various instructions. In various implementations, the data acquisition engine 180 can be configured to facilitate communication (e.g., via network 120) between the response system 130 and systems described herein. The facilitation of communication can be implemented as an application programming interface (API) (e.g., REST API, Web API, customized API), batch files, and/or queries. In various implementations, the data acquisition engine 180 can also be configured to control access to resources of the response system 130 and database 140.

The API can be used by the data acquisition engine 180 and computing systems to exchange data and make function calls in a structured format. The API can be configured to specify an appropriate communication protocol using a suitable electronic data interchange (EDI) standard or technology. The EDI standard (e.g., messaging standard and supporting technology) can include any of a SQL data set, a protocol buffer message stream, an instantiated class implemented in a suitable object-oriented programming language (e.g., Java, Ruby, C#), an XML file, a text file, an Excel file, a web service message in a suitable web service message format (e.g., representational state transfer (REST), simple object access protocol (SOAP), web service definition language (WSDL), JavaScript object notation (JSON), XML remote procedure call (XML RPC)). As such, EDI messages can be implemented in any of the above or using another suitable technology.

In some implementations, data is exchanged by components of the data acquisition engine 180 using web services. Where data is exchanged using an API configured to exchange web service messages, some or all components of the computing environment can include or can be associated with (e.g., as a client computing device) one or more web service node(s). The web service can be identifiable using a unique network address, such as an IP address, and/or a URL. Some or all components of the computing environment can include circuits structured to access and exchange data using one or more remote procedure call protocols, such as Java remote method invocation (RMI), Windows distributed component object model (DCOM). The web service node(s) can include a web service library including callable code functions. The callable code functions can be structured according to a predefined format, which can include a service name (interface name), an operation name (e.g., read, write, initialize a class), operation input parameters and data type, operation return values and data type, service message format, etc. In some implementations, the callable code functions can include an API structured to access on-demand and receive a data feed from a search or discovery engine for Internet-connected devices. Further examples of callable code functions are provided further herein as implemented in various components of the data acquisition engine 180.

The data sources 160 can provide data to the response system 130 based on the data acquisition engine 180 scanning the Internet (e.g., various data sources and data feeds) for data associated with a specific user or entity (e.g., vendor, insurer). That is, the data acquisition engine 180 can hold (e.g., in non-transitory memory, in cache memory, and/or in database 140) the executables for performing the scanning activities on the data sources 160. Further, the response system 130 can initiate the scanning operations. For example, the response system 130 can initiate the scanning operations by retrieving domain identifiers or other user/entity identifiers from a computer-implemented DBMS or queue. In another example, a user can affirmatively request a particular resource (e.g., domain or another entity identifier) to be scanned, which triggers the operations. In various implementations, the data sources 160 can facilitate the communication of data between the client devices 110 and third party devices 150, such that the data sources 160 receive data (e.g., over network 120) from the client devices 110 and third party devices 150 before sending the data other systems described herein (e.g., response system 130). In other implementations and as described herein, the client devices 110 and third party devices 150, and/or the data sources 160 can send data directly, over the network 120, to any system described herein and the data sources 160 can provide information not provided by any of the client devices 110 and third party devices 150.

In an example implementation, an application executed by the client devices 110 and third party devices 150 can cause the web browser to display on a monitor or screen of the computing devices. For example, the user can connect (e.g., via the network 120) to a website structured to host the customized dashboards. In various implementations, hosting the customized dashboard can include infrastructure such as host devices (e.g., computing device) and a collection of files defining the customized dashboard and stored on the host devices (e.g., in a database). The web browser operates by receiving input of a uniform resource locator (URL) into a field from an input device (e.g., a pointing device, a keyboard, a touchscreen, mobile phone, or another form of input device). In response, the content management circuit 135 executing the web browser can request data such as from the database 140. The web browser can include other functionalities, such as navigational controls (e.g., backward and forward buttons, home buttons, other navigational buttons or items). The content management circuit 135 can execute operations of the database 140 (or provide data from the database 140 to the client devices 110, and/or third party devices 150 for execution) to provide the customized dashboards at the client devices 110 and third party devices 150.

In some implementations, the content management circuit 135 can include both a client-side application and a server-side application. For example, a content management circuit 135 can be written in one or more general purpose programming languages and can be executed by client devices 110 and third party devices 150. The server-side content management circuit 135 can be written, for example, in one or more general purpose programming, or a concurrent programming language, and/or can be executed by the response system 130. The content management circuit 135 can generate customized user-interactive dashboards for one or more users and entities, such as the client device 110 and third party devices 150, based on data received, collected, and/or aggregated from the analysis circuit 136, any other computing device described herein, and/or any database described herein (e.g., 140).

The generated dashboards can include various data (e.g., data stored in database 140 and data sources 160) associated with one or more entities including scheduling information, profile information, cybersecurity risk and vulnerabilities cybersecurity vulnerabilities (e.g., malware, unpatched security vulnerabilities, expired certificates, hidden backdoor programs, super-user and admin account privileges, remote access policies, other policies and procedures, type and lack of encryption, type and lack of network segmentation, common injection and parameter manipulation, automated running of scripts, unknown security bugs in software or programming interfaces, social engineering, and/or IoT devices), insurer and vendor information (e.g., policies, contracts, products, services, underwriting, limitations), incident information, cyberattack information (e.g., phishing attacks, malware attacks, web attacks, and/or artificial intelligence (AI)-powered attacks), remediation items, remediation actions/executables, security reports, data analytics, graphs, charts, historical data, historical trends, vulnerabilities, summaries, help information, domain information, and/or subdomain information. As used herein, a “cyber-incident” can be any incident where a party (e.g., user, individual, institution, company) gains unauthorized access to perform unauthorized actions in a computer network environment. The database 140 can also include data structures for storing information such as system definitions for customized dashboards generated by content management circuit 135, animated or other content items, actionable objects, graphical user interface data, and/or additional information.

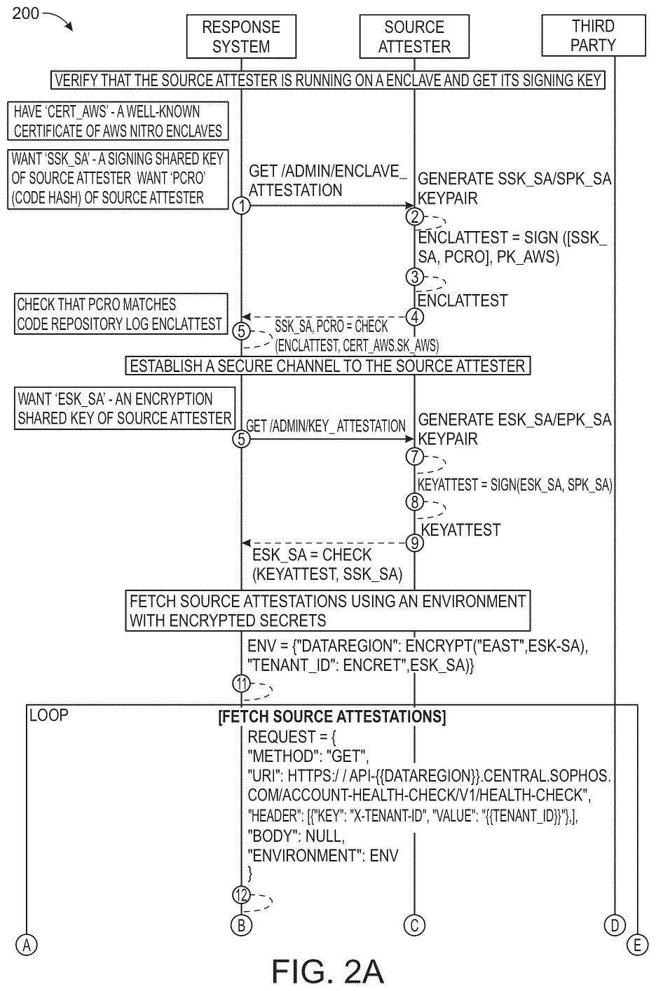

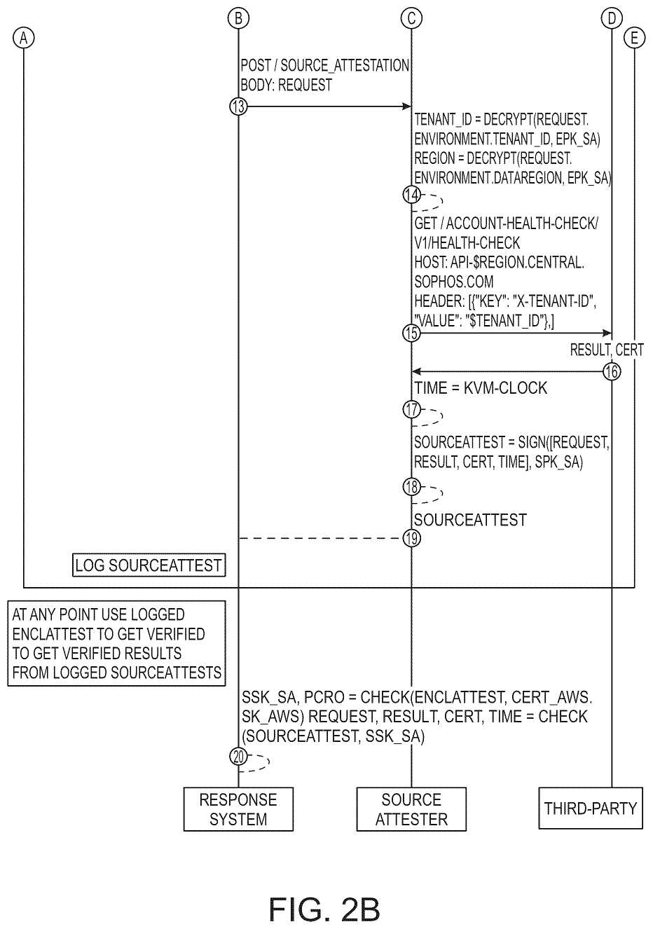

Referring generally to FIGS. 2A-2B, block diagrams of implementations of a system 200 for posture-based modeling (e.g., attestation/verification within a secure computing environment) are shown. Referring to FIG. 2A in more detail, the system 200 can verify that a source attester is running on an enclave and fetch a signing key of the source attester, establish a secure channel to the source attester, and/or fetch source attestations using an environment with encrypted secrets. For example, the system 200 can verify that a source attester is running on an enclave and fetch a signing key of the source attester by initiating a certificate check process (e.g., utilizing AWS Nitro Enclaves certificates) to authenticate the integrity and identity of the enclave. A compliance system (e.g., compliance system 106 of FIG. 1) can then request and validate an attestation, confirming that the state and the code of the enclave executed by the enclave are as expected (e.g., matching a known good configuration). Furthermore, the system 200 can establish a secure channel to the source attester by executing a cryptographic protocol (e.g., Transport Layer Security (TLS) handshake) that ensures the confidentiality and integrity of communications. This can involve the exchange of session keys generated by a modeler (e.g., modeler 108 of FIG. 1) and the enclave (e.g., with session keys derived using an ephemeral Diffie-Hellman key exchange to facilitate a secure channel setup). Further, the system 200 can fetch source attestations using an environment with encrypted secrets by employing secure cryptographic envelopes (e.g., using symmetric key encryption like AES-256) to encapsulate the attestation data. For example, a modeler (e.g., modeler 108) can encrypt an attestation request payload with a shared secret key, ensuring that only a source attester, which possesses the corresponding decryption key, can access and process an attestation request.

Referring to FIG. 2B in more detail, the system 200 can capture and securely log a POST action of a source attestation body (e.g., encapsulating requests for attestation validation). For example, the response system 130 of FIG. 1 (e.g., using the modeler 108) can decode the encrypted environment variables/fields (e.g., TENANT_ID, REGION, TIME, SOURCE ATTEST, etc.) and utilize the ESK for decryption). The system 200 can transmit GET requests to verify the health and status of an account (e.g., via an API endpoint as specified in the health check URL) and ensure that the received information is current by timestamping with a trusted source (e.g., KVM-CLOCK). Further, the system 200 can verify that the signature of the source attester is applied to the transaction (e.g., signing with the SPK of the enclave), further verified by the compliance system 106 against the attestation of the enclave and the known certificate authority (e.g., using AWS certificates, using fields such as SSK_SA, PCRO, REQUEST, RESULT, CERT, TIME, etc.), thereby providing an immutable log for subsequent audits and verifications.

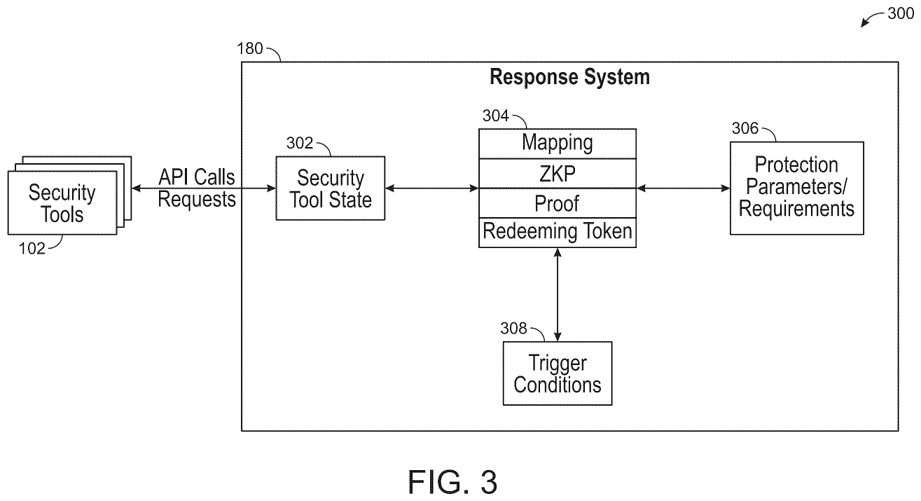

Referring now to FIG. 3, a block diagram of an implementation of a system 300 including a response system 130 for posture-based modeling is shown. In some implementations, the system 300 can include the response system 130 and security tools 102, which can be used at block 302, block 304, block 306, and/or block 308 for various purposes related to cybersecurity protection, protecting data, and/or posture-based modeling, as further described herein. In some implementations, at block 302, the response system 130 can determine a security tool state corresponding to one or more security tools 102. For example, the response system 130 can utilize API calls/requests (e.g., utilizing RESTful API) to interrogate the security tools 102, retrieving their operational states, configurations, and/or recent activity logs (e.g., to assess the current state, effectiveness, etc. of the security tools 102). At block 304, the response system 130 can receive data and engage in data processing tasks such as mapping the received data to known security incidents or potential threats using techniques like Zero-Knowledge Proofs (ZKPs) to verify data integrity without exposing the underlying data. For example, the system can use ZKP to validate the redemption of tokens provided by security tools as proof of a secure state or incident resolution without revealing sensitive details related to an entity.

At block 306, the response system 130 can determine and apply protection parameters or requirements by comparing the current security tool states against predefined security benchmarks or profiles (e.g., encryption standards, regulatory compliance requirements, etc.). For example, at block 306, the response system 130 can process and analyze data such as the efficacy of current encryption protocols in use (e.g., comparing deployed AES-256 encryption against organizational policy requirements) and the level of adherence to various cybersecurity frameworks (e.g., NIST Cybersecurity Framework, ISO/IEC 27001 standards). At block 308, the response system 130 can trigger conditions based on the analyzed data and security tool states. For example, in response to detecting a discrepancy or anomaly, the response system 130 can execute predefined cybersecurity response protocols (e.g., isolation of affected systems, activation of additional monitoring tools, notification to incident response teams, etc.) based on protection parameters/requirements corresponding to an entity and to a protection plan of the entity, as described above regarding FIG. 1.

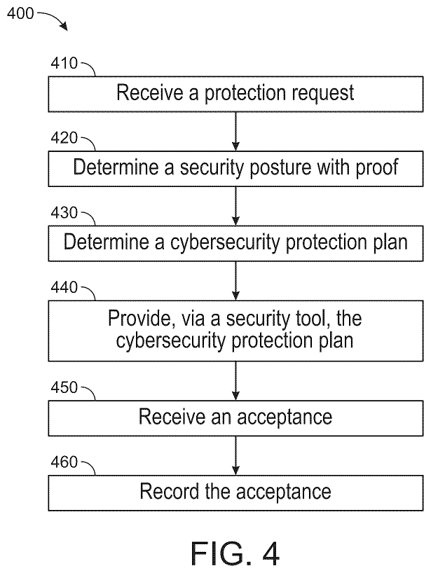

Referring now to FIG. 4, a flowchart for a method 400 for protecting data (e.g., for posture-based modeling) is shown, in accordance with present implementations. At least the computing/security architecture shown and described regarding FIG. 1 can perform method 400 according to present implementations.

In general, method 400 relates to shifting the point of purchase of cyber protection or a cyber product to cybersecurity tools with compliance automation. For example, in response to a protection entity or vendor of a security tool entering rules (e.g., protection parameters or requirements of a protection plan, such as encryption standards, implementation of MDR systems, entity firmographic data, etc.), the method 400 can be used (e.g., by various computing devices, as shown on FIG. 1) to link the protection plan requirements to real-world cyber implementations of the entity. For example, using an existing link between a security vendor tool and the entity (e.g., prospective entity), the method 400 can be used to verify whether the protection parameters of the cyber protection plan or product are satisfied by the entity and the cybersecurity implementations of the entity. For example, rather than requiring a human to perform underwriting or verification that the entity and the cybersecurity implementations of the entity meet (or comply) with the various criteria of the protection plan (e.g., the protection parameters), the method 400 can be used to dynamically map cybersecurity parameters to cyber implementations of the entity, using proof (e.g., digital documentation, evidence, or assessments that demonstrate the security measures and protocols a company or entity has implemented to protect against cyber threats and vulnerabilities) to ensure the entity complies with the requirements/parameters of the protection plan, thus bypassing the need for human involvement in underwriting. Furthermore, the point of purchase of cyber protection can be “shifted” to the security vendor (e.g., cybersecurity company offering a security tool) by embedding, within a security vendor dashboard (e.g., GUI), data related to the mapped cybersecurity parameters, proof, and/or entity (e.g., information related to the qualification or preapproval of the entity for protection). For example, a ZKP model can be used can maintain anonymity of the prospective entity prior to the prospective entity agreeing to (or enrolling in) the cyber protection plan. For example, the ZKP model used in method 400 can prevent sharing the identity of the client prior to the client purchasing, agreeing to, and/or signing the protection plan, thereby avoiding breaking legal agreements (e.g., non-disclosure agreements) associated with the cybersecurity plan, protection entity, and/or prospective entity.

As a broad example of method 400, a prospective entity can interact with a security vendor application (e.g., dashboard) when considering purchasing and implementing a cybersecurity tool offered by the vendor (e.g., firewalls, antivirus software, intrusion detection/prevention systems (IDS/IPS), endpoint protection platforms (EPP), multi-factor authentication (MFA) tools, encryption tools, employee training programs, etc.). Furthermore, as the entity reviews these tools via the dashboard/application, a real-time evaluation of the cybersecurity stance of the entity can be initiated and executed. For example, a ZKP model can be used to analyze the security measures of the entity against the protection requirements of the provider without disclosing the identity of the entity, thereby safeguarding confidential information and adhering to any non-disclosure agreements in place. Furthermore, if the cybersecurity practices of the entity align with the specified criteria, a notification of pre-qualification or pre-approval for cyber protection can be provided to the entity (e.g., via the vendor dashboard/application). As such, the method 400 can be used to connect the prospective adoption by the entity of specific security tools directly with protection eligibility, streamlining the path to obtaining cyber protection based on the security readiness (e.g., resilience, posture, etc.) of the entity.

In some implementations, the one or more processing circuits can be configured to shift the point of purchase of cyber protection to cyber security tools with compliance automation. For example, the one or more processing circuits can provide a prospective entity seeking to purchase or implement a cybersecurity tool with compliance data related to protection plans that the prospective entity is qualified for based on potentially implementing the cybersecurity tool (e.g., whether the entity would comply with protection parameters of a cybersecurity plan if the entity implemented the security tool). This data can be provided via a security tool dashboard of the vendor and can allow the entity to purchase a protection plan via the dashboard, thereby shifting the point of purchase to the security tool application. In some implementations, the one or more processing circuits can be configured to use a ZKP method of matching posture to protectability. For example, the one or more processing circuits can be configured to use a Zero-Knowledge Proof model to determine whether a prospective entity is qualified and provide this information to a protection entity without exposing the underlying identity of the prospective entity. In some implementations, the one or more processing circuits can be configured to unify tools for assessing protectability based on cybersecurity posture, identifying cybersecurity/protection gaps, and/or suggesting solutions, and/or further to quantify business impact (QBI), enhance resilience, and/or automate policy renewal processes. For example, the one or more processing circuits can be configured to integrate with cybersecurity assessment platforms to automatically evaluate the security measures of the entity, pinpoint specific vulnerabilities, recommend corrective actions, quantify the potential business impact of identified vulnerabilities, and/or continuously monitor the cybersecurity posture of an entity for further updates. In some implementations, the one or more processing circuits can be configured to allow a protection entity to perform bulk trading of entity policies matching proof criteria. For example, the one or more processing circuits can be configured to aggregate compliance data and cybersecurity evaluations (e.g., in bulk) and to allow protection entities to efficiently identify and transact policies in bulk for entities that meet or exceed the requisite cybersecurity protection parameters corresponding to one or more cybersecurity protection plans, thereby streamlining the underwriting process.

In a broad overview of method 400, at block 410, the one or more processing circuits (e.g., response system 130 of FIG. 1) can receive a protection request. At block 420, the one or more processing circuits can determine a security posture. At block 430, the one or more processing circuits can determine a cybersecurity protection plan. At block 440, the one or more processing circuits can provide, via a security tool, the cybersecurity protection plan. At block 450, the one or more processing circuits can receive an acceptance. At block 460, the one or more processing circuits can embed the proof into the acceptance and record the acceptance.

At block 410, the one or more processing circuits (e.g., response system 130 of FIG. 1) can receive a protection request. In some implementations, at block 410, the one or more processing circuits can receive, via a vendor security tool application, a cybersecurity protection request from an entity. For example, the one or more processing circuits can receive a request for cybersecurity protection (e.g., inquiry regarding cybersecurity protection plan, etc.) from a client device by the entity or other user interacting with an interface system, such as a graphical user interface (GUI). In some implementations, the cybersecurity protection request received at block 410 can include entity data of the entity. For example, the cybersecurity protection request received by the one or more processing circuits can include legal/regulatory data (e.g., regulatory impact, privacy impact, etc.), firmographic data (e.g., industry, revenue, etc.), and/or cybersecurity data (e.g., safeguards, root cause, etc.) of the entity.

At block 420, the one or more processing circuits can determine a security posture. In some implementations, at block 410, the one or more processing circuits can determine a cybersecurity posture with proof based on the entity data. For example, the one or more processing circuits can process data received via the vendor security tool application (e.g., entity data related to firmographics, security measures, etc.) and output a cybersecurity posture with proof. In some implementations, the proof includes one or more digital signatures and authenticated data (e.g., of an entity, related to a security posture, etc.). In some implementations, a cybersecurity posture determined at block 410 can be a data package encapsulating/encoding the cybersecurity disposition (e.g., a mapping of compliances, firmographic insights, protective measures, etc.) of the entity. For example, the cybersecurity posture can integrate data reflecting the encryption protocols of the entity, which can be used by a vendor, provider, or protection entity to assess the alignment by the entity with cybersecurity benchmarks and standards (e.g., ISO 27001 certification). In some implementations, the cybersecurity posture can include a verifiable account of the cybersecurity measures (e.g., implementation of advanced threat detection systems like MDR and endpoint detection and response solutions) of the entity.

At block 430, the one or more processing circuits can determine a cybersecurity protection plan. In some implementations, at block 430, the one or more processing circuits can determine, utilizing one or more protection parameters (e.g., vendor parameters or rules, insurance parameters or rules, regulatory parameters or rules certification authorities (CAs) parameters or rules, technology partners parameters or rules, audit and compliance firms parameters or rules, cybersecurity framework organizations parameters or rules), at least one cybersecurity protection plan corresponding to a cybersecurity attribute to protect the entity based on the cybersecurity posture with the proof. For example, the one or more processing circuits can identify and generate a cybersecurity protection plan (e.g., ransomware protection plan), and/or the cybersecurity protection plan can correspond to a cybersecurity attribute (e.g., confidentiality, integrity, authentication, etc.) of the entity. In some implementations, the cybersecurity protection plan determined by the one or more processing circuits at block 430 can be based on the cybersecurity posture of the entity and based on the proof (e.g., digital signatures, authenticated cybersecurity data, etc.). For example, the one or more processing circuits can identify and generate a cybersecurity protection plan by comparing and mapping compliances (e.g., regulatory and privacy impacts) of the entity, firmographic insights (e.g., industry classification and revenue metrics) of the entity, data related to protective measures (e.g., encryption standards, MDR, etc.) implemented by the entity, etc. to requirements (e.g., protection eligibility) of the cybersecurity protection plan (e.g., encryption standards, managed detection and response (MDR) system requirements, entity size/revenue requirements, etc.).

Still referring to block 430, the determining step executed by the processing circuits includes a computational assessment to map the cybersecurity posture of the entity against a set of protection parameters. The process can include analyzing various dimensions of the cybersecurity framework of the entity, including but not limited to, encryption protocols, the deployment of security measures such as firewalls, intrusion detection systems, and/or anti-malware tools, the adherence by the entity to regulatory standards, and/or so on. For example, if an entity operates within a highly regulated industry such as finance or healthcare, the processing circuits account for compliance measures like HIPAA or GDPR in shaping the protection plan. This ensures the plan offers coverage for potential cybersecurity incidents and aligns with legal obligations.

Furthermore, the generation of a cybersecurity protection plan includes predicting potential vulnerabilities and simulating threat scenarios based on the current cybersecurity posture of the entity. This determining step uses can use data analytics and machine learning algorithms to identify patterns and predict risks, incorporating both historical data on cyber incidents within similar industry sectors and real-time data from the own network of the entity. For example, if the data analysis by the entity reveals a recurrent pattern of phishing attacks, the proposed protection plan might prioritize coverage for incidents stemming from such breaches, including financial loss and data restoration costs. Additionally, the plan might suggest specific preventative measures, like enhanced employee training on phishing identification and response strategies, integrating both protection and prevention into the cybersecurity framework of the entity. In some implementations, the cybersecurity protection plan is designed to change in response to the dynamic nature of cyber threats and the changing cybersecurity landscape of the entity. As such, the processing circuits can also establish parameters for periodic re-evaluation of the cybersecurity posture of the entity and subsequent plan adjustments. For instance, if an entity upgrades its cybersecurity infrastructure by implementing a new Endpoint Detection and Response (EDR) system, this enhancement could be factored into the re-assessment process, potentially leading to adjustments in the protection coverage and cost structure to reflect the reduced risk level.

At block 440, the one or more processing circuits can provide, via a vendor security tool application, the cybersecurity protection plan. In some implementations, at block 440, the one or more processing circuits can provide, to a graphical user interface (GUI) of the vendor security tool application of the entity computing system of the entity, the at least one cybersecurity plan (e.g., to the entity). For example, the cybersecurity protection plan determined by the one or more processing circuits at block 430 can be transmitted and displayed via the one or more processing circuits (e.g., using a graphical user interface (GUI)) at block 440. In some implementations, the cybersecurity protection plan provided via the vendor security tool application at block 440 can include at least one selectable element (e.g., digital button, drag-n-drop, etc.). For example, the entity can interact with the selectable element (e.g., via pressing, clicking, etc.) to select one or more options related to the cybersecurity protection plan (e.g., “Yes”/“No”, “I agree,” etc.). For example, the entity can accept (e.g., digitally sign/approve) the cybersecurity protection plan using the selectable element.

At block 450, the one or more processing circuits can receive an acceptance. In some implementations, at block 450, the one or more processing circuits can receive, from the vendor security tool application, an acceptance of the at least one cybersecurity protection plan. For example, the one or more processing circuits can receive an acceptance of the cybersecurity protection plan via the user (e.g., entity) interacting with the one or more processing circuits via an application of a client device (e.g., by using a GUI, etc.) at block 450. For example, the entity can accept the at least one cybersecurity protection plan by selecting an “Accept” button, by providing a digital signature, etc., and/or the acceptance by the entity can be received by the one or more processing circuits via network, as described regarding FIG. 1.

At block 460, the one or more processing circuits can record the acceptance. In some implementations, at block 460, the one or more processing circuits can record the acceptance with proof embedded in a compliance dataset. For example, the one or more processing circuits can store data related to the acceptance of the cybersecurity protection plan of the entity in a data store for compliance verification, and/or the one or more processing circuits can embed the proof (e.g., compliance certifications, digital signatures, etc.) within the stored data. Furthermore, the acceptance stored in the compliance dataset can be stored on a distributed ledger, or on an external data store. In some implementations, at block 460, the acceptance recorded by the one or more processing circuits can include the cybersecurity attribute and the accepted cybersecurity protection plan. For example, the data recorded in the compliance dataset by the one or more processing circuits at block 460 scan include data related to the cybersecurity attribute (e.g., confidentiality, integrity, authentication, etc.) and the accepted cybersecurity protection plan (e.g., artifact/identifier of signed/accepted breach protection plan, etc.). Furthermore, the compliance dataset used to embed the proof into the acceptance and record the acceptance at block 460 can be a dataset/data structure configured to be monitored to ensure ongoing compliance with the accepted cybersecurity requirements (e.g., encryption protocol compliance, security patching cadence, and/or access control integrity, such as SSL/TLS standards for data in transit, frequency of security updates, implementation of least privilege principles, etc.) of the cybersecurity protection plan.

In some implementations, the one or more processing circuits can further receive or collect environmental data from computing and networking structures of the entity for posture-based modeling. For example, the entity can input environmental data using the one or more processing circuits, which can be transmitted via a network and received for further use in posture-based modeling. Furthermore, the environmental data can include information related to the computing and networking infrastructure of the entity such as hardware and software setups, security mechanisms, and/or network layouts (e.g., firewall rules, server specifications, network connections, etc.).

In some implementations, the one or more processing circuits can further record the environmental data received/collected from the computing and networking structures of the entity in the compliance dataset. For example, the one or more processing circuits can store/catalog environmental data in a data set. Furthermore, the compliance dataset can be a structured dataset stored in a data store and used to determine the compliance by the entity with various requirements (e.g., protection parameters) of the cybersecurity plan (e.g., GDPR compliance, minimum data encryption standards, etc.).

In some implementations, determining the at least one cybersecurity protection plan by the one or more processing circuits can include executing a zero-knowledge proof (ZKP) model to determine the cybersecurity posture of the entity (e.g., readiness, resilience) against the one or more protection parameters. As described herein and above, zero-knowledge proofs (ZKPs) are a cryptographic method allowing one party (the prover) to prove to another party (the verifier) that a certain statement is true without revealing any information about the statement itself beyond its veracity. In some implementations, the ZKP model used by the one or more processing circuits to determine the cybersecurity posture of the entity can maintain anonymity of all or a portion of the data used in determining the at least one cybersecurity protection plan. For example, the one or more processing circuits can execute ZKPs to match entity posture to protectability, allowing the entity to prove compliance with protection parameters (e.g., encryption standards, endpoint security) without revealing underlying data (e.g., sensitive user data, classified cybersecurity data, etc.) of the entity and data related to the security tool (e.g., proprietary source code used in cybersecurity product, etc.). Furthermore, the one or more processing circuits can verify, using the ZKP model, the adherence by the entity to required security measures (e.g., SHA-256 encryption for data at rest, TLS 1.3 for data in transit, etc.) without exposing actual encryption keys of data being encrypted. For example, the ZKP model can be used by the one or more processing circuits to confirm the deployment of next-generation firewalls (NGFWs) required by protection parameters of the cybersecurity protection plan by the entity (e.g., vendor protection, insurance protection, regulatory protection). Further, in some implementations, the anonymity of the entity is maintained until acceptance. For example, the one or more processing circuits, utilizing the ZKP model, can prevent a protection entity from learning the identity of a prospective entity prior to acceptance of the protection plan (e.g., before the prospective entity/the representative of the prospective entity accepts the provided security plan).

In some implementations, (1) determining at least one cybersecurity protection plan; (2) providing the at least one cybersecurity protection plan, (3) receiving the acceptance, and/or (4) recording the acceptance can correspond to quoting, binding, and/or issuing (QBI) of the cybersecurity protection plan. For example, the one or more processing circuits can further analyze qualitative business impact (QBI) and resilience against cybersecurity threats of the computing infrastructure of the entity in performing the various steps described above. For example, the one or more processing circuits can unify and analyze data related to the QBI to assess the potential financial loss, reputation damage, and/or operational downtime associated with cybersecurity incidents (e.g., data breaches, ransomware attacks, DDoS attacks, etc.). In some implementations, determining the at least one cybersecurity protection plan further includes quoting the cybersecurity protection plan based on matching the cybersecurity posture of the entity to the cybersecurity attribute. For example, the one or more processing circuits can compare the cybersecurity posture of the entity to cybersecurity attributes of one or more protection plans (e.g., by filtering based on protection parameters, by using GAI/ML techniques, etc.) to determine whether the entity meets various criteria (e.g., protection parameters) of the one or more protection plans and determine a protection quote (e.g., premiums, payments schedule, reimbursement, etc.) based on the identified protection plans and the cybersecurity posture of the entity. Further, in this example, the one or more processing circuits can examine the robustness of security measures (e.g., deployment of redundant systems), determine the effectiveness of incident response plans (e.g., using historical/predictive datasets and models), and/or analyze other entity datasets and security tools and further generate a protection quote based on the above analysis.

For example, the one or more processing circuits can use an artificial intelligence (AI) or machine learning (ML) model (e.g., generative AI (GAI), large-language model, supervised learning model, etc.) to predict the impact of specific vulnerabilities within the network (e.g., unpatched software, outdated hardware) of the entity, simulate model potential attack paths (e.g., using cyber penetration testing tools), and/or determine potential business impacts based on the QBI. In some implementations, providing the at least one cybersecurity protection plan, receiving the acceptance, and/or recording the acceptance corresponds to binding and issuing the at least one cybersecurity protection plan based on (1) transmitting a first API call to create a protection binder and (2) transmitting a second API call to issue the at least one cybersecurity protection plan. For example, the one or more processing circuits can bind (e.g., signify the protection commitment by the entity to the protection agreement before the actual protection policy is issued) and issue (e.g., finalize the protection coverage by preparing and sending the formal policy documents to the entity) the protection plan by executing API calls (e.g., for submitting a protection application such as cybersecurity application, protection application, insurance application, third party application, quoting an protection application, creating a protection binder, issuing a corresponding cyber plan, etc.), and/or the API calls executed by the one or more processing circuits can include data payloads for various uses in aligning security posture to protection requirements. In some implementations, the first API call can include a first data payload including an entity identification, cybersecurity protection plan information, and/or a temporary protection agreement identifier. In some implementations, the second API call can include a finalized protection policy document, a permanent policy identifier, and/or confirmation of policy activation covering the entity under the at least one cybersecurity protection plan.

In some implementations, the one or more processing circuits can further automatically renew the cybersecurity protection plan of the entity based on the modeled cybersecurity posture and resilience. For example, the one or more processing circuits can evaluate and update the cybersecurity protection plan parameters (e.g., encryption requirements, regulatory standards, coverage levels, deductible amounts) by analyzing the modeled cybersecurity posture and resilience to extend or renew the term (e.g., period of effect) of the cybersecurity protection plan. For example, the one or more processing circuits can process the renewal of the cybersecurity protection plan by assessing adherence to encryption standards (e.g., AES-256 for data at rest, TLS 1.3 for data in transit), compliance with regulatory standards (e.g., GDPR for data protection, SOC 2 for service organizations), and/or more. For example, one or more processing circuits can map data associated with the adherence by the entity to cybersecurity standards (e.g., based on the cybersecurity posture of the entity) to various protection parameters of a cybersecurity protection plan, and/or further update the cybersecurity protection plan (e.g., by changing/recalibrating the cybersecurity parameters of the plan, by generating a new plan, etc.) based on the adherence by the entity with the plan requirements, thereby unifying protectability tools for autorenewal.

In some implementations, the one or more processing circuits can further dynamically update the at least one cybersecurity protection plan based at least on an update in a cybersecurity landscape or a change in one or more protection preferences of the entities. For example, the one or more processing circuits can adjust the cybersecurity protection plan (e.g., by adjusting cybersecurity protection parameters) in response to emerging threats (e.g., zero-day exploits, advanced persistent threats), new compliance requirements (e.g., updates to international data protection laws), or other changes in the cybersecurity landscape identified by the one or more processing circuits. Furthermore, one or more processing circuits can update or refine the cybersecurity protection plan based on changes in the protection preferences of the entity. For example, an entity can change its protection preferences when implementing more enhanced data privacy measures in light of increasing regulatory scrutiny (e.g., changing protection preferences to a higher value associated with a higher degree of cybersecurity protection, etc.). Based on evaluating the update and changes, the one or more processing circuits can adjust the cybersecurity protection plan to match the current risk profile and cybersecurity needs (e.g., extending coverage to new digital assets, recalibrating premiums based on risk assessment outcomes, renewing a plan, generating a new plan, etc.) of the entity. For example, one or more processing circuits can update one or more protection parameters to ensure the related protection plan is dynamically aligned with the evolving security requirements of the entity and the external cybersecurity environment.

In some implementations, the one or more processing circuits can further perform bulk trading of entity policies matching proof criteria for posture-based modeling, as described in detail below. In some implementations, the one or more processing circuits can receive, from a provider computing system, a bundle request from a protection provider (sometimes referred to herein as a third party, protection entity, e.g., vendor, insurer, certification authorities (CAs), technology partners, audit and compliance firms, cybersecurity framework organizations). For example, the one or more processing circuits can receive, from the provider computing system (e.g., client device) a bundle request for multiple protection policies that meet certain cybersecurity posture requirements (e.g., MDR system criteria). Furthermore, the bundle request can specify criteria (e.g., proof criteria) such as the presence of continuous monitoring tools, adherence to specific cybersecurity frameworks (e.g., ISO/IEC 27001, NIST), or a minimum score on cybersecurity posture assessments, and/or the one or more processing circuits can execute functions/algorithms to assess which policies in the market comply with these proof criteria. For example, the bundle request can be generated by the one or more processing circuits based on parsing through policy attributes, analyzing historical claims data for risk assessment, and/or evaluating compliance certifications that entities possess. Once a match between cybersecurity protection plans and a group of entities is identified, the one or more processing circuits can facilitate the bulk trading of the matched policies to a cybersecurity protection provider.

In some implementations, the bundle request can include a set of cybersecurity parameters (e.g., cybersecurity protection plan criteria, such as incident response (IR) plan requirements). In some implementations, the one or more processing circuits can determine a plurality of prospective entities satisfying the set of cybersecurity parameters. For example, the bundle request can include a set of cybersecurity parameters such as required intrusion detection system capabilities (e.g., signature-based, anomaly-based), data encryption levels (e.g., AES 256-bit encryption), and/or endpoint protection standards (e.g., real-time malware scanning, automated patch management). The one or more processing circuits can process data from a database of entities to identify the entities whose cybersecurity measures align with the set of cybersecurity parameters. For example, determining the entities satisfying the criteria can include the one or more processing circuits querying a compliance database or internal compliance report for certifications held (e.g., SOC 2 Type II, PCI DSS compliance), checking configuration management databases for installed security software versions, and/or cross-referencing against security incident and event management logs to determine the efficacy of the cybersecurity implementations (e.g., cost-avoidance based determination, etc.) of the entities. Once the matching entities are identified, the one or more processing circuits can group or bundle the identified entities that meet the bundle request of the protection provider criteria for cybersecurity protection.

In some implementations, the one or more processing circuits can bundle the plurality of prospective entities and corresponding cybersecurity postures into a data package. For example, the one or more processing circuits can bundle the identified prospective entities and corresponding postures into a data package by compiling (e.g., grouping, mapping, etc.) data of the selected entities with data of the security postures of the entities in a unified format (e.g., JSON, XML, etc.). Furthermore, the one or more processing circuits can use data serialization techniques (e.g., converting data structures into JSON format for ease of transmission) and encrypt the package using advanced encryption standards (AES) to ensure data confidentiality and integrity. For example, the bundled package can be timestamped and digitally signed using employing cryptographic hashing (e.g., SHA-256) to protect the data included in the package and to prepare the data package for secure transmission to the protection provider via encrypted communication channels.

In some implementations, the one or more processing circuits can transmit to a plurality of protection entity computing systems, the data package including information of the plurality of prospective entities and corresponding security postures. For example, the one or more processing circuits can transmit the bundled data package to a broker computing system, such as a third party device, by establishing a secure connection utilizing various protocols (e.g., TLS (Transport Layer Security) for data in transit, VPN (Virtual Private Network) tunnel or a dedicated leased line for added security, etc.). Upon establishing the connection, the one or more processing circuits can initiate and execute a secure file transfer protocol (e.g., SFTP or SCP) to send the encrypted and signed data package including information of the plurality of protection plans (e.g., coverage type, reimbursements, other data related to the cybersecurity protection plans and cybersecurity parameters, etc.). Furthermore, the broker computing system can use decryption keys and digital signature verification tools to decrypt, authenticate, and/or process the received data package including information of the plurality of protection plans. In some implementations, the data package includes a customized implementation corresponding to an endorsement or a pricing coverage. For example, the data package can include specific terms (e.g., cyber protection terms) that offer enhanced cybersecurity protection coverage at preferential rates for prospective entities demonstrating strong cybersecurity postures (e.g., robust systems, organizational focus on cyber threats, implementation of specific cybersecurity tools, etc.). Alternatively, the data package can include terms demanding increased premiums or deductibles for entities identified as high-risk (e.g., based on cybersecurity posture, firmographic data of the prospective entity, weak cybersecurity measures implemented, etc.).

In some implementations, the one or more processing circuits can perform bulk trading of entity policies or product policies matching proof criteria according to the process outlined above, but by determining, bundling, or transmitting a plurality of protection plans instead of a plurality of prospective entities/corresponding cybersecurity postures. For example, the one or more processing circuits can receive, from a broker computing system, the bundle request including a set of cybersecurity parameters and determine a plurality of entities (e.g., entities with cyber protection) satisfying the parameters. Further, the one or more processing circuits can identify a plurality of protection plans of the plurality of entities. For example, the one or more processing circuits can identify a plurality of protection plans by retrieving and analyzing policy attributes from a secured database. For example, the one or more processing circuits can execute database search operations (e.g., SQL JOIN queries across policyholder tables and protection plan tables) to cross-reference the protection parameters (e.g., using protection database logs, data on current cybersecurity certifications, risk assessments, etc.) to identify a plurality of protection plans implemented by the entities. The one or more processing circuits can further transmit to a plurality of protection entity computing systems, the data package including information of the plurality of protection plans (e.g., plan type, coverage amount, term, entity cyber requirements/prerequisites, etc.), receive one or more bid requests for the bundled data package, and/or exchange the bundled data package for an amount. For example, the exchange can include the one or more processing circuits assigning the plurality of protection plans of the bundled data package to a protection entity.

For example, the processes outlined above can allow a broker, after digitization of cybersecurity safeguards and configurations of an entity, to present (e.g., independently or by partnering with a security vendor) a set of qualified prospective entities to a protection entity. For example, the set of qualified prospective entities can include a list of entities (e.g., entities seeking cybersecurity protection) and corresponding cybersecurity posture data (e.g., entity firmographic data, data related to cyber implementations, etc.) to be used by a protection entity in determining whether to bid on a portion (e.g., a bulk amount) of the prospective entities. Furthermore, after receiving the entity and cybersecurity data, the protection entities can make special implementations (e.g., endorsements, pricing, coverage, etc.) to encourage the broker to provide the prospective entities included in the list of entities to the protection entity. For example, the protection entity can offer reduced pricing terms (e.g., lower premiums) or additional coverage options (e.g., DDoS coverage) after receiving the list of prospective entities and determining the corresponding cybersecurity postures of the entity are robust (e.g., implementation of multiple cybersecurity tools, compliance with latest industry standards, compliance with regulatory standards, etc.). Furthermore, the bid amount offered by the protection entity or the special implementations made to encourage the broker to send the plurality of entities to the protection entity can be based on a bulk pricing model designed to factor both the number of entities included in the bid (or the entities for which special implementations are offered) and corresponding cybersecurity postures of the entities.

In some implementations, the one or more processing circuits can receive, from one or more broker computing systems, one or more bid requests for the bundled data package. For example, the one or more processing circuits can receive bid requests that include specific parameters such as the desired level of cybersecurity coverage (e.g., coverage against data breaches, ransomware attacks, etc.), preferred premium ranges and payment criteria (e.g., payment periods, late fees, etc.), and/or criteria for cybersecurity compliance standards (e.g., compliance with ISO/IEC 27001, NIST Cybersecurity Framework, etc.). Furthermore, at least one (e.g., each) bid request received by the one or more processing circuits via the one or more broker computing systems can specify the requirements of the broker for policy customization options (e.g., inclusion of cyber incident response services, coverage extensions for cloud-based assets, etc.) to match/align the protection plans with the market demand, cybersecurity landscape changes, and/or specific entity cybersecurity protection needs.

In some implementations, the one or more processing circuits can exchange the bundled data package for an amount based on one of the one or more bid requests. For example, the one or more processing circuits can evaluate and accept a bid request (e.g., offer of monetary sum) that offers optimal terms for the exchange by evaluating various factors related to the one or more bid requests, including the proposed amount and the compliance of the bidder with required cybersecurity practices (e.g., data encryption standards, regulatory compliance, etc.). In some implementations, the exchange (e.g., process of exchanging bundled data package for amount) includes assigning the plurality of protection plans of the bundled data package to a broker. For example, the broker to whom the protection plans are assigned can be a specialized entity with a robust technological infrastructure capable of handling complex data transactions securely (e.g., intermediator). Furthermore, in assigning the protection plans to the broker, the one or more processing circuits can update a transaction ledger to reflect the transfer of ownership (e.g., the exchange of the bundled data package for monetary amount).

In some implementations, the set of cybersecurity parameters can include proof criteria, and/or the proof criteria can include cybersecurity measures and technologies (SMT) of the plurality of entities. For example, the one or more processing circuits can evaluate the bundled data package against the bid requests by applying proof criteria that encompass specific cybersecurity measures and technologies (SMT) of the entities. For example, these proof criteria can include verifying the implementation of Multi-Factor Authentication (MFA) to bolster access control, assessing the effectiveness of Endpoint Detection and Response (EDR) systems in identifying and mitigating cyber threats, evaluating the coverage provided by Managed Detection and Response (MDR) services for comprehensive threat management, etc. In some implementations, determining the at least one cybersecurity protection plan corresponding to the cybersecurity attribute further includes using the proof to ensure compliance with required cybersecurity measures and technologies. Furthermore, the proof used to ensure compliance can include documentation (e.g., security policy documents, incident response plans, employee training completion certificates), compliance proof (e.g., ISO/IEC 27001 certification, GDPR compliance reports, internal compliance reports, etc.), network security proof (e.g., firewall and IDS/IPS configuration snapshots, VPN usage logs), access control proof (e.g., MFA deployment records, access control lists), data protection proof (e.g., encryption protocol details, data backup and recovery audit trails), and/or threat detection and response proof (e.g., EDR alerts history, malware removal reports). Vendor risk management proof (e.g., third party security assessment reports, vendor SLAs). For example, the one or more processing circuits can incorporate digital certificates or blockchain-based records as proof (e.g., stored in a database, distributed ledger, etc.). For example, these proofs can validate that a cybersecurity implementations of the entity, such as MFA, EDR, and/or MDR, meet specific standards set by the cyber protection plan. For instance, a digital certificate could be issued to an entity upon successful implementation of MFA, and/or the one or more processing circuits can use this proof of implementation in determining potential cybersecurity plans for which the entity is qualified. In some implementations, determining the at least one cybersecurity protection plan corresponding to the cybersecurity attribute further includes using one or more tokens to align the entity with the cybersecurity attributes. For example, one or more tokens can serve as digital representations of the compliance by the entity with required cybersecurity measures and technologies, and/or holding a token can indicate that an entity has implemented certain cybersecurity measures (e.g., those that have been validated and are in active use). For example, a token could represent the active and effective use of EDR systems within the network of the entity and be issued following an audit or assessment by a trusted third party or through automated systems capable of independently verifying the presence and effectiveness of EDR systems. In some implementations, the tokens correspond to a verified and authenticated state of the security posture and resilience of the entities. For example, the verified/authenticated state can indicate that the security implementations of the entity have been thoroughly checked for effectiveness and compliance (e.g., verification that a cybersecurity measure is implemented by the entity, that the implemented cybersecurity measure is correctly configured and fully operational (e.g., active), etc.).

In some implementations, the cybersecurity protection plan provided is based on the determined security posture of the entity, and/or the cybersecurity protection plan corresponds to one or more coverage options aligning with the protection preferences of the entity. For example, the one or more processing circuits can analyze the digital infrastructure vulnerabilities (e.g., utilizing data collected from or related to security tools, such as data regarding recent cyber incidents, current defense mechanisms, etc.) of the entity, the cybersecurity needs (e.g., coverage type, amount of coverage, etc.) of the entity, and/or other entity data (e.g., firmographic data such as entity size, revenue, etc.) to determine a cybersecurity protection plan aligning with the cybersecurity needs (e.g., type of protection, integrations, etc.) of the entity, preferences, technical implementations, etc. For example, the one or more processing circuits can process entity data to generate an entity risk profile that includes potential attack vectors (e.g., susceptibility to phishing, ransomware attack history), existing safeguards (e.g., deployment of firewalls, use of secure sockets layer (SSL) encryption for data transmission), and/or areas of compliance (e.g., adherence to the General Data Protection Regulation (GDPR) or the Health Insurance Portability and Accountability Act (HIPAA)). Based on entity risk profiles and the stated cybersecurity needs of the entity, the one or more processing circuits can dynamically configure protection coverage options by providing different cybersecurity protection plans in response to different entity cybersecurity protection preferences, needs, and/or implementations (e.g., necessity of Endpoint Detection and Response (EDR) systems, desire for phishing protection, entity size/revenue, etc.).

### Cyber Resilience Tokenization

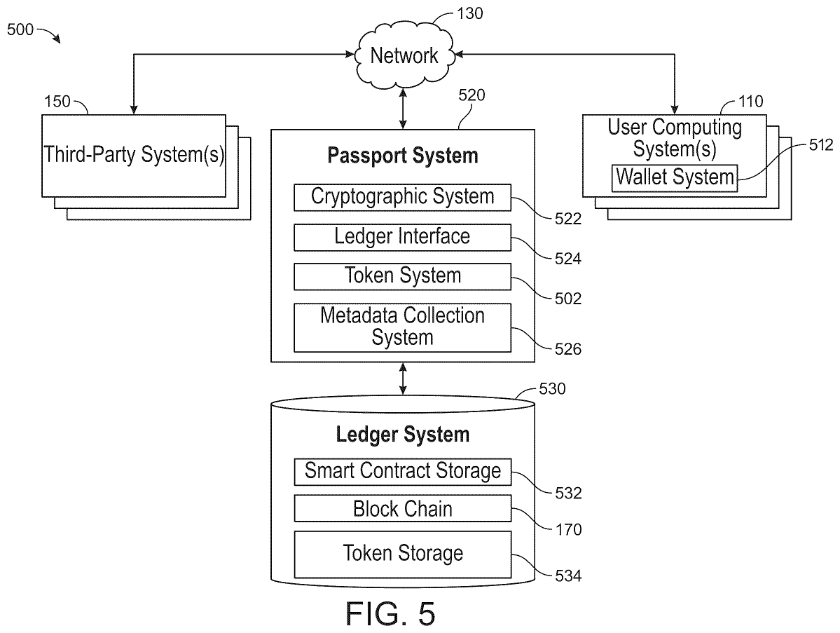

Referring to FIG. 5, a block diagram of an implementation of a system 500 for cyber resilience tokenization is shown, according to some implementations. The implementation shown in FIG. 5 can include client devices 110, third party devices 150 (also referred to herein as “third party device 150”, “third party systems 150”, and/or “third party system(s) 150”), a passport system 520, and/or a ledger system 530. In some implementations, the client devices 110 can include a wallet system 512. In some implementations, the passport system 520 can include a cryptographic system 522, a ledger interface 524, a token system 502, and/or a metadata collection system 526. In some implementations, the ledger system 530 can include smart contract storage 532, blockchain 170, and/or token storage 534. These components can be interconnected through a network 120 that supports secure communications profiles (e.g., TLS, SSL, HTTPS, etc.). In some implementations, the passport system 520 can incorporate the same or similar features and functionality as described regarding the response system 130 of FIG. 1. Although the various computing elements of FIG. 5 can be described in the singular form (e.g., user computing system 50, third party device 150, etc.), it should be understood that the implementation shown in FIG. 5 can include two or more of any device/system described herein (e.g., two or more user computing system(s) 50, two or more third party devices 150, etc.).

At least one (e.g., each) system or device of FIG. 5 can include one or more processors, memories, network interfaces (sometimes referred to herein as a “network circuit”) and user interfaces. The memory can store programming logic that, when executed by the processor, controls the operation of the corresponding computing system or device. The memory can also store data in databases. For example, memory can store programming logic that when executed by a processor within a processing circuit, causes a database to update parameters or store a system or event log. The network interfaces can allow the computing systems and devices to communicate wirelessly or otherwise. The various components of devices in system 100 can be implemented via hardware (e.g., circuitry), software (e.g., executable code), or any combination thereof. Devices, systems, and/or components in FIG. 5 can be added, deleted, integrated, separated, and/or rearranged in various implementations of the disclosure.

Generally, the client devices 110, third party devices 150, passport system 520, and/or ledger system 530, wallet system 512, cryptographic system 522, ledger interface 524, token system 502, metadata collection system 526, smart contract storage 532, blockchain 170, token storage 534, and/or network 120 can include one or more logic devices, which can be one or more computing devices equipped with one or more processing circuits that run instructions stored in a memory device to perform various operations. The processing circuit can be made up of various components such as a microprocessor, an ASIC, or an FPGA, and/or the memory device can be any type of storage or transmission device capable of providing program instructions. The instructions can include code from various programming languages commonly used in the industry, such as high-level programming languages, web development languages, and/or systems programming languages. The client devices 110, third party devices 150, passport system 520, and/or other various components of FIG. 5 can also include one or more databases for storing data that receive and provide data to other systems and devices on the network 120.

Generally, the passport system 520 can execute and be utilized to execute various processes and tasks corresponding with modeling cyber resilience data. For example, the passport system 520 can provide a single sign-on gateway (e.g., using an identity management system like AuthO) facilitating access to the associated security posture of the user, threat, incident, and/or insurance data sets using data sets encapsulated within various tokens. For example, the passport system 520 can generate a token (e.g., a passport) linked to various additional tokens and further linked to a control structure restricting access to one or more of the additional tokens based on rules (e.g., RBACs). For example, a cyber resilience identifier (e.g., passport) of an entity can include entity data and additional cyber resilience data stored in tokens, and/or the passport system 520 can provide and restrict access to one or more portions of the tokenized data based on various conditions, entity types, data types, regulations, and/or so on. That is, an entity can have a control structure with access controls and a passport created by the passport system 520 linked to both sensitive (e.g., private) and non-sensitive (e.g., public) data, and/or the passport system 520 can deny access (e.g., to sensitive data) and provide access (e.g., to non-sensitive data) based the access control (e.g., whether the user to access the data is a customer, insurer, vendor, MDR/XDR provider, etc.).

Generally, the passport system 520 can provide secure access to token-related data and facilitate interactions between different cybersecurity systems and data sources of FIG. 5 (e.g., client device 110, third party devices 150, ledger system 530, etc.) based on various access controls. For example, the passport system 520 can create a cyber resilience identity with tokens and rule-based access controls controlling access to the tokens. For example, the passport system 520 can generate a passport for a third party linked to controls such that the third party can only access their own data within the token structure. In some implementations, a third party entity can use the passport system 520 to access performance tokens stored in the token structure, such as in a passport associated with the cybersecurity status of an entity, with RBAC rules restrict other entities from viewing or modifying these tokens. Another example can include third party vendors having access to their own evaluation tokens that include the results of security assessments relevant to their services, without the ability to access data from other vendors.

In some implementations, the passport system 520 can include one or more processing circuits, including processor(s) and memory. The memory can have instructions stored thereon that, when executed by processor(s), cause the one or more processing circuits to perform the various operations described herein. The operations described herein can be implemented using software, hardware, or a combination thereof. The processor(s) can include a microprocessor, ASIC, FPGA, etc., or combinations thereof. In many implementations, the processor(s) can be a multi-core processor or an array of processors. Memory can include, but is not limited to, electronic, optical, magnetic, or any other storage devices capable of providing processor(s) with program instructions. The instructions can include code from any suitable computer programming language. In some implementations, the passport system 520 can include an interface circuit and function circuit.

In some implementations, the passport system 520 can model cyber resilience data using cyber resilience identities and associated metadata. For example, the passport system 520 can use templates to structure cyber resilience data and apply attributes to model various cyber resilience metrics (e.g., threat detection capabilities, response readiness). In some implementations, the passport system 520 can receive or identify cyber resilience data. For example, the passport system 520 can collect data from various sources, including security incident reports, vulnerability assessments, and/or system performance metrics. In some implementations, the passport system 520 can encrypt a portion of the cyber resilience data. For example, the passport system 520 can apply cryptographic techniques to secure sensitive information within the cyber resilience dataset, such as private keys or confidential incident data. In some implementations, the passport system 520 can generate a metadata object including metadata of cyber resilience data. For example, the metadata object can include information such as data creation timestamps, data source identifiers, and/or encryption keys. In some implementations, the passport system 520 can generate a cyber resilience identity including at least a link with the metadata object, a unique identifier (UID), and/or a performance event dataset. For example, the cyber resilience identity can include a URI linking to the metadata object, a UID for tracking the identity, and/or a dataset summarizing key performance events.

In some implementations, the passport system 520 can encapsulate the cyber resilience identity within a control structure restricting one or more updates and redemptions of the metadata object. For example, the control structure can use access controls and permission rules to prevent unauthorized modifications or access to the metadata object. In some implementations, the passport system 520 can determine at least one access data structure being compatible with the control structure. For example, the passport system 520 can analyze data structures such as access control lists (ACLs) or role-based access controls (RBAC) to facilitate compatibility with the control structure. In some implementations, the passport system 520 can broadcast, using the control structure, the cyber resilience identity to a ledger or distributed ledger. For example, the passport system 520 can publish the cyber resilience identity to a blockchain or distributed ledger, and/or the identify can be securely recorded and accessed by authorized entities via the distributed ledger.

In some implementations, the token system 502 can generates various tokens. In some implementations, the token system 502 can generate cyber resilience identities (e.g., a passport including a token linked to various additional tokens with metadata). That is, generating the cyber resilience identities can include generating tokens that include metadata objects or metadata with information corresponding to components and metrics of a cybersecurity posture of the entity, such as firmographic information, security safeguards, threat detection capabilities, incident response data, compliance metrics, or other relevant cybersecurity information. For example, the token system 502 can generate, mint, or otherwise create unified safeguard tokens, unified requirements tokens, performance tokens, coverage tokens, incident readiness tokens, insurability readiness tokens, gap tokens, effectiveness tokens, and/or various additional tokens. For example, the token system 502 can structure a token to encapsulate data sets related to different aspects of cybersecurity such that a set of tokens can facilitate an evaluation of the security status (e.g., by an insurer or vendor) of the entity. The various tokens generated by the token system 502 and encapsulated in cyber resilience identities are described in greater detail herein.

In some implementations, the cyber resilience identities can include a coverage token. The coverage token can be structured to store information about insurance policies, including policy numbers, premium amounts, and/or coverage data. That is, the token system 502 can generate a coverage token when the insurance coverage data of the entity need to be documented and managed. For example, the coverage token can be created to include policy information such as the insured client, domain, and/or premium data. In generating the cyber resilience identities, the coverage token generated by the token system 502 can include data on insurance coverage, retention terms, and/or claims associated with the policy. For example, the coverage token can store data related to premium payment schedules, policy numbers, and/or claim UIDs that are linked to an insurance policy of an entity corresponding to a cyber resilience identity.

In some implementations, the cyber resilience identities can include an effectiveness token. The effectiveness token can be structured to store a record of the security effectiveness of the organization over time, linking to historical data through performance tokens and capturing outcomes related to incidents and claims. That is, the token system 502 can generate an effectiveness token to document and evaluate the results of past and ongoing security measures within an organization. For example, the effectiveness token can be generated to include the unique effectiveness token UID, the creation date, a list of performance tokens, and/or outcomes related to security incidents and claims. In generating the cyber resilience identities, the effectiveness token generated by the token system 502 can include references to associated performance tokens, incident tokens, and/or claims tokens, providing a longitudinal view of security effectiveness. For example, the effectiveness token can include data indicative of how various incidents have impacted the security posture of the organization over time, including the effectiveness of response efforts and any gaps identified during evaluations.

In some implementations, the cyber resilience identities can include a gaps token. The gaps token can be structured to record and track information about vulnerabilities and compliance issues within the IT infrastructure of the organization. That is, the token system 502 can generate a gaps token to identify and monitor security gaps that could affect the cybersecurity posture of the organization. For example, the gaps token can be generated to include a unique gap UID, timestamp, description of the vulnerability, impact description, severity rating, and/or recommended actions for remediation. In generating the cyber resilience identities, the gaps token generated by the token system 502 can include metadata about at least one (e.g., each) identified gap, including the category of the threat, impact on confidentiality, integrity, and/or availability, and/or references to external resources for further information. For example, the gaps token can capture the severity of a local privilege escalation vulnerability in the IT infrastructure of the organization and provide recommendations for mitigating the threat.

In some implementations, the cyber resilience identities can include an IOC (Indicators of Compromise) token. The IOC token can be structured to store and describe indicators of malicious activity detected within the environment of the organization. That is, the token system 502 can generate an IOC token to catalog and track known indicators of compromise that are associated with cybersecurity incidents. For example, the IOC token can be generated to include a unique indicator UID, type of indicator (e.g., file hash), description of the indicator, and/or a pattern representing the malicious activity. In generating the cyber resilience identities, the IOC token generated by the token system 502 can include data such as the confidence level in the indicator (e.g., high, medium, low, or a scale between 1 and 10), the type of malicious activity it represents, and/or the pattern or signature detected. For example, the IOC token can store information about a malicious file hash associated with a known malware instance, helping to identify and respond to similar threats in the future.

In some implementations, the cyber resilience identities can include an incident token. The incident token can be structured to capture information about a cybersecurity incident, including the type, date, outcome, and/or associated claims data. That is, the token system 502 can generate an incident token when it is necessary to document and manage the lifecycle of a cybersecurity incident within an organization. For example, the incident token can be generated to include a unique incident UID, the title of the incident, incident data such as the type of attack, impacted data, response actions taken, and/or the associated costs. In generating the cyber resilience identities, the incident token generated by the token system 502 can include references to related tokens, such as TTPs (Tactics, Techniques, and/or Procedures) tokens, IOC tokens, and/or breach team data, providing an overview of the incident. For example, the incident token can document the timeline of a ransomware attack, the response efforts, the root cause analysis, and/or the financial impact on the organization.

In some implementations, the cyber resilience identities can include a performance token. The performance token can be structured to provide a record of evaluations associated with safeguards and requirements within an organization at a time. That is, the token system 502 can generate a performance token when to store the results of evaluations and assessments related to the cybersecurity safeguards of the organization. For example, the performance token can be generated to include a unique performance token UID, the date of creation, safeguard results, safeguard transformation results, and/or comparison results against predefined requirements. In generating the cyber resilience identities, the performance token generated by the token system 502 can include outcomes of safeguard evaluations, transformation proofs, and/or any identified gaps in compliance at a point in time. For example, the performance token can track the effectiveness of endpoint security measures, document how well the measures meet the thresholds, and/or identify areas for improvement.

In some implementations, the cyber resilience identities can include a ransom token. The ransom token can be structured to capture data about a ransomware incident, including ransom demands, payment data, and/or outcomes. That is, the token system 502 can generate a ransom token when it is necessary to document and manage the specifics of a ransomware event within an organization. For example, the ransom token can be generated to include a unique ransom UID, the incident UID it is associated with, data of the ransomware attack such as the group involved, payment wallet address, currency type, and/or the outcome of the payment. In generating the cyber resilience identities, the ransom token generated by the token system 502 can include references to the breach team involved, post-incident follow-up data, and/or information about the threat actor. For example, the ransom token can document the financial impact of the ransom payment, the success rate of data decryption, and/or ongoing risks posed by the threat actor.

In some implementations, the cyber resilience identities can include a TTPs (Techniques, Tactics, and/or Procedures) token. The TTPs token can be structured to provide an overview of a detected cybersecurity threat event, outlining the tactics, techniques, and/or procedures identified. That is, the token system 502 can generate a TTPs token when it is necessary to document and analyze adversarial behaviors detected during a cybersecurity incident. For example, the TTPs token can be generated to include a unique TTP UID, the event data such as the event code, provider, start and end time, and/or description of the event, as well as information about the threat, including the tactic employed, techniques used, procedures followed, and/or the threat actor involved. In generating the cyber resilience identities, the TTPs token generated by the token system 502 can include observations from the event, such as the actions taken by the adversary, the outcome of those actions, and/or any data artifacts observed. For example, the TTPs token can document a phishing attack, detailing how it was executed, the tools used by the attacker, and/or the impact on the organization.

In some implementations, the cyber resilience identities can include a unified asset token. The unified asset token can be structured to provide information about the assets managed within an organization, including types, operational statuses, and/or associated identifiers. That is, the token system 502 can generate a unified asset token when to document and manage the lifecycle of assets within the IT infrastructure of the organization. For example, the unified asset token can be generated to include a unique asset UID, the date of creation, asset data such as type, name, description, location, and/or owner, and/or the operational status of the asset. In generating the cyber resilience identities, the unified asset token generated by the token system 502 can include identifiers and sources related to the asset, such as inventory data, cloud provider information, and/or any additional metadata. For example, the unified asset token can document the operational status of the server, its cloud instance data, and/or any associated identifiers such that an organization can track and monitor assets.

In some implementations, the cyber resilience identities can include an incident readiness token. The incident readiness token can be structured to capture the attributes that demonstrate the preparedness of the organization for responding to cybersecurity incidents. That is, the token system 502 can generate an incident readiness token to document and verify the ability of the organization to handle cybersecurity incidents effectively. For example, the incident readiness token can be generated to include a unique incident readiness UID, the associated passport UID, and/or a description of the readiness of the organization to respond to cybersecurity incidents. In generating the cyber resilience identities, the incident readiness token generated by the token system 502 can include attributes such as the incident response plan, training and awareness programs, tools and technologies used, and/or testing exercises conducted. For example, the incident readiness token can document the annual incident response plan updates of the organization, quarterly training sessions of the organization, and/or various additional tools and technologies of the organization in place to detect and mitigate cybersecurity threats.

In some implementations, the cyber resilience identities can include an insurability readiness token. The insurability readiness token can be structured to capture the attributes used for an organization to qualify for cybersecurity insurance, including risk assessments, security measures, and/or incident history. That is, the token system 502 can generate an insurability readiness token when it is necessary to document and assess the preparedness of the organization for obtaining cybersecurity insurance. For example, the insurability readiness token can be generated to include a unique insurability readiness UID, the carrier UID, the associated passport UID, and/or a description of the preparedness of the organization for cybersecurity insurance. In generating the cyber resilience identities, the insurability readiness token generated by the token system 502 can include attributes such as risk assessments, security measures, documentation and compliance, and/or incident history. For example, the insurability readiness token can document the annual risk assessments of the organization, the implementation of strong cybersecurity controls of the organization, and/or the effective mitigation of past incidents of the organization, providing an overview of the qualifications of the organization for cybersecurity insurance.

In some implementations, the cyber resilience identities can include or be associated with a passport, which can be a token or a distinct entity interacting with other tokens. The passport can be structured to encapsulate information about an entity, including firmographic data, indicators of cybersecurity readiness, and/or more. That is, the token system 502 can generate or link to a passport to provide certain information corresponding to a cybersecurity posture of the entity and readiness for insurance purposes. For example, the passport can contain or link to various tokens, such as unified safeguard tokens, unified requirements tokens, performance tokens, coverage tokens, incident readiness tokens, insurability readiness tokens, gap tokens, effectiveness tokens, and/or various additional tokens. For example, the token system can generate a cyber resilience identity or passport providing access to metadata inclusive of various cyber resilience data (e.g., legal structure of the entity, number of protected records of the entity, preparedness for cyber insurance of the entity, etc.) through linked tokens. Additional, token system can 502 can generate the passport linked with a control structure to limit access to data and updates, as further described herein.

In some implementations, the wallet system 512 can include one or more processing circuits, including processor(s) and memory. The memory can have instructions stored thereon that, when executed by processor(s), cause the one or more processing circuits to perform the various operations described herein. The operations described herein can be implemented using software, hardware, or a combination thereof. The processor(s) can include a microprocessor, ASIC, FPGA, etc., or combinations thereof. In many implementations, the processor(s) can be a multi-core processor or an array of processors. Memory can include, but is not limited to, electronic, optical, magnetic, or any other storage devices capable of providing processor(s) with program instructions. The instructions can include code from any suitable computer programming language. In some implementations, the wallet system 512 can include an interface circuit and function circuit.

In some implementations, the wallet system 512 can include a storage mechanism for holding digital assets, including cyber resilience tokens, private keys, and/or access credentials. In some examples, the wallet system 512 can perform cryptographic operations to encrypt and decrypt token-related data and sign transactions, authenticating the client device 110 during interactions with the passport system 520 and the ledger system 530. The wallet system 512 can manage permissions and access control so that authorized can entities initiate or authorize updates to the cyber resilience tokens stored within the ledger system 530. In some implementations, the wallet system 512 can communicate with dynamic non-fungible tokens (DNFTs) or other various tokens (e.g., fungible tokens, semi-fungible tokens, fractionalized tokens, synthetic tokens, quantum-resistant tokens, cross-chain tokens) or cryptographic elements (e.g., digital signatures, hashes, encryption keys, zero-knowledge proofs, homomorphic encryption keys, lattice-based cryptographic keys, quantum entanglement signatures) associated with the cyber resilience identity. For example, the wallet system 512 can store and manage multiple NFTs or DNFTs representing different aspects of a cybersecurity posture (e.g., cyber resilience status) of an organization or entity. The wallet system 512 can facilitate updates to the tokens by performing cryptographic operations that validate and record changes to the cybersecurity data encapsulated within the DNFTs. The wallet system 512 can also provide an interface that authorized entities use to access and manage the DNFTs, facilitating the review and assessment of the cybersecurity posture of the entity over time.

In another example, a quantum-resistant token can be structured to secure cyber resilience data against potential attacks from quantum computers using post-quantum cryptographic techniques, and/or the wallet system 512 can store, manage, and/or facilitate access to these tokens within a cyber resilience identity framework. In yet another example, a zero-knowledge proof can be a cryptographic method allowing verification of certain cybersecurity attributes (e.g., compliance status) without revealing the underlying sensitive data, and/or the wallet system 512 can process and validate these proofs as part of secure interactions with the cyber resilience identity. In yet another example, a quantum entanglement signature can be a method for facilitating data authenticity and integrity using entangled quantum states, and/or the wallet system 512 can generate, store, and/or apply these signatures to authenticate and validate the integrity of cyber resilience data. In yet another example, a fractionalized token can be a representation of a cyber resilience asset divided into smaller units (e.g., portions of an insurance policy or coverage token), and/or the wallet system 512 can manage the distribution, ownership, and/or transactions involving these fractionalized units within the tokenized cyber resilience identity.

In some implementations, the wallet system 512 can store, create, and/or update a variety of tokens associated with the cybersecurity posture of an organization or entity. The wallet system 512 can create and update performance tokens, which can include results of cybersecurity events, assessments, or incident responses (e.g., a security breach response or a periodic vulnerability assessment). The wallet system 512 can create and maintain unified tokens, which can include data representing the state of various cybersecurity elements over time (e.g., safeguards implemented across the organization, internal and third party requirements compliance, or asset management). The wallet system 512 can capture and record evaluation tokens, which can include cybersecurity data captured at multiple points in time (e.g., snapshots of the organization cybersecurity posture at regular intervals). The wallet system 512 can aggregate and store roll-up tokens, which can include combined data from unified and real-time tokens to provide a view of the cybersecurity performance over a specified period (e.g., annual security performance summary). The wallet system 512 can create and update resilience tokens, which can include tokens representing different dimensions of the organization cybersecurity posture (e.g., tokens for cybersecurity resilience metrics). The wallet system 512 can further provide interfaces for entities to access, manage, and/or review the various tokens.

In some implementations, the systems or components of FIG. 5 can communicate over network 120. Network 120 can include computer networks such as the Internet, local, wide, metro or other area networks, intranets, satellite networks, other computer networks such as voice or data mobile phone communication networks, combinations thereof, or any other type of electronic communications network. Network 120 can include or constitute a display network. As a non-limiting example, network 120 can implement transport layer security (TLS), secure sockets layer (SSL), hypertext transfer protocol secure (HTTPS), and/or any other secure communication protocol. In some implementations, network 120 can be composed of various network devices (nodes) communicatively linked to form one or more data communication paths between participating devices. The network 120 can facilitate communication between the various nodes, such as the client devices 110, third party devices 150, passport system 520, etc. (e.g., using an OSI layer-4 transport protocol such as the User Datagram Protocol (UDP), the Transmission Control Protocol (TCP), Stream Control Transmission Protocol (SCTP), etc.). At least one (e.g., each) networked device can include at least one network interface for receiving and transmitting data, typically as one or more data packets. An illustrative network 120 is the Internet (however, other networks can be used). Network 120 can be an autonomous system (AS), e.g., a network that is operated under a consistent unified routing policy (or at least appears to from outside the AS network) and is generally managed by a single administrative entity (e.g., a system operator, administrator, or administrative group).

In some implementations, the ledger system 530 can include one or more processing circuits, including processor(s) and memory. The memory can have instructions stored thereon that, when executed by processor(s), cause the one or more processing circuits to perform the various operations described herein. The operations described herein can be implemented using software, hardware, or a combination thereof. The processor(s) can include a microprocessor, ASIC, FPGA, etc., or combinations thereof. In many implementations, the processor(s) can be a multi-core processor or an array of processors. Memory can include, but is not limited to, electronic, optical, magnetic, or any other storage devices capable of providing processor(s) with program instructions. The instructions can include code from any suitable computer programming language. In some implementations, the ledger system 530 can include an interface circuit and function circuit.

In some implementations, the ledger system 530 can be a ledger or a decentralized ledger. For example, the ledger system 530 can include a distributed ledger technology (DLT) that supports immutable record-keeping and secure data transactions. The ledger system 530 can store various types of tokens and cybersecurity data, including performance tokens, unified tokens, evaluation tokens, roll-up tokens, and/or resilience tokens. The ledger system 530 can securely record updates and changes to tokens (e.g., providing data integrity and traceability). For example, the ledger system 530 can use blockchain to provide a tamper-evident record of token-related transactions.

In some implementations, the ledger system 530 can include smart contract storage 532, blockchain 170, and/or token storage 534. In some implementations, the smart contract storage 532, blockchain 170, and/or token storage 534 can include one or more processing circuits, including processor(s) and memory. The memory can have instructions stored thereon that, when executed by processor(s), cause the one or more processing circuits to perform the various operations described herein. The operations described herein can be implemented using software, hardware, or a combination thereof. The processor(s) can include a microprocessor, ASIC, FPGA, etc., or combinations thereof. In many implementations, the processor(s) can be a multi-core processor or an array of processors. Memory can include, but is not limited to, electronic, optical, magnetic, or any other storage devices capable of providing processor(s) with program instructions. The instructions can include code from any suitable computer programming language. In some implementations, the smart contract storage 532, blockchain 170, and/or token storage 534 can include an interface circuit and function circuit.

In some implementations, smart contract storage 532 can manage and execute predefined agreements related to token transactions and updates. In one example, smart contract storage 532 can store role-based access controls (RBACs or other rule-based control systems) or other access control mechanisms restricting access or updates to tokenized cyber resilience data stored via the ledger system 530. In some examples, the smart contract storage 532 can store rules or other data to automate processes such as token validation, data access control, and/or compliance checks. For example, smart contract storage 532 can store smart contracts that define the rules and logic for managing token transactions and updates. In some examples, smart contract storage 532 can manage contract templates that specify access permissions, including RBACs to restrict access based on user roles. That is, the smart contract storage 532 can implement RBAC to control permissions for executing transactions or modifying token data. Smart contract storage 532 can execute stored access controls/smart contracts to enforce access permissions, validate transactions, and/or verify compliance by entities or organizations with various cyber resilience parameters. In some implementations, smart contract storage 532 can process transactions according to terms, parameters, or rules to restrict access to tokens or other cyber resilience data.

In some implementations, blockchain 170 can include a decentralized ledger that records and validates token transactions. For example, blockchain 170 can utilize consensus mechanisms (e.g., proof of provenance, proof of work, proof of stake) to validate transactions involving tokenized cyber resilience data across a distributed network. In some examples, blockchain 170 can provide a tamper-evident and immutable record of token data by employing cryptographic techniques (e.g., hashing functions) to record and verify token transactions. That is, blockchain 170 can provide transparency and traceability of token-related activities by securely recording token transactions on a distributed computing architecture.

In some implementations, token storage 534 can store tokenized cyber resilience data. For example, token storage 534 can store and manage tokens including performance tokens, unified tokens, evaluation tokens, and/or roll-up tokens generated and provided by the token system 502. In some examples, token storage 534 interfaces with blockchain 170 to manage and organize token data. For example, token storage 534 can handle different token types, including performance tokens, unified tokens, evaluation tokens, and/or roll-up tokens. Token storage 534 can utilize data structures such as relational databases, NoSQL databases, or file systems to organize and manage tokens and corresponding data. In some examples, token storage 534 can maintain data accuracy by integrating with blockchain 170 to validate and update token records.

In some implementations, the passport system 520 can include one or more systems and subsystems to model cyber resilience data using cyber resilience identities and associated metadata (e.g., cryptographic system 522, ledger interface 524, token system 502, and/or metadata collection system 526). In some implementations, the cryptographic system 522, ledger interface 524, token system 502, and/or metadata collection system 526 can include one or more processing circuits, including processor(s) and memory. The memory can have instructions stored thereon that, when executed by processor(s), cause the one or more processing circuits to perform the various operations described herein. The operations described herein can be implemented using software, hardware, or a combination thereof. The processor(s) can include a microprocessor, ASIC, FPGA, etc., or combinations thereof. In many implementations, the processor(s) can be a multi-core processor or an array of processors. Memory can include, but is not limited to, electronic, optical, magnetic, or any other storage devices capable of providing processor(s) with program instructions. The instructions can include code from any suitable computer programming language. In some implementations, the cryptographic system 522, ledger interface 524, token system 502, and/or metadata collection system 526 can include an interface circuit and function circuit.

In some implementations, the metadata collection system 526 can receive or identify cyber resilience data. That is, receiving or identifying can include the metadata collection system 526 acquiring, processing, and/or categorizing data from various sources, such as cybersecurity events, system performance metrics, and/or vulnerability assessments stored on ledger system 530. For example, the metadata collection system 526 can gather and organize data attributes like event timestamps, sources, and/or types corresponding to the cyber resilience status of the entity and other cyber protection information. Additionally, the metadata collection system 526 can link these data attributes to cyber resilience metrics and update the corresponding records to reflect changes in the cyber protection posture of the entity.

In some implementations, the cryptographic system 522 can encrypt a portion of the cyber resilience data. That is, encrypting can include the cryptographic system 522 securing sensitive data using cryptographic techniques tailored to the requirements of the data. For example, the cryptographic system 522 can apply encryption algorithms to protect sensitive data, such as performance metrics or identifiers of an organization or entity. Further, the cryptographic system 522 can utilize key management techniques to facilitate secure data encryption and decryption process such that only authorized entities can access the encrypted data. Additionally, the cryptographic system 522 can use asymmetric encryption to secure data before it is stored or transmitted. For example, the cryptographic system 522 can apply hashing algorithms to verify the integrity of data associated with cyber resilience events and assessments such that the data remains unaltered during transmission or storage.

In some implementations, the token system 502 and metadata collection system 526 can generate a metadata object including metadata of cyber resilience data. That is, the token system 502 can create structured metadata objects that include information about tokenized data, such as fields, tags, headers, and/or other relevant attributes like data type, source, and/or context. For example, the token system 502 can organize metadata into formats that provide descriptions and classifications for at least one (e.g., each) element of cyber resilience data. Further, the metadata collection system 526 can collect and integrate various metadata elements, such as timestamps, source identifiers, and/or data relevance indicators, into the metadata object. Additionally, the token system 502 can structure the metadata to improve the understanding and usability of the collected cyber resilience data.

In some implementations, the token system 502 can generate a cyber resilience identity including at least a link with the metadata object, a unique identifier (UID), and/or a performance event dataset. That is, generating can include creating, associating, and/or linking metadata objects, unique identifiers, and/or performance datasets with an identifier of an organization or entity. For example, the token system 502 can generate a passport that links to metadata stored in one or more tokens, at least one (e.g., each) containing data related to different aspects of the cyber resilience of the entity. The passport can include a unique identifier for tracking and linking the metadata object to other associated tokens. Further, the performance event dataset within the passport can capture and store cyber resilience performance data, such as that stored in multiple performance tokens, which can be collected at different points in time. For example, the token system 502 can issue or mint tokens linked to a single token that reference metadata objects and include unique identifiers for tracking, and/or the token system 502 can embed performance metrics and historical data within the tokens to provide insights into cyber resilience.

In some implementations, the token system 502 can encapsulate the cyber resilience identity within a control structure restricting one or more updates and redemptions of the metadata object. That is, encapsulating can include implementing token gating mechanisms or smart contracts to enforce rules on who can update or redeem the cyber resilience identity, based on predefined criteria and access control policies. For example, the token system 502 can establish a control structure that allows a customer to view relevant data within their own passport while restricting the access by the insurer to only tokenized data used for underwriting decisions. Generally, the passport system 520 can implement a control structure that enforces rules on who can update or redeem the cyber resilience identity based on predefined criteria (e.g., entity type, user preferences/selections, etc.)

In some implementations, the ledger interface 524 can determine at least one access data structure that is compatible with the control structure. That is, determining can include analyzing various data structures to identify or determine alignment with the access control policies and update restrictions defined by the control structure. For example, the ledger interface 524 can evaluate different data structures to verify compatibility with access levels and permissions for interacting with the cyber resilience identity. Additionally, the ledger interface 524 can select and implement data structures that support the secure and compliant management of access and updates within the token system 502.

The control structure (e.g., implemented as a smart contract) governs access to a token structure containing various tokens, such as performance tokens, unified tokens, evaluation tokens, and/or roll-up tokens. The token structure can include metadata, such as unique identifiers (UIDs), creation timestamps, and/or links to related data sets. The smart contract specifies predefined rules for accessing and updating these tokens. The ledger interface 524 can process the smart contract to extract rules that define role-based access control (RBAC) permissions. For example, the smart contract can specify that at least one (e.g., each) third party can only access their own data within the token structure. In some implementations, a third party entity can have access its own performance tokens stored in the token structure, such as in a passport associated with the cybersecurity status of an entity. The RBAC rules restrict other entities from viewing or modifying these tokens. Another example can include third party vendors having access to their own evaluation tokens that detail the results of security assessments relevant to their services, without the ability to access data from other vendors.

The ledger interface 524 can configure the selected access data structure to enforce these RBAC permissions as extracted from the smart contract. That is, the configuration can include mapping the access permissions to the token structure, linking at least one (e.g., each) token type to the appropriate access control mechanisms. For example, performance tokens related to a particular third party can be linked to a role of the third party. Similarly, unified tokens related to internal compliance reports can only be accessible by authorized roles within the organization itself (e.g., excluding third party access). The ledger interface 524 can integrate the configuration within the ledger system 530 to apply the rules of the control structure to token-related operations. The RBAC can facilitate access to tokens to entities or individuals that have been granted access or authorized to read, update, or add. For example, the control structure can use an access level of an entity or individual to determine whether to allow a user to read data but not update or add to the data (e.g., a third party insurer can access performance datasets on performance tokens linked to a passport of the prosecutive insured, but can be restricted from modifying certain performance data stored thereon), to have full rights (e.g., read/update/add, etc.), and/or so on. That is, the passport system 520 can determine, identify, and/or provide an access level or permissions to a person or entity attempting to access or otherwise interact with tokenized data corresponding to a cyber resilience identity, and/or the access level/permissions can be used by the passport system 520 to restrict or allow the user or entity to perform various actions related to the tokens.

In some implementations, if the smart contract is modified, the ledger interface 524 can reconfigure the access data structures to match the updated RBAC rules. For example, if the smart contract is updated to change access permissions for a particular third party entity, the ledger interface 524 can adjust the RBAC configurations to reflect this change such that the access control mechanisms allows access and is consistent with the control structure. In some implementations, an access data structure can function as a token or another access control mechanism within the token structure. That is, the access data structure can facilitate operations, such as reading, writing, adding, or removing metadata objects associated with tokens in the cyber resilience identity (e.g., also operating and implemented as a token). For example, an access control token can link to other tokens representing performance, evaluation, or resilience data. The access control token can encapsulate the permissions for interacting with the tokens and can include metadata defining allowed operations and roles or entities authorized to perform at least one (e.g., each) operation. Additionally, an access data structure can implement write access to one or more metadata objects within the token structure. For example, an access control token can identify which entities have permission to update particular aspects of the cyber resilience identity, such as modifying performance metrics or altering the status of an evaluation token. Another access data structure can be used to manage read permissions, restricting a third party entity to viewing metadata associated with its own tokens within the structure without granting modification rights. In some implementations, an access control structure can function as a token that defines hierarchical permissions across multiple tokens. For example, a control structure token can specify that only a designated role within an organization has the authority to add or remove tokens from the cyber resilience identity. Additionally, the access control token can be used to facilitate interactions with other tokens within the token structure to apply these permissions.

In some implementations, the ledger interface 524 can broadcast, using the control structure, the cyber resilience identity to a ledger or distributed ledger. That is, broadcasting can include publishing, sharing, or otherwise transmitting a passport (e.g., cyber resilience identity) of an entity to authorized participants on the distributed ledger network, including insurers, regulators, or cybersecurity vendors, to facilitate secure access, auditing, or validation of the cybersecurity posture of the entity or for use in in providing protection or insurance quotes, verifying compliance, offering targeted cybersecurity services (e.g., through advertisements), or generating analytical insights based on the data of the entity. For example, the ledger interface 524 can transmit the cyber resilience identity to a blockchain or similar distributed ledger to maintain an immutable record of the cyber resilience identity and associated data. In this example, the transmission process can include creating a transaction that includes the cyber resilience identity, signing the transaction using cryptographic keys associated with the control structure, and/or broadcasting the transaction to the distributed ledger network. The network nodes can then validate the transaction through a consensus mechanism (e.g., proof of work, proof of stake) and, once validated, add it to a block in the blockchain. Additionally, the ledger interface 524 can store the cyber resilience identity locally (e.g., in a back-end database or other local data store). Further, the ledger interface 524 can transmit or send the cyber resilience identity (e.g., via a shareable link) to various entities, who can access a portion of the data corresponding with the cyber resilience identity but not access another portion of the data based on various access controls.

Referring to the control structure (e.g., smart contract) generally, the one or more control structures can be embedded within the transaction or linked via a unique identifier or hash, which can be included in the transaction data. That is, the rules and conditions defined by the smart contract can be inherently tied to the cyber resilience identity, facilitating the for automated enforcement of access controls and other predefined operations when the identity is accessed or modified on the distributed ledger. In some implementations, the one or more control structures can be referenced by a unique smart contract address included in the transaction. That is, the reference can allow the distributed ledger to call and execute the smart contract independently when certain events are triggered, such as a request to access or update the cyber resilience identity. In some implementations, the one or more control structures can be included as a separate transaction linked to the cyber resilience identity transaction via a cryptographic reference. The smart contract transaction can be broadcasted and stored on the blockchain, where it can autonomously enforce the conditions and permissions associated with the cyber resilience identity when an interaction with the identity occurs on the distributed ledger. In some implementations, the one or more control structures can be encoded into the blockchain transaction as executable code. That is, the smart contract can automatically execute its logic in response to blockchain events, such as validation of the cyber resilience identity transaction.

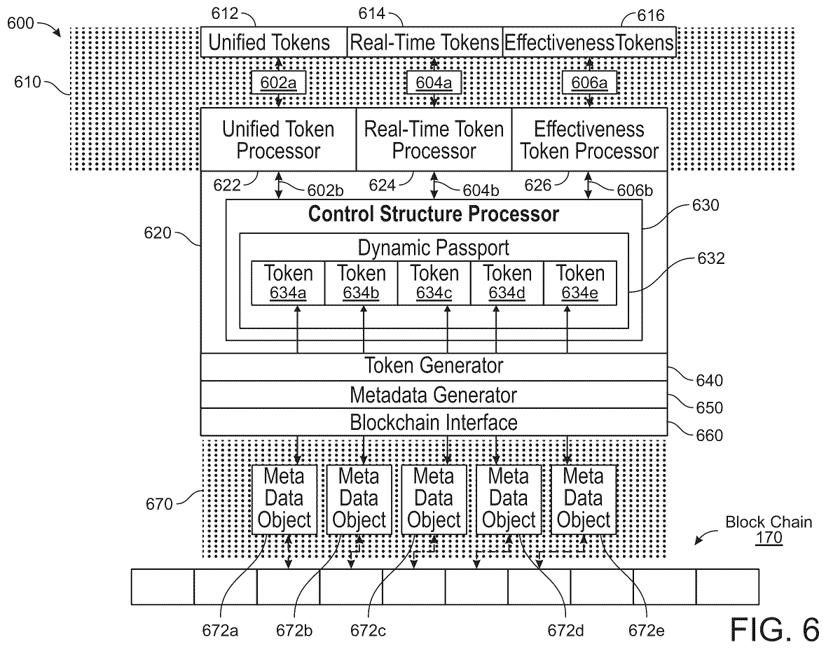

Referring now to FIG. 6, a block diagram of an architecture of certain systems or devices of FIG. 5 is shown, according to some implementations. The implementation shown in FIG. 6 (e.g., system 600) can include a token interface 610 including unified tokens 612, real-time tokens 614, and/or effectiveness tokens 616. The implementation shown in FIG. 6 can also include a smart contract control structure 620 including a unified token processor 622, a real-time token processor 624, and/or an effectiveness token processor 626. Further, the smart contract control structure 620 can include a control structure processor 630, a token generator 640, a metadata generator 650, and/or a blockchain interface 660. In some implementations, the control structure processor 630 can include a dynamic passport 632, and/or dynamic passport 632 can include tokens 634a-634e (collectively, 634). At least one (e.g., each) of the tokens 634 can be linked to a metadata interface 670 including one or more metadata objects 672a-672e (collectively, metadata objects 672). In some implementations, the implementation shown in FIG. 6 can include blockchain 170.

In some implementations, FIG. 6 depicts an example smart contract control structure 620. In some examples, the unified token processor 622, real-time token processor 624, and/or effectiveness token processor 626 can detect a presence of a token (fungible, non-fungible, partially-fungible, etc.), and/or can transmit the token to a compatibility processor (e.g., unified token processor 622, real-time token processor 624, effectiveness token processor 626) compatible with that particular token. The detection can be responsive to an action by the token interface 610 to transmit the tokens to the smart contract control structure 620. In some examples, the token interface 610 can include a communication channel between one or more of the smart contract control structure 620 and one or more of the unified tokens 612, real-time tokens 614, and/or effectiveness tokens 616. The token interface 610 can include an application programming interface compatible with the smart contract control structure 620 to detect various cyber resilience tokens. At least the token interface 610 or the smart contract control structure 620 can execute one or more instructions to determine whether one or more of the tokens are compatible with the smart contract control structure 620.

In some implementations, the unified token processor 622 can perform detection of unified tokens 612 via a link 602a or other communication channel (e.g., via a network such as network 120). The detection can be responsive to receiving a unified token from token system 502, client device 110, or third party devices 150, over link 602a. The unified token processor 622 can be configured to be compatible with a unified token 612, or can be generated to be compatible with a particular unified token 612. For example, the unified token processor 622 can be integrated with or store a hash based on a unified token 612 and a hash processor operable to generate a hash based on any unified token 612. The unified token processor 622 can generate a hash in response to detecting the presence of the unified token 612, and/or can determine whether the unified token 612 is compatible with the smart contract control structure 620 by comparing the generated hash with the stored hash. The unified token processor 622 can include logic to detect a unified token 612 passed to it, by, for example, a JSON object or a header argument. Additionally, the unified token processor 622 can provide the detected unified token to the control structure processor 630 via link 602b.

In some implementations, the real-time token processor 624 can perform detection of real-time tokens 614 via link 604a. The detection can be responsive to receiving a real-time token 614 from token system 502, client device 110, or third party devices 150, over link 604a. For example, the real-time token processor 624 can be integrated with or store a hash based on a real-time token 614 and a hash processor operable to generate a hash based on any real-time token 614. The real-time token processor 624 can generate a hash in response to detecting the presence of the real-time token 614, and/or can determine whether the real-time token 614 is compatible with the smart contract control structure 620 by comparing the generated hash with the stored hash. The real-time token processor 624 can include logic to detect a real-time token 614 passed to it, by, for example, a JSON object or a header argument. Additionally, real-time token processor 624 can provide the detected real-time token 614 to the control structure processor 630 via link 604a.

In some implementations, the effectiveness token processor 626 can perform detection of effectiveness tokens 616 via link 606a. The detection can be responsive to receiving an effectiveness token 616 from token system 502, client device 110, or third party devices 150, over link 606a. For example, the effectiveness token processor 626 can be integrated with or store a hash based on an effectiveness token 616 and a hash processor operable to generate a hash based on any effectiveness token 616. The effectiveness token processor 626 can generate a hash in response to detecting the presence of the effectiveness token 616, and/or can determine whether the effectiveness token 616 is compatible with the smart contract control structure 620 by comparing the generated hash with the stored hash. The effectiveness token processor 626 can include logic to detect an effectiveness token 616 passed to it, by, for example, a JSON object or a header argument. Additionally, the effectiveness token processor 626 can provide the detected effectiveness token 616 to the control structure processor 630 via link 606b.

In some implementations, the smart contract control structure 620 can include a control structure processor 630 configured to generate and store tokens 634. The tokens 634 can include one or more unified tokens 612, real-time tokens 614, and/or effectiveness tokens 616. That is, responsive to receiving one or more of the unified tokens 612, real-time tokens 614, and/or effectiveness tokens 616 from the unified token processor 622, real-time token processor 624, and/or effectiveness token processor 626, the control structure processor 630 can receive the tokens 634 via links 602b, 604b, and/or 606b. It should be understood that a control structure (or smart contract control structure) used herein can refer to a logical or structural construct that encapsulates one or more elements, such as tokens, or metadata objects, within a defined boundary. The control structure serves as an organizational framework that groups these elements together, allowing them to be referenced, accessed, or transmitted as a single unit. The smart contract control structure 620 or other control mechanisms can manage interactions and enforce access controls based on predefined rules. For example, a control structure can be a data structure that stores references or pointers to the encapsulated elements. In another example, it could be a structure that includes metadata defining relationships and dependencies between the elements.

In some implementations, a container or wrapper can encapsulate a cyber resilience identity having a control structure, which can include multiple tokens linked to metadata objects. Encapsulation can be implemented by defining a data structure within a memory or storage system that can include relevant tokens and their associated metadata objects. The container itself can be a structured data object, such as a JSON object, a database schema, or a serialized data structure, that stores pointers, references, or data fields corresponding to at least one (e.g., each) token and its linked metadata. The smart contract control structure 620, such as a smart contract, can be included within the container by referencing its address or embedding its bytecode within the container data structure. When the container is instantiated or accessed, the control structure processor 630 can reference the smart contract control structure 620 to enforce the rules and permissions associated with the cyber resilience identity.

In some implementations, a smart contract can encapsulate a cyber resilience identity, which can include multiple tokens linked to metadata objects. The smart contract can encapsulate the cyber resilience identity by defining a set of rules and data fields within its code that represent the cyber resilience identity and its components. The control structure processor 630 can create and maintain a mapping or registry within the blockchain 170 or distributed ledger that associates at least one (e.g., each) token with its corresponding metadata objects. The encapsulation occurs as the smart contract control structure 620 references these tokens and metadata objects within its execution environment, using internal storage variables or linked data structures (e.g., mappings) to track and enforce relationships between them. The smart contract control structure 620 can encapsulate the cyber resilience identity by controlling access to these mappings, allowing only authorized operations as defined by the logic of the contract.

In some implementations, the control structure processor 630 can generate a metadata object, such as a wrapper, where a smart contract control structure 620 (e.g., a smart contract) is wrapped or otherwise linked to dynamic passport 632, which can further include links to metadata (e.g., stored data, fields, etc.) of tokens 634. For example, the dynamic passport 632 can be encapsulated in a smart contract control structure 620 and can generated by metadata generator 650 as part of the metadata interface 670. The linking dynamic passport 632 and the control structure processor 630 can provide access to the tokenized cyber information based on the smart contract control structure 620.

In some implementations, the control structure processor 630 can generate a dynamic passport 632 including a token with a link to (e.g., encapsulated in) the smart contract control structure 620. The link can be established via a digital signature or cryptographic hash that securely associates the dynamic passport 632 with corresponding metadata. The dynamic passport 632 can be provided to a metadata interface 670 such that a blockchain (e.g., blockchain 170) can verify and store the metadata securely on the chain. Additionally, the control structure processor 630 can encapsulate the dynamic passport 632 and tokens 634 within the smart contract control structure 620. For example, encapsulating can include encrypting the data and setting permissions for data access. That is, the encapsulation can restrict outputs of the metadata objects 672. For example, when the dynamic passport 632 and tokens 634 are encapsulated, the control structure processor 630 can output when conditions or permissions are verified. In another example, when the dynamic passport 632 and tokens 634 are encapsulated in a smart contract control structure 620, the control structure processor 630 can output when a valid decryption key is presented. For example, the control structure processor 630 can authorize transactions after verifying that compliance and regulatory requirements are met based on data of the tokens 634.

In some implementations, the control structure processor 630 can be configured to perform segmentation or allocation of tokens 634 of the dynamic passport 632 based on parameters by accessing the metadata of a token and evaluating compliance with cyber resilience standards. Accordingly, the control structure processor 630 can automatically pool (or tranche) asset tokens (associated with underlying assets) based on parameters. For example, the parameters can be programmed into smart contracts of the control structure processor 630. For example, the dynamic passport 632 can include one or more segmented allocations of the tokens 634 (e.g., with token 634a and 634b segmented into an allocation and tokens 634c-634e segmented into another allocation). While not shown in FIG. 6, a segmented allocation smart contract control structure can be within the smart contract control structure 620 and be operated by the control structure processor 630. In some examples, this integration facilitates automated re-segmentation based on real-time data analysis. In another example, this integration facilitates compliance checks and performance tracking without external system intervention.

In some implementations, at least one (e.g., each) of the tokens 634 can include metadata objects 672. For example, links can connect at least one (e.g., each) token 634 to a respective metadata object 672. In some examples, the metadata interface 670 can be utilized to connect at least one (e.g., each) token 634 to its metadata object 672. For example, the token 634a can be connected to the metadata object 672a via a link, the token 634b can be connected to the metadata object 672b via a link, and/or so on.

In some examples, the metadata interface 670 can include a communication channel between one or more of the tokens in the smart contract control structure 620 and metadata objects of blockchain 170. That is, metadata objects 672 can be accessed and verified through blockchain transactions to verify integrity and authenticity. Furthermore, blockchain 170 can store links to the metadata objects 672 or store the metadata objects 672 in blocks of the blockchain 170. For examples, the blockchain 170 can store the metadata objects 672 in blocks to verify that participants have consistent and unalterable access to the cyber resilience information stored in the tokens 634 of the dynamic passport 632.

In some implementations, the token interface 610 can include an application programming interface compatible with the smart contract control structure 620 to detect various cyber resilience tokens. In some examples, at least the token interface 610 or the smart contract control structure 620 can execute one or more instructions to determine whether one or more of the tokens (e.g., tokens 634 or corresponding unified tokens 612, real-time tokens 614, and/or effectiveness tokens 616) are compatible with the smart contract control structure 620.

In some implementations, the token generator 640 (e.g., token system 502) can generate one or more tokens (e.g., fungible, semi-fungible, or non-fungible tokens, collectively referred to herein as “controllable electronic records”) in accordance with a token obtained at one or more of the unified token processor 622, real-time token processor 624, and/or effectiveness token processor 626. For example, the token generator 640 can generate tokens based on a number of new metadata objects indicated by an obtained token, and/or linked with respective smart contract control structures. For example, the token generator 640 can generate a cyber resilience identity (e.g., dynamic passport 632) with links to one or more tokens at least one (e.g., each) linked with a particular smart contract control structure 620 with which the respective token is compatible. The token generator 640 can thus generate a corresponding number of keys that can control restrictions on output by the particular metadata object linked with the particular smart contract control structure compatible with the particular token. The token generator 640 can modify and delete tokens (e.g., tokens 634) linked with cyber resilience identity (e.g., dynamic passport 632), to update control of a partial distribution or exchange of metadata object control.

In some implementations, the metadata generator 650 can generate one or more metadata objects (e.g., metadata objects 672a, 672b, 672c, 672d, 672e, etc.) in accordance with a token obtained at one or more of the unified token processor 622, real-time token processor 624, and/or effectiveness token processor 626 (e.g., at a compatibility processor). That is, the metadata object can include metadata of cyber resilience data. For example, metadata generator 650 can generate multiple tokens based on a number of new metadata objects linked with respective smart contract control structure(s) 620 and encapsulated with a cyber resilience identity (e.g., passport). For example, the metadata generator 650 can generate one or more metadata objects 672 at least one (e.g., each) linked to respective tokens 634 and further linked, via the tokens 634, to the dynamic passport 632 with a particular smart contract control structure 620 by which the metadata object co is controlled. In some examples, the metadata generator 650 can modify and delete metadata objects linked with tokens or smart contract control structures to update control of a partial transfer of metadata object control. Further, the metadata generator 650 can modify and update tokens and associated information of existing tokens (e.g., tokens 634) corresponding to a cyber resilience identity (e.g., dynamic passport 632).

In some implementations, the blockchain interface 660 can include an API compatible with the blockchain 170 via metadata generator 650. The blockchain interface 660 can selectively add, modify, and/or delete blocks from the blockchain 170. The blockchain interface 660 can add, modify, and/or delete blocks in accordance with restrictions or interfaces of the blockchain 170, and/or can add, modify, and/or delete blocks independently of the restrictions or interfaces of the blockchain 170 at any portion or index of the blockchain 170.

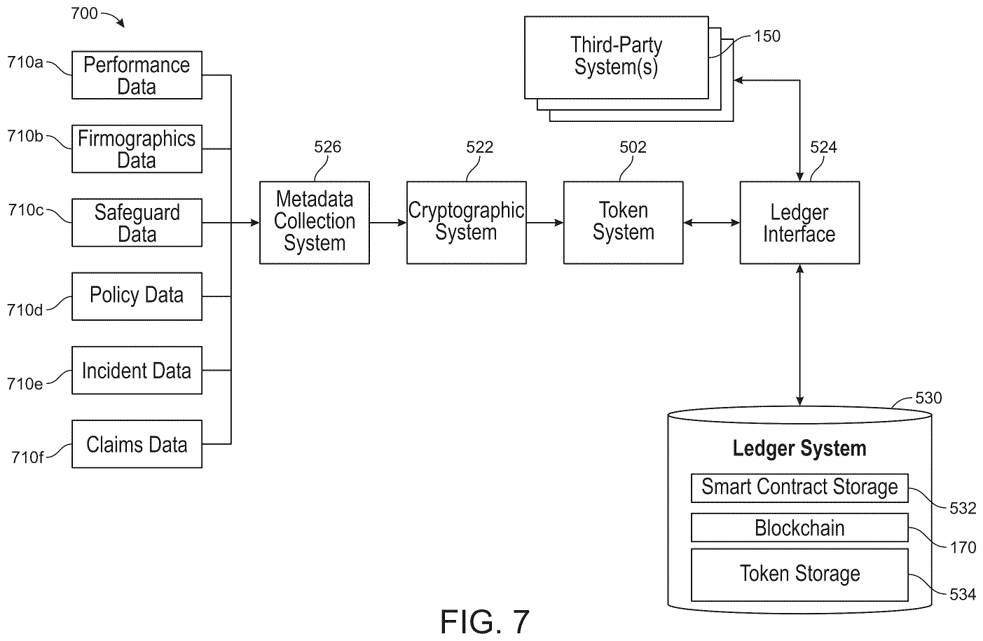

Referring now to FIG. 7, a block diagram 700 of an architecture of certain systems or devices of FIG. 5 is shown, according to some implementations. The implementation shown in FIG. 7 includes third party devices 150 and ledger system 530. The ledger system 530 can include smart contract storage 532, blockchain 170, and/or token storage 534. The implementation shown in FIG. 7 can also include metadata collection system 526, cryptographic system 522, token system 502, and/or ledger interface 524. The implementation shown in FIG. 7 can also include performance data 710a, firmographics data 710b, safeguard data 710c, policy data 710d, incident data 710e, and/or claims data 710f (collectively, cyber resilience data 710).

In some implementations, the metadata collection system 526 can receive or identify cyber resilience data 710. For example, the metadata collection system 526 can collect or retrieve performance data 710a (e.g., metrics related to cybersecurity incidents or system performance), firmographics data 710b (e.g., company size, industry type, or geographic location), safeguard data 710c (e.g., implemented security controls or measures), policy data 710d (e.g., security policies or compliance requirements), incident data 710e (e.g., records of security breaches or system failures), and/or claims data 710f (e.g., insurance claims or risk assessments) of an entity or organization. In some examples, the metadata collection system 526 can integrate data from various cybersecurity tools and databases (e.g., third party devices 150, blockchain 170, etc.) to compile a cyber resilience dataset. In some implementations, the metadata collection system 526 can provide the received or identified cyber resilience data to the cryptographic system 522.

In some implementations, the cryptographic system 522 can encrypt a portion of the cyber resilience data. For example, the cryptographic system 522 can apply symmetric encryption algorithms (e.g., AES) to secure sensitive data such as performance data 710a or firmographics data 710b. In another example, the cryptographic system 522 can use asymmetric encryption techniques (e.g., RSA) to protect keys and authentication credentials. Further, the cryptographic system 522 can implement hashing algorithms (e.g., SHA-256) to verify the integrity of the data by generating unique hash values for at least one (e.g., each) data record. In some implementations, the cryptographic system 522 can provide the portion of encrypted cyber resilience data to the token system 502.

In some implementations, the token system 502 can generate a metadata object including metadata of cyber resilience data. For example, the token system 502 can create metadata objects that encapsulate encrypted performance data, safeguard records, and/or compliance data. In some implementations, the token system 502 can include additional metadata such as timestamps, data sources, and/or integrity checks. In some implementations, the token system 502 can generate a cyber resilience identity including at least a link with the metadata object, a unique identifier (UID), and/or a performance event dataset. For example, the cyber resilience identity can include a UID to uniquely identify the entity, a link to a metadata object (e.g., data of one or more tokens), and/or include a dataset with performance events or incidents. In some implementations, the token system 502 can encapsulate the cyber resilience identity within a control structure restricting one or more updates and redemptions of the metadata object. The control structure can be a data structure or other system including a cyber resilience identifier (e.g., passport) with linked tokens and restricting accessing to metadata object (e.g., data) of certain tokens. In some implementations, the token system 502 can determine at least one access data structure being compatible with the control structure. For example, the token system 502 can utilize various access management techniques, such as access control lists (ACLs), role-based access controls (RBACs), or attribute-based access controls (ABACs), to verify that the access data structure aligns with the permissions and restrictions defined within the control structure. The passport system 520 can assess these access data structures to determine whether the structures comply with predefined standards or policies (e.g., determining whether an entity or authorized user has the appropriate credentials or attributes to access, modify, or update the metadata objects encapsulated within the control structure). Additionally, the token system 502 can dynamically adjust the access parameters based on changes in roles, permissions, or security requirements such that the control structure remains consistent with the evolving access needs of various entities and users involved in managing or interacting with the cyber resilience identity.

In some implementations, access controls, such as role-based access controls (RBACs) or access parameters, can be implemented in various forms to manage permissions for entities interacting with the metadata object (e.g., token). Access controls can include any method or mechanism that limits, restricts, or authorizes access to certain data based on predefined criteria. Examples of access controls could involve establishing rules that dictate who can view, modify, or delete data elements within the metadata object or cyber resilience identity. Such controls can be used to regulate access across different entities, such as allowing a third party like an insurer to view certain data, modify data, or be restricted from accessing other sensitive data. These access controls can also be configured within a broader access management framework, such as ACLs or RBACs, that dynamically adapts to the roles and permissions associated with different users or systems.

In some implementations, the token system 502 can generate a cyber resilience identity including at least a link with the metadata object, a unique identifier (UID), and/or a performance event dataset. For example, the cyber resilience identity can incorporate a UID to uniquely identify the entity, link to the metadata object to reference encrypted data, and/or include a dataset detailing performance events or incidents. The token system 502 can encapsulate the cyber resilience identity within a control structure restricting one or more updates and redemptions of the metadata object. Further, the token system 502 can determine at least one access data structure that aligns with the control structure. For example, the token system 502 can use access control lists or role-based access controls to verify alignment with the control structure for control over which data elements can be accessed or modified by different entities. In some implementations, the ledger interface 524 can broadcast, using the control structure, the cyber resilience identity to a ledger or distributed ledger. For example, the ledger interface 524 can interact with the ledger system 530, including smart contract storage 532, blockchain 170, and/or token storage 534, to submit the cyber resilience identity and associated metadata and publish the cyber resilience identity to blockchain 170. In some examples, the ledger interface 524 can also communicate with third party devices 150 to share and verify the cyber resilience identity across different platforms and networks (e.g., to transmit to a vendor or insurer).

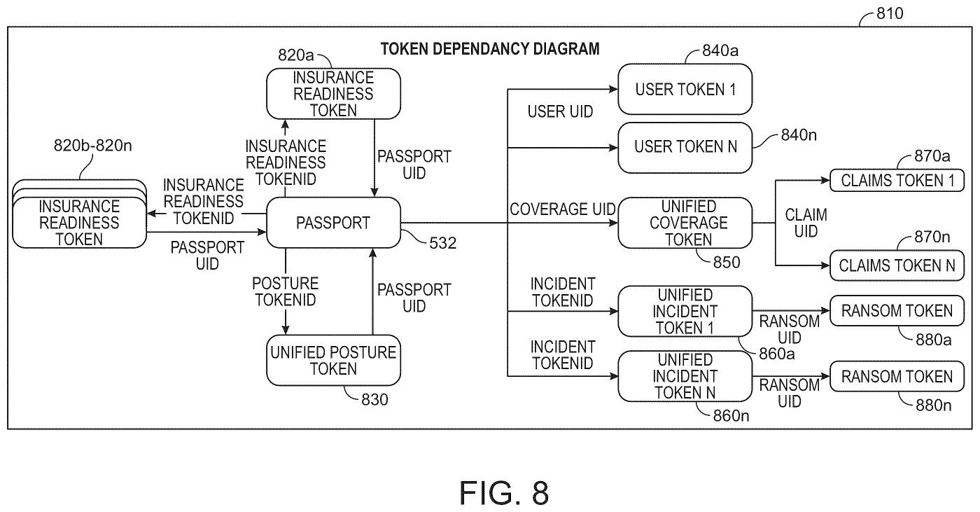

Referring now to FIG. 8, a block diagram of a token dependency system 810 for tokenized cyber resilience data is shown, according to some implementations. The implementation shown in FIG. 8 includes a dynamic passport 632 and one or more insurance readiness tokens 820a-820n (collectively, 820), a unified posture token 830, one or more user tokens 840a-830n (collectively user tokens 840), a unified coverage token 850, one or more unified incident tokens 860a-860n (collectively unified incident tokens 860), claims tokens 870a-870n (collectively claim tokens 870), and/or ransom tokens 880a-880n (collectively ransom tokens 880).

In some implementations, the dynamic passport 632 can operate as a central node and be linked to tokenized cyber resilience data (e.g., tokens) to facilitate interactions across the various tokens in managing, accessing, and/or updating cyber resilience data. For example, the dynamic passport 632 can be linked to the insurance readiness tokens 820 via the passport UID and insurance readiness token ID. In another example, the dynamic passport 632 can be linked to the unified posture token 830 through the passport UID and posture token IDs. Further, the dynamic passport 632 can be linked to user tokens 840 through a user UID. The dynamic passport 632 can further be linked to the user to a unified coverage token 850 via a coverage UID. In some examples, the unified coverage token 850 can be linked to claims tokens 870 via a claim UID, and/or the link can provide the dynamic passport 632 with access to the claims tokens 870. Further, the dynamic passport 632 can be linked with the unified incident tokens 860 via an incident token ID. In some examples, the unified incidents tokens 860 can be linked to the ransom tokens 880 via a ransom UID, and/or the link can provide the dynamic passport 632 with access to the ransom tokens 880.

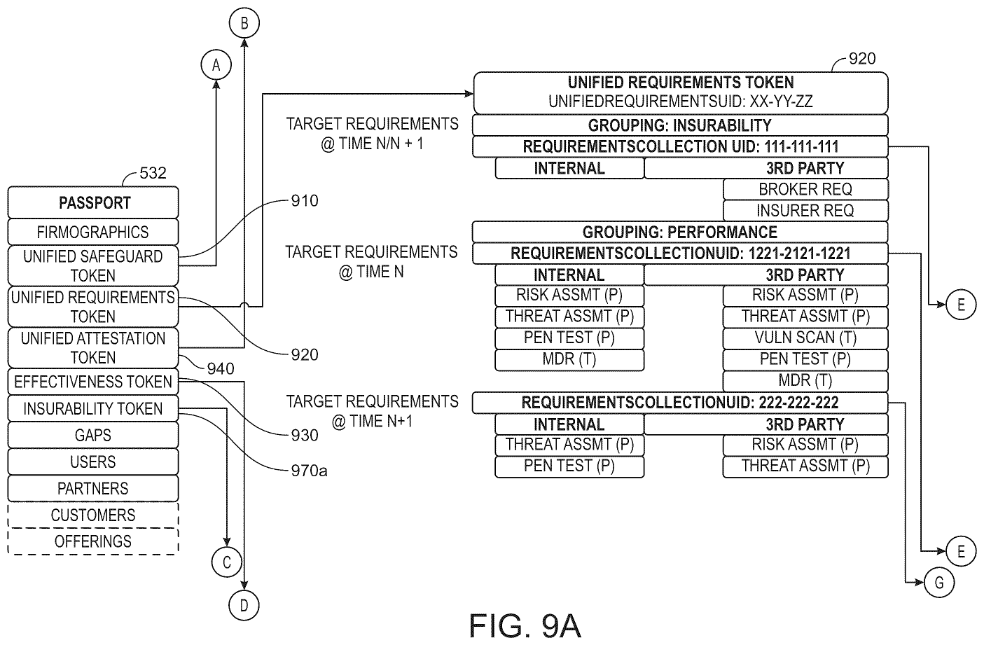

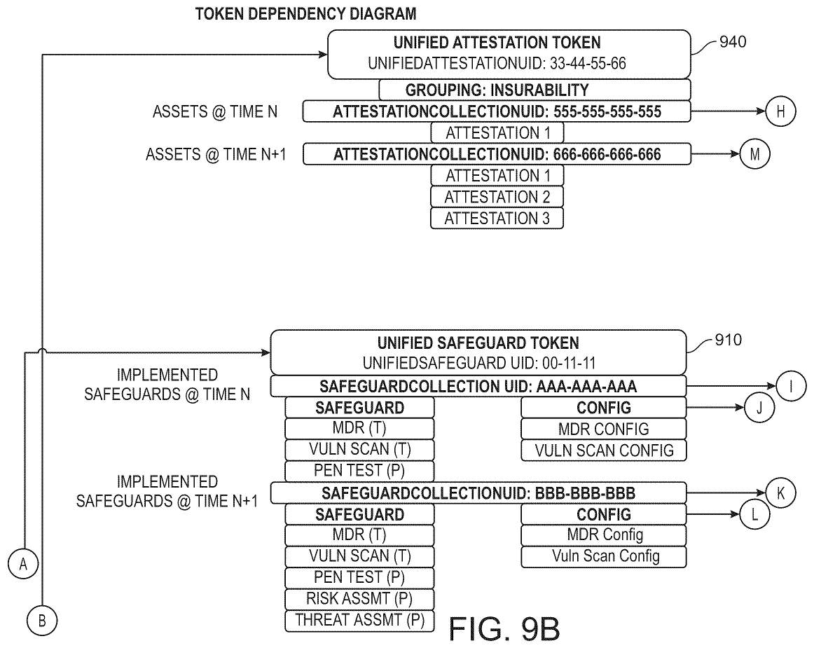

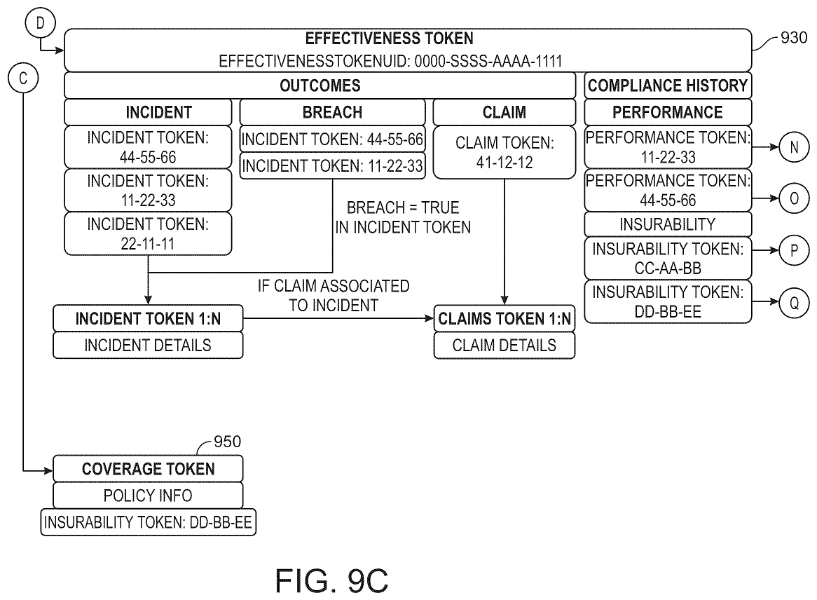

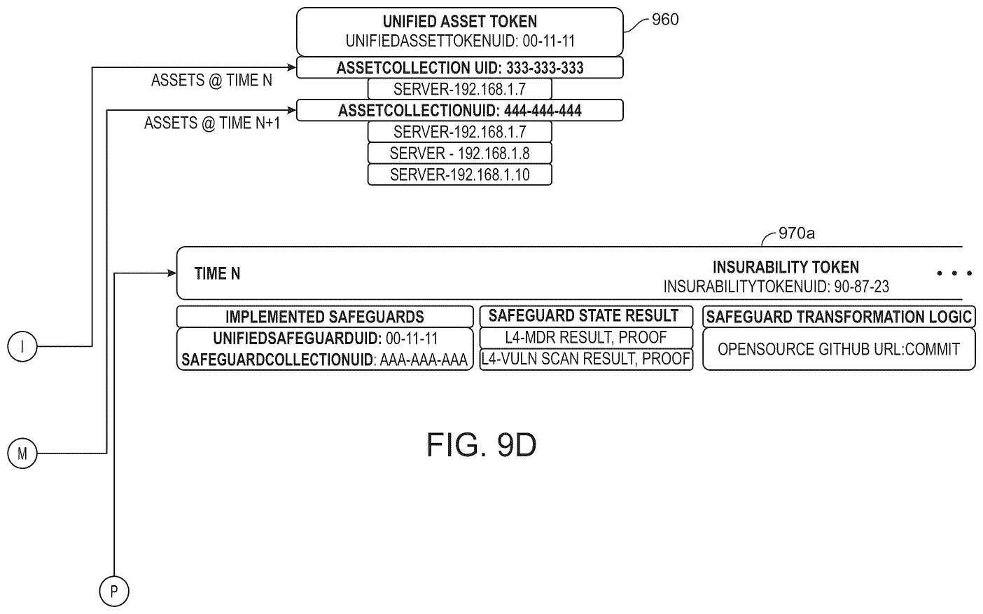

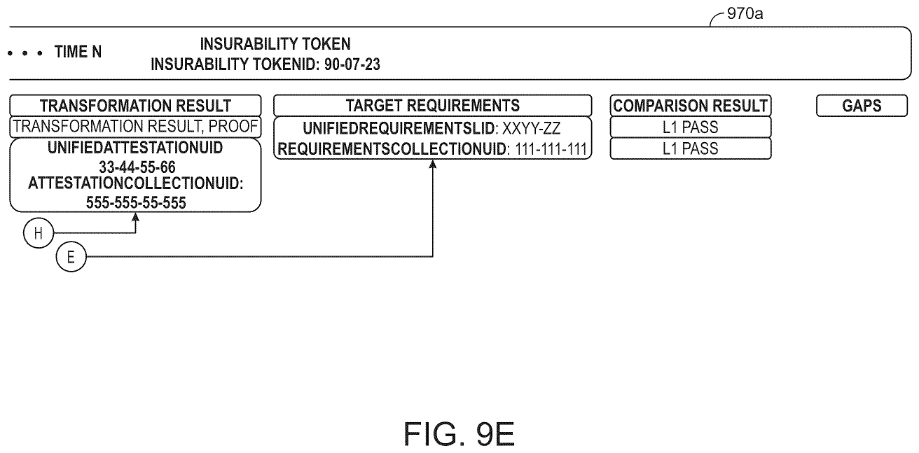

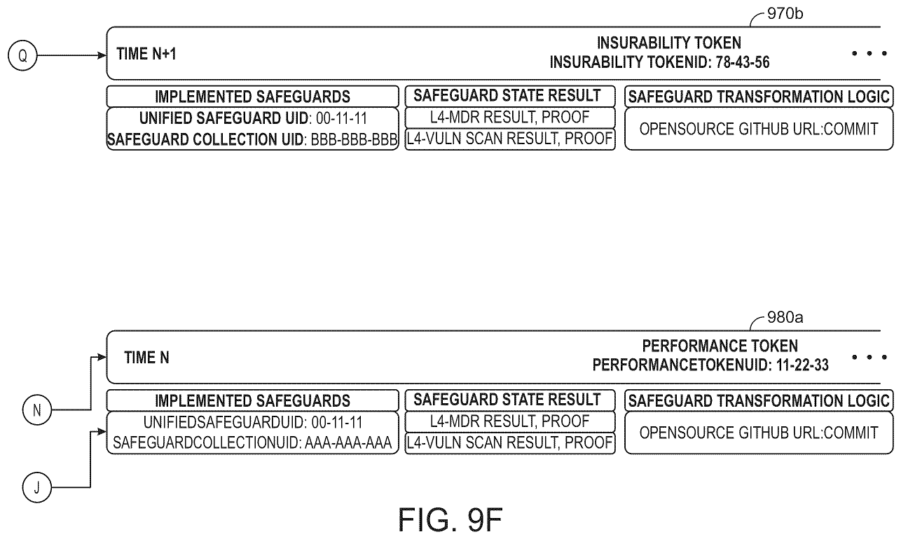

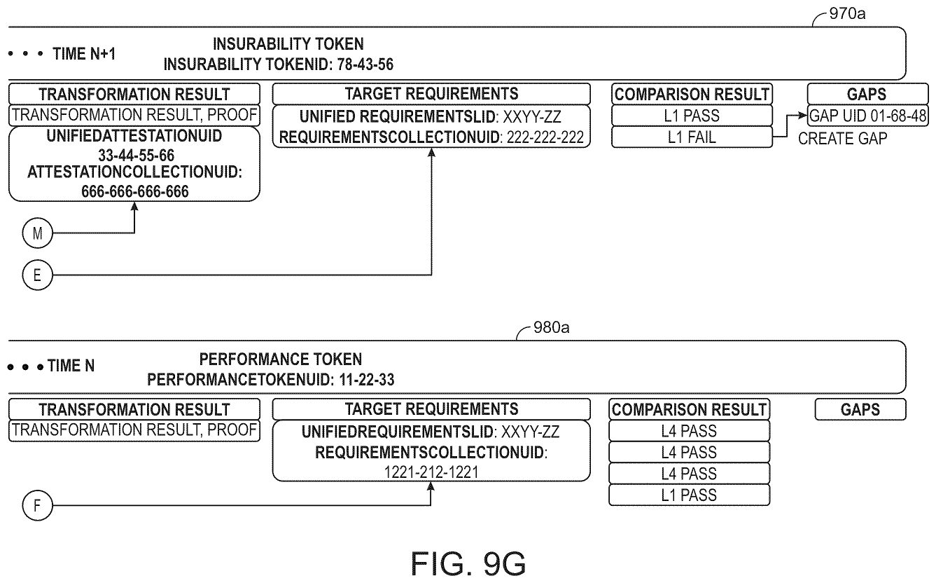

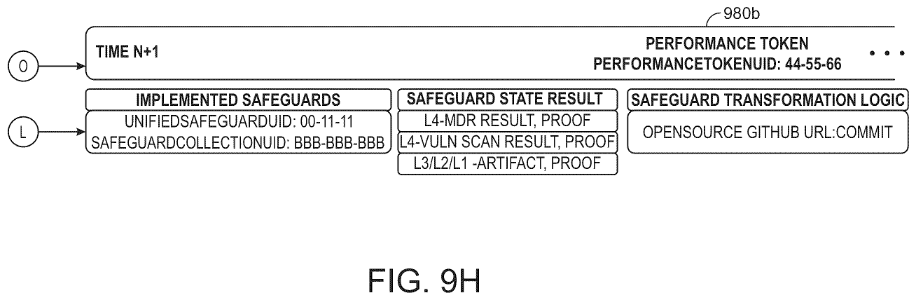

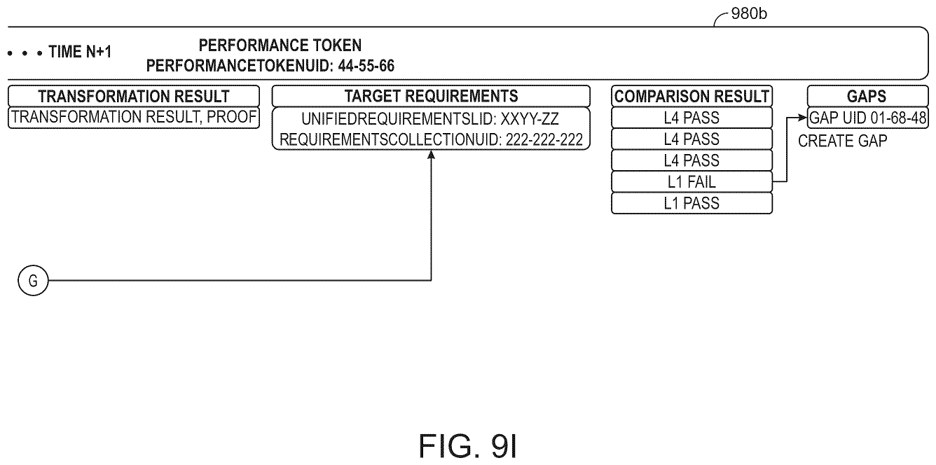

Referring generally to FIGS. 9A-9I, an architecture for tokenized cyber resilience data is shown, according to some implementations. Referring now to FIG. 9A, the dynamic passport 632 can include various cyber resilience data, such as firmographics data, unified safeguards token 910, unified requirements token 920, unified attestation token 940, effectiveness token 930, insurability token 970a, gap information, users, partners, customers, offerings, and/or so on. In some examples, the unified safeguards token 910 can receive data/be linked with other systems or data via node A, the unified attestation token 940 can receive data/be linked with other systems or data via node B, the effectiveness token can receive data/be linked with other systems or data via node C, and/or the insurability token 970a can receive data/be linked with other systems or data via node D, as further described herein. In some implementations, entities can interact with and access the dynamic passport 632 and linked tokens (e.g., unified safeguards token 910, unified requirements token 920) based on various rules (e.g., access controls with various access parameters).

In some implementations, FIGS. 9A-9I illustrates tokenized cyber security data over various times (e.g., time N/N+1, time N, time N+1, etc.). In some implementations, unified tokens (e.g., unified safeguards token 910, unified requirements token 920, unified attestation token 940, etc.) can store metadata of cyber resilience data over a time period. For example, the unified requirements token 920 can be generated by the token system 502 and can include a unified requirements UID and an insurability grouping with grouped cyber resilience data. In another example, the unified requirements token 920 can include a first requirements collection UID corresponding to requirements (e.g., cyber resilience standards for a policy) at a first time (e.g., time N/N+1), which can be linked with other systems/and or data via node E, as further described herein. In another example, the unified requirements token 920 can include a second requirements collection UID corresponding to requirements at a second time (e.g., time N+1), which can be linked with other systems/and or data via node F, as further described herein. Still yet, in another example, the unified requirements token 920 can include a third requirements collection UID corresponding to requirements at a third time (e.g., time N), which can be linked with other systems/and or data via node G, as further described herein. For example, the first, second, and/or third UID can correspond to various internal and third party cyber resilience requirements at different times, such as risk assessment data, threat assessment data, other testing data, MDR data, pen test data, vulnerability scan data, broker requirements, insurer requirements, and/or so on.

Referring now to FIG. 9B, the unified attestation token 940 can be linked to the dynamic passport 632 via node A. As described regarding the unified requirements token 920, the unified attestation token 940 can include groupings and data corresponding to attestations at various times. For example, the unified attestation token 940 can be generated by the token system 502 and can include an insurability grouping with a first attestation collection UID corresponding with assets (e.g., attestation 1) at a first time (e.g., time N), and/or the first attestation collection UID can be linked with other systems/data via node H. Further, the unified attestation token 940 can include a second attestation collection UID corresponding with assets (e.g., attestation 1, attestation 2, attestation 3, etc.) at a second time (e.g., time N+1), and/or the second attestation collection UID can be linked with other systems/data via node M. In some implementations, the unified safeguard token 910 can be linked to the dynamic passport 632 via node B. For example, as described above, the unified safeguard token 910 can include groupings and data corresponding to safeguards at various times. For example, the unified safeguard token 910 can include a first safeguard collection UID corresponding with safeguards (e.g., MDR, vulnerability scans, penetration test rules, etc.) at a first time (e.g., time N), and/or the first safeguard collection UID can be linked with other systems/data via node I. The unified safeguard token 910 can further include a first configuration, which can be linked to other data/systems via node J and include data corresponding to cyber resilience systems and protection techniques implemented in the cyber resilience architecture (e.g., MDR configurations, vulnerability scan configurations, etc.) of the organization. Further, the unified safeguard token 910 can include a second safeguard collection UID corresponding with safeguards implemented at a second time (e.g., time N+1), and/or the second attestation collection UID can be linked with other systems/data via node K. The unified safeguard token 910 can further include a second configuration, which can be linked to other data/systems via node L.

Referring now to FIG. 9C, a coverage token 950 can be linked to the dynamic passport 632 via node C. In some examples, the coverage token 950 can be generated by the token system 502 can include cyber protection information such as policy information (e.g., policy number, type, etc.) and various tokens including insurability information (e.g., an insurability token). In some implementations, the effectiveness token 930 can be linked to the dynamic passport 632 via node D. The effectiveness token 930 can include various data corresponding to cyber resilience outcomes, such as incident data (e.g., via incident tokens 1 through N), corresponding breach data (e.g., via incident tokens 1 through N), and/or corresponding claims data (e.g., via claims tokens 1 through N associated with incident tokens 1 through N). In some implementations, the effectiveness token 930 can include various data corresponding to cyber resilience compliance history, such as performance data. For example, the performance data can include multiple performance tokens including respective timestamps or identifiers corresponding to cyber resilience performance of an entity during one or more incidents/breaches or claims associated with incident tokens and claims tokens, and/or the performance tokens (e.g., performance tokens 980a-980b) can be linked to other data/systems via node N and node O. In some implementations, the effectiveness token 930 can include insurability data, such as one more insurability tokens (e.g., received via a coverage token). In some examples, the insurability tokens (e.g., insurability tokens 970a-970b) can be linked to other data/systems via node P and node Q.

Referring now to FIG. 9D, the dynamic passport 632 can be linked to the unified asset token 960 via node I and via node M. For example, the unified asset token 960 can be generated by the token system 502 and can include a first grouping of assets (e.g., server identifier 1) at a first time (e.g., time N) and a second grouping of assets (e.g., server identifier 1, server identifier 2, server identifier 3, etc.) at a second time (e.g., time N+1). In some implementations, the insurability token 970a can be linked to the dynamic passport 632 via node P with the effectiveness token 930. For example, the insurability token 970a can include insurability data at a first time (e.g., time N), such as implemented safeguards and associated identifiers, safeguard state results (e.g., L4-MDR result and proofs, L4-vulnerability scan results and proofs), and/or safeguard transformation logic (e.g., accessible via a URL or other link). Referring now to FIG. 9E, the insurability token 970a can further include a transformation result and proof, which can be linked via UIDs to node H with the unified attestation token 940. The insurability token 970a can further include target requirements, which can be linked via UIDs or other identifiers with the unified requirements token 920. The insurability token 970a can further include comparison results (e.g. L1) pass, gap data (e.g., data of missing and inadequate cyber protections), and/or more.

Referring now to FIG. 9F, the dynamic passport 632 can be linked to the insurability token 970b via node Q. As shown in FIG. 9F, the insurability token 970b can be generated by the token system 502 and can include insurability data at a second time (e.g., time N+1), such as implemented safeguards and associated identifiers, safeguard state results, and/or safeguard transformation logic. For example, the insurability token 970b can include encrypted data of implemented safeguards, such as firewall configurations or endpoint protection settings, verified against cyber resilience requirements. The encrypted data can be encapsulated within a control structure configured to restrict updates or access based on cryptographic proofs, allowing only authorized entities (e.g., those with permitted access based on RBACs) to modify, create, view, and/or retrieve the data in accordance with access controls defined for the dynamic passport 632. In some implementations, the dynamic passport 632 can be linked to the performance token 980a via node N with the effectiveness token 930. In some examples, the performance token 980a can include performance data of an entity at a first time (e.g., time N), including implemented safeguards, results, transformation logic, and/or so on. In some implementations, the implemented safeguards can be linked, via node J, with a configuration of the unified safeguard token 910.

Referring now to FIG. 9G, the insurability token 970b can further include a transformation result and proof, which can be linked via UIDs to node M with the unified attestation token 940. In some implementations, the insurability token 970b can be generated by the token system 502 and can further include target requirements, which can be linked via UIDs or other identifiers with the unified requirements token 920 via node E. Further, the insurability token 970a can further include comparison results (e.g. L1 pass/fail), gap data (e.g., gap UIDs), and/or so on. In some implementations, the performance token 980a can further include transformation results and proofs, comparison results (e.g., L4 pass/fail), and/or gaps. Further, the insurability token 970b (or another token) can store cryptographic proofs of provenance corresponding with and entity and associated cyber resilience data. In some examples, the performance token 980a can include target requirements and associated IDs, accessible via node F, from the unified requirements token 920.

Referring now to FIG. 9H, the dynamic passport 632 can be linked to the performance token 980b via node O with the effectiveness token 930. In some examples, the performance token 980b can be generated by the token system 502 and can include performance data of an entity at a second time (e.g., time N+1), including implemented safeguards, results, transformation logic, and/or so on. For example, the performance token 980a and the performance token 980b can include performance data sets encapsulated within a control structure corresponding to the dynamic passport 632, and/or access to data of the performance tokens 980a-980b can be granted based on an access data structure compatible with a control structure (e.g., allowing authorized entities to retrieve and update metadata of the performance token 980b based on access controls, restricting access and updates to the performance data based on access controls, etc.). In some implementations, the implemented safeguards can be linked, via node L, with a configuration of the unified safeguard token 910. Referring now to FIG. 9I, the performance token 980b can further include transformation results and proofs, comparison results, and/or gaps. The performance token 980b can also include target requirements and identifiers received via node G with the unified requirements token 920.

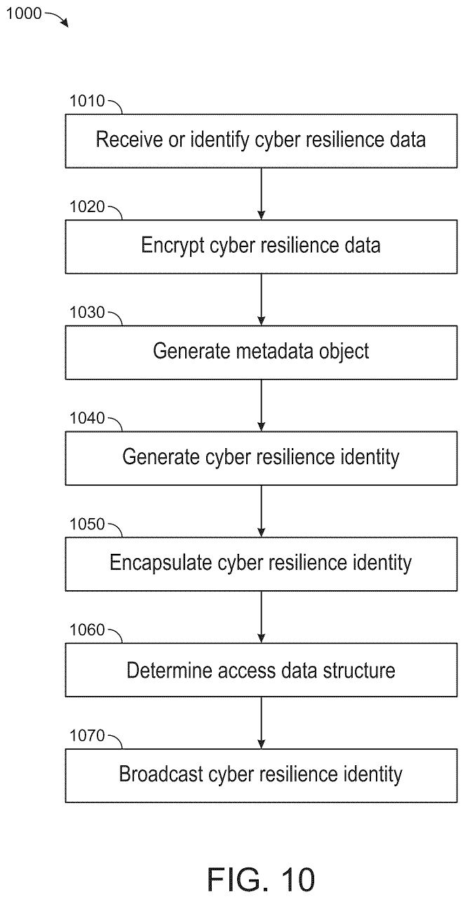

Referring now to FIG. 10, a flowchart for a method 1000 of modeling cyber resilience data using cyber resilience identities and associated metadata is shown, according to some implementations. One or more of the components described with respect to FIG. 1 or FIG. 5 can be used to perform the steps of method 1000. For example, the response system 130 of FIG. 1 or the passport system 520 of FIG. 5 can perform one or more of the steps of the method 1000. Additional, fewer, or different operations can be performed depending on the particular implementation. In some implementations, some, or all operations of method 1000 can be performed by one or more processors executing on one or more computing devices, systems, or servers. In some implementations, at least one (e.g., each) operation can be re-ordered, added, removed, or repeated.

In a broad overview of method 1000, at block 1010, the one or more processing circuits (e.g., passport system 520 of FIG. 5) can receive or identify cyber resilience data. At block 1020, the one or more processing circuits can encrypt the cyber resilience data. At block 1030, the one or more processing circuits can generate a metadata object. At block 1040, the one or more processing circuits can generate a cyber resilience identity. At block 1050, the one or more processing circuits can encapsulate the cyber resilience identity. At block 1060, the one or more processing circuits can determine an access data structure. At block 1070, the one or more processing circuits can broadcast the cyber resilience identity.

In some implementations, at block 1010, the one or more processing circuits can receive or identify cyber resilience data. For example, the metadata collection system 526 of the passport system 520 can gather performance data 710a, firmographics data 710b, safeguard data 710c, policy data 710d, incident data 710e, and/or claims data 710f. In some examples, the passport system 520 can interface with blockchain 170 to retrieve historical cybersecurity events and insurance-related data. In another example, the token system 502 can provide data corresponding to token transactions and associated cyber resilience metadata, and/or the passport system 520 can receive or identify the tokenized cyber resilience data via interactions with various tokens (e.g., performance tokens, roll-up tokens, etc.). In another example, the metadata collection system 526 can receive cyber resilience data from user computing systems 50 or from third party devices 150 through the ledger interface 524. In another example, the metadata collection system 526 can receive encrypted cybersecurity posture information and insurance data when a company signs up on the platform. In some implementations, the passport system 520 can collect and process retrieved cyber resilience data related to the historical cybersecurity performance and current risk assessments of the company. Further, in another example, the passport system 520 can gather data from external cybersecurity assessment tools integrated via the ledger interface 524.

In some implementations, at block 1020, the one or more processing circuits can encrypt the cyber resilience data. For example, the cryptographic system 522 of the passport system 520 can apply various encryption algorithms or techniques (e.g., AES-256, RSA, ECC (Elliptic Curve Cryptography), etc.) to encrypt various types of cyber resilience data (e.g., performance data 710a, safeguard data 710c, etc.). In some implementations, at block 1020, the one or more processing circuits can encrypt a portion of the cyber resilience data. That is, the passport system 520 can selectively encrypt portions of the cyber resilience data (e.g., encrypting attributes within policy data 710d or particular records in claims data 710f) received at block 1010 based on determined parameters (e.g., sensitivity, relevance, etc.) corresponding to the data or based on various additional factors (e.g., entity preferences, regulations, policy requirements, etc.). For example, the cryptographic system 522 can selectively encrypt attributes within policy data 710d, such as encryption of policy coverage data, while leaving other attributes unencrypted. In another example, the passport system 520 can apply encryption to claims data 710f to encrypt sensitive or private data such as financial amounts or claim descriptions based on determined sensitivity levels or regulatory requirements, and/or the passport system 520 cannot apply encryption to other received data (e.g., firmographics data 710b) such that at least a portion of data received at block 1010 is encrypted. Further, the passport system 520 can perform encryption dynamically as data is ingested or updated (e.g., encrypting transaction data when such data is entered into the system or encrypting data subsets based on access control policies).

In some implementations, at block 1030, the one or more processing circuits can generate a metadata object. In some examples, a metadata object generally refers to a structured set of data that provides information about other data, including data such as identification information, descriptive information, administrative information, structural information, and/or contextual information to assist in organizing, finding, and/or understanding the underlying data. For example, the passport system 520 can generate a metadata object including various attributes such as data collection timestamps, data source identifiers, and/or categorization tags. In another example, the metadata object can be generated to include information about the cyber resilience data, such as data on the origin (e.g., client device 110 or third party devices 150) of the data, data processing stages, and/or data types (e.g., performance data 710a or policy data 710d). In some implementations, at block 1030, the one or more processing circuits can generate a metadata object including metadata of cyber resilience data. For instance, the passport system 520 can generate a metadata object (e.g., information of a token) to encapsulate data related to the encrypted cyber resilience data (e.g., encryption algorithms used, encryption timestamps) and include references to related events or records (e.g., linking policy data 710d that can be encrypted to security incidents or compliance checks). Further, the metadata object generated by the passport system 520 can incorporate contextual information about data handling practices (e.g., data access controls, audit trails) and compliance measures (e.g., adherence to industry standards, internal policies, etc.) corresponding to cyber resilience data received or collected at block 1010.

In some implementations, at block 1040, the one or more processing circuits can generate a cyber resilience identity. In some examples, a cyber resilience identity generally refers to a dynamic, unique identifier that encapsulates various aspects of an entity or the cyber resilience posture (e.g., dynamic passport 632) of the organization. For example, the passport system 520 can generate a dynamic passport 632 that includes a link to the metadata object, and/or the metadata object can provide context about the cyber resilience data (e.g., data type, encryption data, data source information, etc.). In some implementations, the passport system 520 can generate a cyber resilience identity linked to a unique identifier (UID) of an entity or organization. For example, the UID can be assigned by the passport system 520 to uniquely reference and track the cyber resilience data of the entity and provide the entity with access to such data. Further, in some examples, the passport system 520 can generate a cyber resilience identity incorporating or being otherwise linked to a performance event dataset (e.g., cyber resilience dataset used to record performance metrics, security incidents, or compliance activities linked to the data of the entity). For example, the passport system 520 can generate the dynamic passport 632 to reflect updates from performance tokens, track incident logs, and/or link such records with relevant compliance checks. Further, as new data or events occur, the passport system 520 can update the cyber resilience identity (e.g., dynamic passport 632) to reflect new or updated information.

In some implementations, at block 1050, the one or more processing circuits can encapsulate the cyber resilience identity. For example, encapsulation can generally include securing, containerizing, and/or packaging the cyber resilience identity within a data structure. In some implementations, at block 1050, the one or more processing circuits can encapsulate the cyber resilience identity within a control structure restricting one or more updates or redemptions of the metadata object. For example, the passport can be linked to a control structure which can define permissions or conditions under which a metadata object (e.g., data of tokens) can be altered or accessed. In some examples, the control structure can include tokens that represent secure access points or validation measures for the encapsulated identity. In another example, the passport system 520 can use a digital signature within the control structure to verify the authenticity of the encapsulated cyber resilience identity and protect the identity and corresponding resilience data from tampering. Additionally, the passport system 520 can implement access controls (e.g., RBACs) within the control structure that restrict access based on user roles or access levels to verify that only authorized entities can modify or view elements of the cyber resilience identity. For example, the control structure can incorporate a dynamic passport 632, which can include tokens 634a-634e (e.g., resilience tokens), at least one (e.g., each) linked to a metadata interface 670 with metadata objects 672a-672e. In some examples, encapsulating can include the passport system 520 storing or aggregating the dynamic passport 632 and tokens 634 and setting corresponding access permissions (e.g., based on compliance with cyber resilience standards). For example, the control structure processor 630 can output the encapsulated data only when conditions or permissions are verified or when a valid decryption key is presented.

In some implementations, at block 1060, the one or more processing circuits can determine an access data structure. For example, an access data structure can define a format and organization of data that specifies how access permissions and conditions are structured and enforced. For example, the access data structure can incorporate access control lists (ACLs) or attribute-based access control (ABAC) mechanisms to specify access rights and restrictions based on user attributes or roles. In some implementations, at block 1060, the one or more processing circuits can determine at least one access data structure being compatible with the control structure. For example, the passport system 520 can identify an access data structure that aligns with the permissions and constraints established by control structure processor 630. For example, the passport system 520 can identify an access data structure that conforms to the permissions and constraints established by the smart contract control structure 620. Additionally, the passport system 520 can integrate the access data structure with the smart contract control structure 620 by implementing token-based authorization or rule-based access controls to manage access to the cyber resilience identity. Further, the passport system 520 can configure the access data structure to enforce access permissions and conditions using control protocols (e.g., token validation procedures through token interface 610 or multi-factor authentication settings within the smart contract control structure 620). For example, the passport system 520 can configure an access data structure that uses token-based authorization to allow only entities with valid tokens (e.g., tokens 634a-634e) generated by token generator 640 to access certain metadata objects 672 within the dynamic passport 632.

In some implementations, at block 1070, the one or more processing circuits can broadcast the cyber resilience identity. For example, the passport system 520 can broadcast the generated cyber resilience identity, including its associated metadata and performance event dataset, to a distributed ledger such as blockchain 170. In some examples, broadcasting can include the passport system 520 using the blockchain interface 660 to transmit the identity and associated data so that it is securely recorded and accessible across the distributed ledger network. In some implementations, at block 1070, the one or more processing circuits can broadcast the cyber resilience identity to a ledger or distributed ledger. For example, the passport system 520 can use the blockchain interface 660 to broadcast the cyber resilience identity to blockchain 170, where it can be immutably stored and made accessible for future verification and audit. In another example, the passport system 520 can broadcast the identity to multiple nodes within a distributed ledger, distributing the validation and recording of the cyber resilience identity across the network. Further, the broadcast can include cryptographic proofs or signatures to authenticate the identity, restricting updates or accesses to the identity as recorded on the ledger to authorized entities. For instance, the passport system 520 can broadcast the dynamic passport 632, along with linked tokens 634a-634e and associated metadata objects 672a-672e, to blockchain 170, where the broadcasted information can be validated by consensus mechanisms and securely stored across the distributed ledger.

In some implementations, the one or more processing circuits can receive an access request for the cyber resilience identity. In some implementations, the one or more processing circuits can receive, from an entity computing system corresponding to the cyber resilience identity or from an authorized entity computing system corresponding to an authorized entity of a plurality of authorized entities, an access request comprising at least one access data structure compatible with a control structure for restricting one or more updates and redemptions of a metadata object corresponding with the cyber resilience identity. That is, the passport system 520 can receive an access request that includes data structures, such as access tokens or certificates, which are evaluated against role-based access controls (RBACs) defined by the control structure (e.g., smart contract). In some examples, the cyber resilience identity can be associated with an entity and can be encapsulated within a control structure that links the identity to various tokens, such as performance tokens or safeguard tokens, which authorized entities (e.g., vendors, insurers) can request access to (e.g., a type of access such as read access, write access, etc.).

In some implementations, the one or more processing circuits can verify the access data structure. In some implementations, the one or more processing circuits can verify the at least one access data structure using the control structure. For example, the control structure (e.g., smart contract) can assess whether the access request complies with the predefined role-based access controls (RBACs) and cryptographic validation protocols. That is, verifying can include determining if the requesting entity has the necessary permissions to access or modify tokens or tokenized data within the cyber resilience identity, allowing authorized entities to interact with the associated metadata objects or performance event datasets in various ways based on various access controls.

In some implementations, the one or more processing circuits can grant access to the metadata object and the performance event dataset of the cyber resilience identity. In some implementations, the one or more processing circuits can grant access to the metadata object and the performance event dataset to the entity or the authorized entity. For example, after verifying the access request, the passport system 520 can grant access to tokens within the cyber resilience identity, such as performance tokens or safeguard tokens. That is, granting access can include permitting or allowing the client device 110 or the authorized entity computing system (e.g., third party device 150 or client device 110) to retrieve information about the cyber resilience performance of the entity over time or to view and interact with tokenized data, depending on the permissions defined by the RBACs.

In some implementations, the one or more processing circuits can decrypt the metadata object. In some implementations, the one or more processing circuits can decrypt the metadata object after access is granted. For example, the passport system 520 can use the cryptographic system 522 to decrypt tokens or portions of tokenized data as permitted by the verified access request. That is, the decryption process can be applied selectively, allowing only the data segments authorized by the RBACs to be decrypted and made accessible to the requesting entity. Additionally, the decryption can be performed in real-time as the access request is processed, maintaining the security of the metadata object throughout the interaction.

In some implementations, the one or more processing circuits can provide access to the metadata object and the performance event dataset. In some implementations, the one or more processing circuits can provide access to the metadata object and the performance event dataset by facilitating retrieval using a secure interface between the one or more processing circuits and the entity computing system or the authorized entity computing system. For example, the passport system 520 can use a secure interface, such as a blockchain interface 660, to allow the client device 110 or an authorized entity computing system to retrieve and interact with the decrypted metadata object and performance event dataset. That is, the interface enforces the RBACs and control structure policies during data retrieval, restricting access to the performance tokens and other sensitive information to authorized entities. Additionally, encryption protocols can be applied during data transmission to protect the integrity and confidentiality of the data as it is accessed by the requesting entity.

In some implementations, the control structure includes a verification function to restrict the one or more updates and redemptions of the metadata object. For example, the smart contract control structure 620 can include a verification function that validates requests to update or redeem the metadata object based on predefined rules or policies. This function can operate within the control structure to restrict any attempted updates or redemptions to those that meet verification criteria. In some implementations, the verification function is executable by control structure to validate one or more of the one or more updates and redemptions of the metadata object by verifying one or more cryptographic proofs of authorization of authorized entities prior to updating the cyber resilience identity. For example, the smart contract control structure 620 can execute a verification function that checks cryptographic proofs, such as digital signatures or hashed authentication tokens, from multiple authorized entities before processing any changes to the metadata object. In another example, the verification function can cross-reference these cryptographic proofs with a list of pre-approved entities stored within the smart contract control structure 620 to verify that only entities with the correct authorization can initiate updates. Additionally, the verification function can include multi-factor authentication protocols, where authorized entities provide multiple forms of verification (e.g., a combination of cryptographic proofs and biometric data) before any updates to the cyber resilience identity (e.g., dynamic passport 632) are processed.

In some implementations, the one or more processing circuits can be further configured to receive or identify additional cyber resilience data of an entity corresponding to the cyber resilience identity. For example, the metadata collection system 526 of the passport system 520 can gather additional data that complements the performance data 710a, safeguard data 710c, and/or other cyber resilience data previously received at block 1010. This additional data can include updated incident data 710e or newly identified vulnerabilities from third party devices 150. In some implementations, the one or more processing circuits can be further configured to receive at least one cryptographic proof of provenance of the additional cyber resilience data. For example, the passport system 520 can generate a cryptographic proof of provenance by creating a secure hash (e.g., using SHA-256) of the additional cyber resilience data, such as a software update or new compliance report. This proof of provenance can be used to verify the origin and integrity of the data, ensuring that it has not been tampered with during transmission or storage. In some implementations, the one or more processing circuits can be further configured to verify, using the verification function of the control structure, the at least one cryptographic proof of provenance. For example, the smart contract control structure 620 can compare the cryptographic proof with existing transaction records and digital signatures stored within blockchain 170 or other distributed ledgers, validating the authenticity and integrity of the newly received data before it is appended to the cyber resilience identity.

In some implementations, the one or more processing circuits can be further configured to update, using the control structure, the cyber resilience identity by updating the metadata object or appending the additional cyber resilience data to the performance event dataset. For example, the smart contract control structure 620 can automatically update the metadata object to reflect new security incidents or append the additional data to the performance event dataset, linking the metadata object with existing records in dynamic passport 632. In some implementations, the one or more processing circuits can be further configured to broadcast, using the control structure, the updated cyber resilience identity to the ledger or the distributed ledger. For example, the passport system 520 can use blockchain interface 660 to broadcast the updated cyber resilience identity and verify that nodes within blockchain 170 receive the update and that the updated identity is securely recorded across the distributed ledger for future verification and access.

In some implementations, the one or more processing circuits can be further configured to receive, from an entity computing system of an entity corresponding to the cyber resilience identity or from an authorized entity computing system corresponding to an authorized entity of a plurality of authorized entities, an access request for the cyber resilience identity. For example, the passport system 520 can receive an access request from third party devices 150 or client device 110, where the request can originate from an entity seeking to access or update the cyber resilience identity. This request can be routed through the ledger interface 524, which can validate the origin of the request and determine the appropriate access level. The request can involve accessing data, such as policy data 710d or performance data 710a, with verification against stored access control policies. In some implementations, the access request includes the at least one access data structure. For example, the request can include an access data structure such as a token-based authentication key or a cryptographic certificate that aligns with the predefined access protocols of the smart contract control structure 620 to identify and authenticate the requesting entity.

In some implementations, the one or more processing circuits can verify, using the control structure, the at least one access data structure. For example, the smart contract control structure 620 can cross-reference the access data structure with stored access permissions, checking against the ACLs or ABAC mechanisms to determine if the requesting entity is authorized to access or modify the cyber resilience identity. In some implementations, the one or more processing circuits can be further configured to grant access to the metadata object and the performance event dataset within the cyber resilience identity to an entity or an authorized entity. For example, upon successful verification, the passport system 520 can unlock portions of the metadata object and performance event dataset, allowing the authorized entity to retrieve and view the data through a secure access protocol. In some implementations, the one or more processing circuits can be further configured to decrypt the metadata object. For example, the cryptographic system 522 of the passport system 520 can apply decryption algorithms to the metadata object, such as decrypting policy data or incident logs for an authorized entity to review. In some implementations, the one or more processing circuits can be further configured to provide access to the metadata object and the performance event dataset by facilitating retrieval using a secure interface between the one or more processing circuits and the entity computing system or the authorized entity computing system. For example, the passport system 520 can establish a secure communication channel with the entity computing system via the ledger interface 524, transmitting the metadata object and performance event dataset to the verified entity or authorized entity.

In some implementations, the cyber resilience identity is a data structure encapsulating a plurality of resilience tokens. For example, the passport system 520 can generate a dynamic passport 632 that includes multiple tokens 634, where tokens 634 can include resilience tokens. In some implementations, at least one (e.g., each) of the plurality of resilience tokens corresponds to a cybersecurity dimension of a posture of an entity corresponding to the cyber resilience identity. For example, the unified tokens 612, real-time tokens 614, and/or effectiveness tokens 616 can at least one (e.g., each) represent distinct cybersecurity dimensions, such as implemented safeguards, compliance with requirements, and/or ongoing security assessments. That is, a cybersecurity dimension can correspond to an aspect or category of the overall cybersecurity posture of the entity, such as a performance, requirements, insurability, or incident response readiness category. For example, one dimension can include the technical measures in place to prevent unauthorized access (e.g., encryption standards, firewall configurations), and/or another dimension can assess the adherence by the entity to industry regulations (e.g., GDPR compliance). The various tokens described herein collectively provide a multi-faceted or multi-dimensional perspective on the cybersecurity posture of the entity, reflecting various aspects or dimensions of the security over time.

In some implementations, the plurality of resilience tokens can include at least one unified token including the cyber resilience data captured over a period of time, at least one evaluation token including the cyber resilience data captured at a plurality of points in time over the period of time, and/or at least one roll-up token including data of the at least one unified token and the at least one real-time corresponding with a security performance of the entity over the period of time. For example, the unified token processor 622 of the smart contract control structure 620 can generate unified tokens 612 that aggregate cybersecurity data (e.g., safeguards, policies, incidents) over a period of time, providing an overview of the cybersecurity measures of the entity. The real-time token processor 624 can generate real-time tokens 614 (e.g., evaluation) that capture snapshots of the cybersecurity posture of the entity at various intervals, reflecting the ongoing security status of the entity. The effectiveness token processor 626 can generate effectiveness tokens 616 (e.g., roll-up) by combining data from the unified tokens 612 and real-time tokens 614, providing an assessment of the security performance of the entity over time, including significant events or changes in security posture.

In some implementations, the at least one unified token can include a unified safeguard token including data of implemented safeguards and configurations over the period of time, a unified requirements token including data of entity-specific requirements and third party requirements over the period of time, a unified asset token including data of a plurality of assets of the entity over the period of time, or a unified attestation token including data of entity attestations over the period of time. For example, the unified token processor 622 can generate a unified safeguard token that includes records of security measures implemented by the entity, such as firewall settings or encryption protocols, over a specified period. In another example, the unified token processor 622 can generate a unified requirements token that captures compliance data (e.g., internal compliance reports) related to internal policies and third party security standards, tracking how the entity meets these requirements over time. The unified token processor 622 can also generate a unified asset token that records information about the assets of the entity, such as servers, network devices, or software licenses, and/or their associated security configurations during the period. Additionally, the unified token processor 622 can generate a unified attestation token that includes data on certifications, audits, and/or attestations made by the entity regarding its cybersecurity posture over the period.

In some implementations, the at least one real-time token can include a plurality of evaluation tokens including data of at least one of a posture of the entity, a state of the entity, or a protection of the entity at a point in time of the plurality of points in time over the period of time. For example, the real-time token processor 624 of the smart contract control structure 620 can generate evaluation tokens that capture snapshots of the cybersecurity posture of the entity at various points in time. These tokens can include data on the state of implemented security measures (e.g., firewall rules, encryption status), the overall security posture of the entity (e.g., risk levels, compliance status), and/or the effectiveness of protection mechanisms deployed across the infrastructure of the entity. In another example, the evaluation tokens can reflect the response of the entity to incidents or threats, documenting how the security systems were adjusted or enhanced in real-time. The real-time token processor 624 can also generate tokens that track the operational status of systems within the entity, such as the availability of services or the integrity of key data at intervals. These tokens provide a time-stamped record of the security environment of the entity, which supports analysis of how the cybersecurity posture of the entity changes over time.

In some implementations, the one or more processing circuits can be further configured to generate the at least one access data structure for at least one of an entity computing system of an entity corresponding to the cyber resilience identity or an authorized entity computing system corresponding to an authorized entity of a plurality of authorized entities. For example, the passport system 520 can generate an access data structure that defines access permissions and conditions for the cyber resilience identity, incorporating attributes such as user roles, access levels, and/or data access rights. In another example, the passport system 520 can generate a role-based access control (RBAC) mechanism, where at least one (e.g., each) role is associated with predefined access rights and permissions linked to aspects of the cyber resilience identity. Alternatively, in some implementations, the one or more processing circuits can be further configured to receive, from at least one of the entity computing system or the authorized entity computing system, the at least one access data structure. For example, the passport system 520 can receive an access data structure from a third party device 150, where the structure includes access control lists (ACLs), attribute-based access control (ABAC) definitions, RBAC policies, or various additional and alternative controls. In another example, the passport system 520 can receive access tokens or digital certificates from the authorized entity computing system, specifying access permissions and conditions for interacting with the cyber resilience identity.

In some implementations, the least one access data structure can include a token, key, certificate, or access mechanism. For example, the passport system 520 can generate a digital token that grants access rights to an authorized entity to interact with certain components of the dynamic passport 632. In another example, the passport system 520 can issue a cryptographic key or digital certificate to decrypt certain portions of the cyber resilience data or verify the authenticity of transactions related to the dynamic passport 632. In some implementations, the one or more processing circuits are further configured to, in determining the at least one access data structure being compatible with the control structure, in response to receiving the at least one access data structure, configure the at least one access data structure by updating the control structure to enforce restrictions on the one or more updates and redemptions of the metadata object. For example, the passport system 520 can receive a token from an authorized entity computing system and update the smart contract control structure 620 to restrict the modification of metadata objects linked to the dynamic passport 632 based on the permissions encoded within the token. In another example, the passport system 520 can update the smart contract control structure 620 to incorporate the received access data structure, thereby enforcing restrictions on how and when metadata objects can be accessed or modified.

In some implementations, updating the control structure includes updating one or more access parameters of the control structure. For example, the passport system 520 can modify access control lists (ACLs) or role-based access control (RBAC) settings within the smart contract control structure 620 to align with the permissions granted by the new access data structure. For example, RBACs can include rules for accessing tokenized data (e.g., metadata object) based on roles (e.g., entity types or roles of a user within an entity) or other access control parameters (e.g., date/time, user preferences, etc.) In some examples, users or entities associated with a cyber resilience identity (e.g., passport) can select or provide information used for generated RBACs (e.g., based on consent preferences selected via a user interface, other data sharing preferences associated with an entity, regulations, etc.). For example, the passport system 520 can modify access control lists (ACLs) or role-based access control (RBAC) settings within the smart contract control structure 620 to align with the permissions granted by the new access data structure. That is, the passport system 520 can dynamically adjust the control structure to reflect changes in authorized entities, permission levels, and/or data access restrictions as defined by the new access data structure. Further, the passport system 520 can update cryptographic keys or tokens associated with the control structure to ensure that only the entities with the updated permissions can access or modify the cyber resilience identity. Additionally, the passport system 520 can track and log these updates in the distributed ledger.

In another example, the passport system 520 can adjust encryption parameters or key management policies within the smart contract control structure 620 to confirm that entities with a correct or matching access data structure can interact with the dynamic passport 632. In some implementations, the one or more processing circuits are further configured to, in determining the at least one access data structure being compatible with the control structure, in response to generating the at least one access data structure, provide, to the entity computing system or the authorized entity computing system, the at least one access data structure. For example, the passport system 520 can generate a digital certificate or token and transmit it to the authorized entity computing system, granting access to components of the dynamic passport 632 based on the permissions encoded within the access data structure. In another example, the passport system 520 can provide an access key to the entity computing system, authorizing interaction with the metadata object or performance event dataset associated with the dynamic passport 632 (e.g., interaction with the tokens 634) to one or more entities (e.g., an entity corresponding to the passport, another authorized entity such as an insurer of a group of approved insurers, etc.).

In some implementations, the cyber resilience data can include at least one of firmographics data, safeguard data, performance data, policy data, incident data, or claims data. For example, the passport system 520 can collect and categorize cyber resilience data from various sources, such as firmographics data 710b detailing organizational characteristics, safeguard data 710c describing implemented security measures, performance data 710a capturing cybersecurity performance metrics, policy data 710d outlining internal and external security policies, incident data 710e reporting security breaches or vulnerabilities, and/or claims data 710f related to insurance or legal claims following security incidents. In some implementations, the control structure can include a smart contract, and/or the control structure can include a smart contract control structure. For example, a smart contract generally refers to a self-executing contract with the terms of the agreement written into code. In some examples, the smart contract control structure can manage the execution of rules and conditions tied to the cyber resilience identity. For example, the smart contract control structure can automate token transactions, verify cryptographic proofs, and/or enforce access control measures without manual intervention. The smart contract can interact with the tokens (e.g., unified tokens 612, real-time tokens 614, effectiveness tokens 616) to validate actions such as updating the metadata object, transferring ownership of tokens, or adjusting permissions within the control structure. The smart contract control structure can also execute predefined functions based on the conditions encoded in the smart contract, such as triggering updates to the dynamic passport 632 when new resilience data is received or when certain criteria are met.

In some implementations, tokenization of the data can provide a secure and efficient method for clients to share their cyber risk information with brokers and carriers. For example, the passport system 520 can use a tokenization process to convert cyber resilience data into tokens that can be securely shared and managed. In some implementations, DNFTs can include a journal of performance history events, such as cybersecurity management events or insurance-related events. For example, the passport system 520 can generate DNFTs verifiable through a multi-signature wallet or a signature verification mechanism within the smart contract, involving trusted entities to sign off on events they participated in. In some implementations, insureds can create and manage their DNFTs using an interface provided by the passport system 520, securely storing their cybersecurity posture and insurance information and updating it as necessary. In some examples, DNFTs can track and verify performance history events, maintaining authenticity and transparency.

In some implementations, access to sensitive data can be controlled through an access control mechanism within the smart contract, restricting decryption and access to authorized parties. For example, the passport system 520 can manage access controls to sensitive data, ensuring only authorized entities can decrypt and access data. The DNFT structure can feature a unique identifier, encrypted metadata, and/or a list of performance history events. The passport system 520 can use an updateDNFT function (e.g., DNFT.updateDFNT( ) to update the encrypted metadata link in the DNFT, and/or a signEvent function to verify the authenticity of performance history events by including a fee in tokens, allowing only the DNFT owner to add event signatures. The passport system 520 can implement DNFT visibility and access control through an access control mechanism in the smart contract or the API.

In some implementations, the components and data flow for creating a dynamic NFT (DNFT) for at least one (e.g., each) business that tokenizes its security posture can include business registration and data collection. For example, the passport system 520 can facilitate the registration process, where businesses provide information, including firmographics, posture information, and/or insurance data. Once the data is collected, it can be encrypted using key management via an API and stored in a secure data storage service. The passport system 520 can deploy a smart contract to facilitate the creation, update, and/or transfer of DNFTs, using blockchain oracles to access encrypted data from the API and include it in the DNFT as metadata.

In some implementations, the DNFT structure can include a unique identifier, encrypted metadata linked to data accessible via the API, and/or a journal of performance history events. For example, as the cybersecurity posture and insurance information change of the company, the encrypted data can be updated in secure storage, and/or the metadata link in the DNFT can be revised as necessary. The passport system 520 can use a multi-signature wallet or a signature verification mechanism within the smart contract to maintain the authenticity of performance history events, involving trusted entities to sign off on events they were involved in. For example, authorized parties can access the encrypted information via an access control mechanism in the smart contract or the API, restricting decryption and access to only the DNFT owner, authorized insurers, or brokers. The architecture of the passport system 520 can achieve tokenization of the cybersecurity posture of the business while maintaining data confidentiality and allowing authorized parties to securely access the information.

In some implementations, a company can register on a platform and create an account. For example, the passport system 520 can facilitate the company in uploading its encrypted cybersecurity posture and insurance information to the platform. The company can create metadata from the uploaded information, encrypt it with key management systems, and/or upload it to a secure data storage service. The passport system 520 can facilitate the creation of the DNFT using platform-acquired tokens and incorporate the encrypted data as metadata within the DNFT. In some implementations, the company can view and manage its DNFTs through an interface provided by the passport system 520. For example, this can involve handling performance history events, such as cybersecurity management events or insurance-related events, and/or updating the encrypted metadata link as necessary. The passport system 520 can use a signEvent function to verify the authenticity of events, involving a fee paid in tokens and engaging trusted entities to sign off on events they participated in. In some implementations, insurers or brokers can access the encrypted information in the DNFTs with permission from the company to assess risk and propose suitable insurance policies. For example, the passport system 520 can provide a method for authorized parties to securely manage and verify the cybersecurity posture and insurance information of a company, improving trust and reducing the likelihood of fraud.

### Zero-Knowledge Proof (ZKP) Modeling

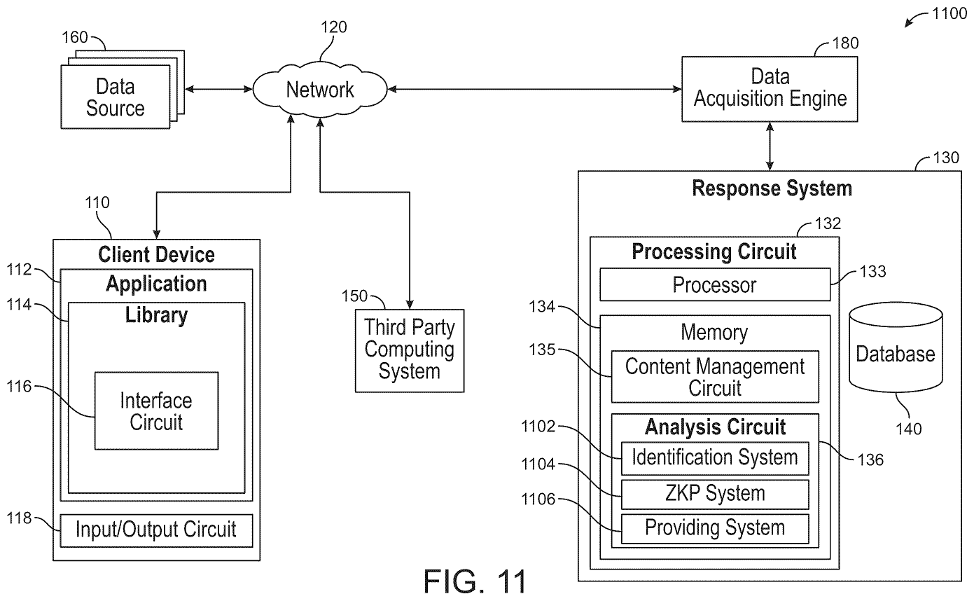

Referring to FIG. 11, a block diagram of an implementation of a system 1100 for zero-knowledge proof (ZKP) modeling is shown, according to some implementations. The implementation shown in FIG. 11 includes a client device 110 (also referred to herein as user computing system, entity computing system, etc.), response system 130, third party device 150 (also referred to herein as third party device, etc.), data sources 160, and/or data acquisition engine 180. In some implementations, the client device 110 can include an application 112 and an input/output circuit 118. The application 112 can include a library 114, and/or the library 114 can include an interface circuit 116. In some implementations, the response system 130 can include a processing circuit 132 and a database 140. The processing circuit 132 can include a processor 133 and memory 134. The memory 134 can further include a content management circuit 135 and an analysis circuit 136. In some implementations, the analysis circuit 136 can include an identification system 1102, a zero-knowledge proof (ZKP) system 1104, and/or a providing system 1106, as further described herein. The various components of FIG. 11 can be interconnected through a network 120 (e.g., decentralized network, centralized network, data source, etc.).

In some implementations, the elements shown in FIG. 11 can incorporate similar features and functionality as described regarding the elements shown on FIG. 1 or FIG. 5. For example, the response system 130, as shown in FIG. 11, incorporates similar functionality as described regarding the response system 130 of FIG. 1, and/or the database 140, can incorporate the same or similar functionality as described regarding the database 140 of FIG. 1, and/or so on. Specifically, like callout references of FIG. 1 are now further described, however the features and functionalities of components like the response system 130 in FIG. 11 still correspond to those referred to with the same callout reference in FIG. 1. For example, response system 130 described in FIG. 11 can include additional functionality and features related to zero-knowledge proof (ZKP) modeling.

At least one (e.g., each) system or device of FIG. 11 (e.g., response system 130, identification system 1102, ZKP system 1104, providing system 1106, etc.) can include one or more processors, memories, network interfaces (sometimes referred to herein as a “network circuit”) or user interfaces. For example, the client device 110, response system 130, third party device 150, identification system 1102, ZKP system 1104, and/or providing system 1106 can include one or more logic devices, which can be one or more computing devices equipped with one or more processing circuits that run instructions stored in a memory device to perform various operations. The processing circuit can be made up of various components such as a microprocessor, an ASIC, or an FPGA, and/or the memory device can be any type of storage or transmission device capable of providing program instructions. The instructions can include code from various programming languages commonly used in the industry, such as high-level programming languages, web development languages, and/or systems programming languages. The client device 110, response system 130, identification system 1102, ZKP system 1104, providing system 1106, and/or other various components of FIG. 11 can also include one or more databases for storing data that receive and provide data to other systems and devices on the network 120.

The memory (e.g., memory 134) can store programming logic (e.g., content management circuit 135) that, when executed by the processor, controls the operation of the corresponding computing system or device. The memory can also store data in databases. For example, memory can store programming logic that when executed by a processor within a processing circuit, causes a database to update parameters or store a system or event log. The network interfaces can allow the computing systems and devices to communicate wirelessly or otherwise. The various components of devices in system 100 can be implemented via hardware (e.g., circuitry), software (e.g., executable code), or any combination thereof. Devices, systems, and/or components in FIG. 11 can be added, deleted, integrated, separated, and/or rearranged in various implementations of the disclosure.

Generally, the client device 110, response system 130, third party device 150, analysis circuit 136, identification system 1102, ZKP system 1104, and/or providing system 1106 can perform various operations to model, generate, or provide zero-knowledge proofs. A zero-knowledge proof can include or refer to cryptographic protocols or outputs that allow one party (the prover) to prove the truth of a statement to another party (the verifier) without conveying additional information. That is, ZKPs can obfuscate underlying data used to generate the proof such that the fact of compliance or readiness is shared and sensitive configurations (e.g., security controls), internal assessments (e.g., internal compliance reports), or proprietary data are secured or protected. For example, a zero-knowledge proof can prove or confirm various data, statements, or conditions, such as confirming or verifying that organizational security measures align with protocols for security frameworks (e.g., NIST, ISO), validating that an entity computing infrastructure includes a set of incident response capabilities, proving that a risk level (e.g., low, medium) falls within an acceptable threshold set by a third party (e.g., protection provider, insurer, etc.), and/or so on.

In some implementations, the client device 110 can include any computing system or device associated with an entity. For example, an entity can interact with client device 110 to cause client device 110 to transmit and receive data (e.g., perform data exchanges) to or from response system 130 or third party devices 150 via network 120. In some implementations, client device 110 can transmit, receive, or cause transmission of cyber resilience data. Cyber resilience data can include or refer to any data of any type, such as attestation data, configuration data, safeguard data, incident data, effectiveness data, protectability data, insurability data, and/or so on. For example, attestation data can indicate whether an entity has implemented one or more protections (e.g., access controls, encryption mechanisms, etc.) in a computing or networking infrastructure. For example, configuration data can operational data associated with security tools, safeguards, or other systems or protocols deployed or implemented by the entity. For example, safeguard data can include metrics or values indicating implemented security measures (e.g., firewall throughput, endpoint coverage, etc.). For example, incident data can include historical data, documents, logs, or other information associated with cybersecurity events (e.g., breaches, ransomware attacks, etc.), such as event lists, attack types, affected systems, or remediation actions. For example, effectiveness data can include information related to the reliability or performance of cybersecurity controls or response protocols, such as threat detection accuracy, number and scope of incidents, or historical response times. For example, protectability data can include claims data, insurability assessments, minimum levels of protection, predefined risk thresholds, and/or so on. In some implementations, the attestation data, configuration data, safeguard data, incident data, effectiveness data, and/or protectability data can be encapsulated in tokens. For example, the client device 110 can transmit a token including cyber resilience data to response system 130 or third party devices 150.

In some implementations, the network 120 can include or refer to any decentralized network, centralized network, or data source (DNCNDS). For example, a decentralized network can include any distributed architecture where interconnected nodes (e.g., client device 110, response system 130, third party device 150, etc.) exchange, process, and/or store data without reliance on a single central authority. For example, a decentralized network can include a blockchain in which data is maintained in an immutable ledger shared across nodes. Additionally, a decentralized network can implement consensus algorithms, such as proof-of-work or proof-of-stake, to validate data exchanges between nodes. For example, a centralized network can include one or more servers or computing systems configured to manage and route data exchanges within the system 1100. For example, a centralized network can include a cloud-hosted environment or on-premises server infrastructure that aggregates, processes, and/or distributed data to various computing systems or components. A data source can include any repository, database, or system capable of storing or providing data relevant to operations within the system 1100. For example, a data source can include a database, document store, system log, or external APIs that store data configured for retrieval.

In some implementations, the database 140 can include any system, repository, or storage medium configured to store, manage, or provide access to data relevant to operations performed by the response system 130 or other components of the system 1100. For example, the database 140 can store structured or unstructured data, including data used for generating or minting tokens, zero-knowledge proof (ZKP) modeling, or compliance verification. In some implementations, the database 140 can act as a secure repository for storing intermediate or final data used in cryptographic processes. For example, the database 140 can store cryptographic commitments, hashes, or other data produced in generating zero-knowledge proofs or applying zero-knowledge proof techniques or protocols. In some implementations, the database 140 can store entity data or third party data (e.g., attestations, safeguards, compliance parameters). For example, the database 140 can maintain logs or records of compliance parameters of an insurer, implemented safeguards within an entity security architecture, incident histories corresponding entities or insured parties, and/or other data that can be queried or referenced by the response system 130 for various operations (e.g., generating or validating tokens, performing zero-knowledge proofs, determining compliance, etc.).

In some implementations, the third party device 150 can include any computing system or device associated with an external entity, such as a protection provider, vendor, partner organization, service provider, insurer, or compliance authority. The third party device 150 can interact with various systems or components of the system 1100, such as the client device 110 or response system 130, via network 120 to transmit, receive, or process data. For example, the third party device 150 can receive tokens encapsulating cyber resilience data, such as attestation tokens, safeguard tokens, or incident tokens, from the response system 130. In some implementations, the third party device 150 can issue verification requests to the response system 130. For example, a verification request can include a posture or compliance parameter, such as a requirement to validate whether an entity meets security standards (e.g., encryption protocols, access control mechanisms). Upon, responsive to, or subsequent to providing the verification request, the third party device 150 can receive a zero-knowledge proof (ZKP) or an indication of ZKP validation from the response system 130 and can use the received ZKP to confirm compliance or performance without accessing raw data used to determine the compliance or the performance.

In some implementations, the data sources 160 can include any system, repository, or database configured to provide or store data relevant to operations performed by the system 1100. For example, data sources 160 can include organizational databases, third party databases, external data feeds, system logs, or third party APIs. Data sources 160 can provide various data that can be used in generating or verifying tokens, modeling zero-knowledge proofs (ZKPs), or evaluating compliance with posture or performance parameters. In some examples, data sources 160 can provide attestation data, configuration data, safeguard data, incident data, effectiveness data, or protectability data associated with one or more entities. For example, a data source 160 can include an organizational repository storing logs or historical records of cybersecurity events, such as incident response timelines, affected systems, or remediation actions. For example, data sources 160 can include an external compliance framework or database (e.g., repository of NIST or ISO security standards) that provides criteria or thresholds used to evaluate compliance. For example, data sources 160 can include one or more threat intelligence feeds configured to issue updated information on known vulnerabilities or incidents relevant to entity performance.

In some implementations, the data acquisition engine 180 can include any system, component, interface, or endpoint configured to facilitate the retrieval, aggregation, or exchange of data between the response system 130 and various systems or components connected via the network 120. For example, the data acquisition engine 180 can interact with client device 110, third party device 150, and/or data sources 160 to transmit or receive data used by response system 130 for token generation, zero-knowledge proof (ZKP) modeling, or compliance verification. For example, the data acquisition engine 180 can retrieve cyber resilience data, such as configuration data or incident logs, from the client device 110 for processing by the response system 130. For example, the data acquisition engine 180 can receive compliance requirements or performance thresholds from third party device 150. For example, the data acquisition engine 180 can query data sources 160 (e.g., request external APIs, query organizational repositories, search external databases, connect to threat intelligence feeds, etc.) and provide outputs of the queries to the response system 130.

In some implementations, the response system 130 can perform various operations to model, generate, or provide zero-knowledge proofs. In some implementations, the response system 130 can cause sub-systems, such as identification system 1102, ZKP system 1104, and/or providing system 1106, to perform various operations to model, generate, or provide zero-knowledge proofs. For example, the response system 130 or identification system 1102 receive or identify at least one token including cyber resilience data. That is, the cyber resilience data can include or be associated with one or more structured data objects including data (e.g., attestation data, incident data, safeguard data, insurability data, etc.) associated with one or more entities. In some implementations, the response system 130 or identification system 1102 can identify or receive cyber resilience data corresponding with at least one posture or compliance parameter of at least one third party. For example, the identification system 1102 or response system 130 can receive, via an application programming interface (API), a verification request including the at least one posture or compliance parameter from third party device 150 and identify a corresponding token (e.g., attestation token, safeguard token, etc.) related to the verification request.

A posture or compliance parameter can include or refer to any condition, value, criteria, threshold, or attribute associated with any type of data. For example, a posture or compliance parameter can include standards or requirements instituted by a protection provider as a condition for providing a protection product to an entity. That is, a protection provider can require that an entity demonstrate compliance with the ISO/IEC 27001 standard for information security management systems. The posture or compliance parameter can include: “The organization is to implement an encryption mechanism for transmitted data.” The cyber resilience data can include attestation data verifying that encryption protocols, such as TLS 1.3, are active for network communications. For example, a posture or compliance parameter can include organizational metrics to verify security of a data exchange within an organizational architecture or network. That is, for a secure data exchange with a vendor, the posture parameter can include: “Data exchanges are to use encrypted channels with a minimum key length of 256 bits,” and the cyber resilience data can include structured data objects verifying the use of AES-256 encryption for the data exchange. For example, a posture or compliance parameter can include a value or threshold associated with a security posture of a computing and networking infrastructure of one or more entities. For example, a compliance or posture parameter can include: “The organization is to demonstrate a patch management process with less than 5% of systems having unpatched critical vulnerabilities,” and the cyber resilience data can include effectiveness data documenting that 97% of entity computing systems are patched against known vulnerabilities.

In some implementations, the response system 130 or ZKP system 1104 can perform a zero-knowledge proof (ZKP) on the cyber resilience data. For example, the response system 130 or ZKP system 1104 can perform a zero-knowledge proof by applying or executing one or more zero-knowledge proof techniques or algorithms (e.g., a zero-knowledge succinct non-interactive arguments of knowledge (zk-SNARKs) protocol, a zero-knowledge scalable transparent arguments of knowledge (zk-STARKS) protocol, etc.) on the cyber resilience data. In some implementations, the response system 130 or ZKP system 1104 can determine at least one posture or compliance parameter of the at least one third party is satisfied based on the cyber resilience data. That is, the response system 130 or ZKP system 1104 can compare the cyber resilience data (e.g., attestation data, configuration data, safeguard data, incident data, effectiveness data, etc.) to the posture or compliance parameter and determine that the cyber resilience data meets or exceeds the parameters. For example, the cyber resilience data can include an attestation such as, “The entity has implemented L1 and L2 protections,” and the posture or compliance parameter can include a third party requirement associated with the attestation (e.g., “The entity is to implement at least L1 protections for compliance”). For example, the response system 130 or ZKP system 1104 can analyze the cyber resilience data to identify one or more attributes of the cyber resilience data (e.g., attestations, configurations, effectiveness scores, insurability or protectability metrics, etc.) corresponding to a posture or compliance parameter.

In some implementations, to perform the zero-knowledge proof, the response system 130 or ZKP system 1104 can generate at least one ZKP of the cyber resilience data. Generating the at least one ZKP can include the response system 130 or ZKP system 1104 applying one or more transformations, logical operations, or cryptographic techniques (e.g., hashing, encryption, transformation algorithms, secure aggregation, etc.) to at least a portion of the cyber resilience data. In some implementations, the at least one ZKP includes at least one cryptographic commitment obfuscating the cyber resilience data to prevent exposure of sensitive information. For example, the response system 130 or ZKP system 1104 can generate a ZKP by hashing compliance attributes and embedding the resulting hash into a tokenized data object that verifies compliance without revealing specific configurations or operational details. In some implementations, the response system 130 or ZKP system 1104 can generate multiple ZKPs corresponding to a different aspects or dimensions of the cyber resilience data and link the ZKPs with corresponding tokens (e.g., attestation tokens, safeguard tokens, incident tokens, effectiveness tokens, etc.).

In some implementations, the response system 130 or providing system 1106 can provide, to at least one third party computing system of the at least one third party, the at least one ZKP or indication of performance of the at least one ZKP. For example, the response system 130 or providing system 1106 can transmit the proof to third party device 150 via a zero-knowledge proof application programming interface (e.g., ZPK API) in response to a compliance verification request transmitted from the third party device 150. That is, the providing system 1106 can respond to the verification request by transmitting the ZKP itself, or by a confirmation that the ZKP was successfully generated and validated based on the compliance parameters associated with the request. For example, the third party device 150 can request verification of compliance with industry standards such as NIST or ISO, and/or the response system 130 or providing system 1106 can transmit the ZKP confirming compliance without revealing the underlying configurations or assessment data.

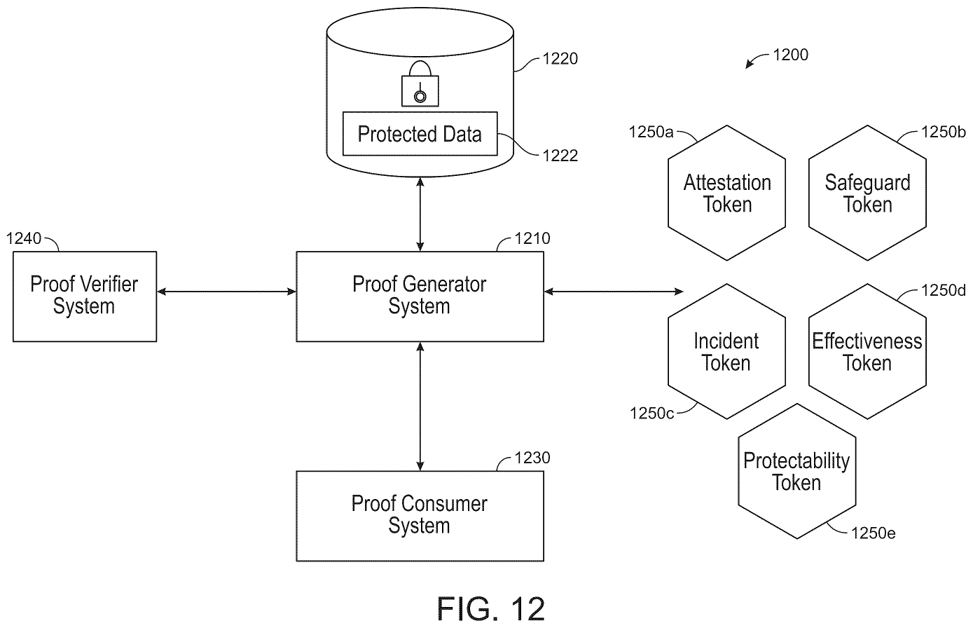

Referring now to FIG. 12, a block diagram of a system 1200 for zero-knowledge proof (ZKP) modeling is shown, according to some implementations. The implementation shown in FIG. 12 includes a proof generator system 1210, a protected database 1220, a proof consumer system 1230, a proof verifier system 1240, and/or tokens 1250a-1250e (collectively, tokens 1250). In some implementations, the protected database 1220 can include protected data 1222. In some implementations, the tokens 1250 can include an attestation token 1250a, a safeguard token 1250b, an incident token 1250c, an effectiveness token 1250d, and/or a protectability token 1250e. In some implementations, the elements shown in FIG. 12 can incorporate similar features and functionality as described regarding the elements shown on FIG. 1, FIG. 5, or FIG. 11. For example, the proof generator system 1210, as shown in FIG. 12, incorporates similar functionality as described regarding the response system 130 and ZKP system 1104 of FIG. 11, and/or the protected database 1220, as shown in FIG. 12, can incorporate the same or similar functionality as described regarding the database 140 of FIG. 11, and/or so on.

In some implementations, the proof generator system 1210 can generate zero-knowledge proofs (ZKPs) by applying cryptographic techniques to a witness (w) and a predefined statement (S). The witness (w) can include a structured set of private inputs or attributes associated with cyber resilience data, such as attestation data, configuration data, safeguard metrics, or incident records associated with one or more entities. The statement (S) can define a public condition to be proven, such as a compliance or posture parameter, operational metric, or performance threshold corresponding with the cyber resilience data. In some implementations, the proof generator system 1210 can construct the witness (w) by gathering private inputs associated with the cyber resilience of an entity. For example, the proof generator system 1210 can access or retrieve data from tokens 1250 to construct the witness. That is, the witness (w) can include tokenized entity attributes (e.g., “firewall coverage=90%”), incident histories (e.g., number of breaches during interval), performance metrics (e.g., “response time<5 minutes”), or other protected values.

In some implementations, the proof generator system 1210 encodes the witness (w) and statement (S) into a structured mathematical framework compatible with a zero-knowledge proof (ZKP) protocol. For example, encoding can include transforming the public statement (S) into a series of logical constraints or polynomial equations that define the relationship between the public conditions described in the statement (S) and the private inputs encapsulated in the witness (w). For example, the proof generator system 1210 can translate compliance conditions in the statement (S) into constraints. That is, the statement (S) can define a parameter or threshold, such as “firewall coverage>90%,” and the proof generator system 1210 can encode the parameter or threshold as a constraint comparing the private firewall metric in the witness (w) against the threshold. For example, the constraint can be expressed as a Boolean condition or as an arithmetic relationship configured for polynomial encoding. In some examples, the proof generator system 1210 preprocesses the private inputs in the witness (w) by applying cryptographic transformations to standardize or aggregate the data. For example, the proof generator system 1210 can normalize performance metrics in the witness (w) to provide compatibility with the ZKP framework or apply aggregation techniques to reduce the complexity of large datasets. Aggregation can include determining or computing the average effectiveness score of multiple safeguards and normalization can include scaling the data into a range for cryptographic evaluation. In some examples, the proof generator system 1210 can map logical operations or relationships into constraints verifiable by the ZKP protocol. For example, the proof generator system 1210 can encode conditions, such as “safeguard A is active AND safeguard B is active,” as Boolean constraints. In another example, the proof generator system 1210 can represent arithmetic conditions, such as “combined safeguard effectiveness>95%,” as polynomial constraints.

In some implementations, the proof generator system 1210 can generate a cryptographic commitment to the witness (w). For example, the cryptographic commitment can provide a binding mechanism that securely links the private inputs in the witness (w) to the proof while validating the contents of the private inputs remain confidential and inaccessible outside of a protected environment. For example, the cryptographic commitment can confirm that proof is verifiable and that any tampering with the private inputs or the proof itself would be detectable. For example, the cryptographic commitment can include a hash-based commitment. That is, the proof generator system 1210 can apply a cryptographic hash function (e.g., SHA-256, Blake3) to the private inputs in the witness (w). The hash function outputs a fixed-size hash value that acts as an irreversible representation of the private data (e.g., verifying that the original inputs cannot be reconstructed from the hash) and obfuscates the private inputs. In another example, the cryptographic commitment can include a polynomial commitment. For example, the proof generator system 1210 can encode the private inputs in the witness (w) as coefficients of a low-degree polynomial and evaluate the polynomial at multiple random points to generate the cryptographic commitment. The cryptographic commitment can validate that any modifications to the witness (w) or tampering with the proof can be detected by a proof verifier (e.g., proof verifier system 1240). For example, if an attempt is made to alter the inputs in the witness (w) after the commitment is generated, the hash value or polynomial evaluations would no longer match the proof, resulting in verification failure.

In some implementations, the proof generator system 1210 can apply a zero-knowledge proof (ZKP) protocol to the encoded constraints and cryptographic commitments to generate a ZKP. For example, applying can include the proof generator system 1210 evaluating the relationship between the private inputs in the witness (w) and the public conditions in the statement (S) as defined by the encoded constraints using a zk-SNARKs or zk-STARKs protocol. For example, when implementing a zk-SNARKs (zero-knowledge succinct non-interactive arguments of knowledge) protocol, the proof generator system 1210 can construct a set of quadratic arithmetic programs (QAPs) to represent the encoded constraints, in which at least one (e.g., each) constraint is expressed as a polynomial equation and the relationship between the private data and the public conditions is transformed into a system of equations. The proof generator system 1210 can evaluate the polynomials at predefined points over a finite field and generate a succinct proof using elliptic curve pairings. In another example, the proof generator system 1210 can implement a zk-STARKs (zero-knowledge scalable transparent arguments of knowledge) protocol, where the constraints are encoded into a system of low-degree polynomials. The proof generator system 1210 evaluates can evaluate the polynomials over a large finite field and use a probabilistic proof system to generate the ZKP. For example, the proof generator system 1210 can apply the Reed-Solomon code to encode the constraints and generate proofs based on Merkle tree commitments of the polynomial evaluations.

In some implementations, the proof verifier system 1240 can validate zero-knowledge proofs (ZKPs) generated by the proof generator system 1210 to confirm that a public statement (S) is satisfied with respect to private inputs encapsulated in the witness (w) without accessing the private inputs. In some implementations, the proof verifier system 1240 can be operated by a third party entity, such as an external auditor, compliance authority, insurer, or other independent system responsible for evaluating compliance, performance, or eligibility based on the ZKP. In some examples, the proof verifier system 1240 can receive the proof, the encoded statement (S), and/or any public parameters or commitments associated with the proof. Further, the proof verifier system 1240 can validate that commitments generated by the proof generator system 1210, such as hash-based or polynomial commitments, remain unaltered and consistent with the proof structure. For example, to perform zk-SNARKs validation, the proof verifier system 1240 can evaluate quadratic arithmetic programs (QAPs) that encode the constraints derived from the statement and the witness, in which at least one (e.g., each) constraint is represented as a polynomial equation, and/or the proof verifier system 1240 can verify the proof by performing elliptic curve pairing checks to determine that the evaluated polynomials satisfy the constraints. For example, to perform zk-STARKs validation, the proof verifier system 1240 can validate low-degree polynomial constraints encoded in the proof and check the correctness of the polynomial evaluations using Merkle tree commitments and probabilistic checks over a finite field. Responsive to validation of the proof, the proof verifier system 1240 can generate a verification result indicating whether the proof satisfies the statement (S). For example, the verification result can confirm that an entity complies with a regulatory standard, meets a performance metric, or satisfies an underwriting requirement for cyber insurance. The proof verifier system 1240 can transmit the verification result to the proof consumer system 1230 for further use, such as logging compliance, granting access, or issuing a certification.

In some implementations, the proof generator system 1210 can associate the ZKP with one or more tokens 1250 (e.g., attestation tokens 1250a, safeguard tokens 1250b, incident tokens 1250c, effectiveness tokens 1250d, protectability tokens 1250e). A token 1250 can include a structured data object that encapsulates cyber resilience data and one or more corresponding ZKPs. For example, the proof generator system 1210 can bind a ZKP to a cryptographic commitment within a token 1250 in response to validating a predefined condition or constraint associated with data of the tokens (e.g., compliance with a posture requirement, performance thresholds, or operational metrics).

In some implementations, at least one (e.g., each) of the tokens 1250 can encapsulate or store structured cyber resilience data with cryptographic commitments and associated zero-knowledge proofs (ZKPs) that validate conditions or constraints without revealing underlying sensitive inputs. For example, the attestation token 1250a can include a ZKP generated from a witness (w) including private attributes, such as encryption status, access control configurations, or other security parameters. The proof generator system 1210 can generate the ZKP to validate a predefined statement (S), such as “the entity has implemented encryption and access control mechanisms,” by encoding the conditions as logical constraints (e.g., encryption_active=TRUE AND RBAC_active=TRUE) that are satisfied by the private inputs. For example, the safeguard token 1250b can include structured data representing metrics or thresholds for security safeguards implemented in a networking infrastructure of an entity. For example, a ZKP can validate a condition, such as “firewall coverage>90%,” where the proof generator system 1210 constructs a witness (w) including the actual firewall coverage percentage (e.g., 92%) and encodes the condition into polynomial constraints that are evaluated over a finite field to generate a succinct proof without revealing the specific firewall coverage value.

In some implementations, the incident token 1250c can include data representing historical incident metrics, such as the number of breaches, ransomware events, or affected systems during a predefined time interval. For example, a ZKP for incident token 1250c can validate a condition such as “number of breaches<3” by encoding the incident data into constraints (e.g., breach_count<3). For example, the effectiveness token 1250d can include operational performance data or metrics evaluating the reliability of safeguards or incident response systems. For example, a ZKP for effectiveness token 1250d can validate a condition such as “average response time<5 minutes” by constructing constraints that encode the response time values into a polynomial framework. The proof generator system 1210 can normalize or aggregate the response time metrics and validate compliance while obfuscating granular operational details (e.g., systems or vulnerabilities exposed as a result of response times). In some examples, the protectability token 1250e can include data related to compliance thresholds, insurability levels, or predefined protection metrics. For example, a ZKP for protectability token 1250e can validate a statement (S) such as “insurability score>80” by evaluating the encoded attributes of the witness (w) against a threshold defined in the statement (S).

In some implementations, the proof generator system 1210 can retrieve cyber resilience data from the tokens 1250. For example, responsive a request to validate attestation data from the proof consumer system 1230, the proof generator system 1210 can access or retrieve attestation token 1250a and extract attestations stored or embedded in the token. For example, the proof generator system 1210 can access tokens 1250 to extract or embed cryptographic commitments, validate included proofs, or apply further cryptographic transformations to derive additional proofs. In some implementations, the protected database 1220 or protected data 1222 can store or provide tokens 1250 and related cyber resilience data. For example, tokens 1250 can include references, metadata, or cryptographic commitments associated with the private inputs (e.g., protected data 1222). For example, the protected database 1220 can store sensitive or private data and provide to the data to the proof generator system 1210 for constructing witnesses (w) and generating ZKPs without exposing the data to other third party computing systems or networks. Additionally, the proof consumer system 1230 or proof verifier system 1240 can access the protected database 1220 to retrieve tokens 1250 or associated public parameters for validation processes.

In some implementations, the proof verifier system 1240 can validate the ZKPs embedded in tokens 1250. For example, the proof verifier system 1240 can receive a token 1250, extract the cryptographic proof, and/or verify that the constraints encoded in the proof align with the public statement (S). The proof verifier system 1240 can perform validation using public parameters, such as commitments or encoded constraints. In some examples, the proof verifier system 1240 can validate commitments using hash checks, elliptic curve pairings (e.g., for zk-SNARKs), or polynomial consistency checks (e.g., for zk-STARKs). Responsive to validation, the proof verifier system 1240 can generate a verification result confirming the validity of the proof associated with the token 1250.

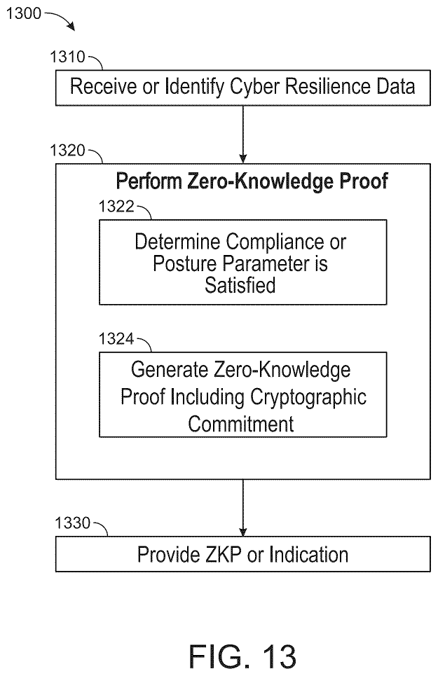

Referring now to FIG. 13, a flowchart for a method 1300 of zero-knowledge proof (ZKP) modeling is shown, according to some implementations. In some implementations, one or more systems or components described here (e.g., with respect to FIG. 1, FIG. 5, or FIG. 11) can perform the steps of method 1300. For example, the response system 130 of FIG. 1 or the analysis circuit 136 of FIG. 11 can perform one or more of the steps of the method 1300. Additional, fewer, or different operations can be performed depending on the particular implementation. In some implementations, some, or all operations of method 1300 can be performed by one or more processors executing on one or more computing devices, systems, or servers. In some implementations, at least one (e.g., each) operation can be re-ordered, added, removed, or repeated.

In a broad overview of method 1300, at block 1310, the one or more processing circuits (e.g., response system 130, analysis circuit 136, etc.) can receive or identify cyber resilience data. At block 1320, the one or more processing circuits can perform a zero-knowledge proof. At block 1322, the one or more processing circuits can determine a parameter is satisfied. At block 1324, the one or more processing circuits can generate a ZKP. At block 1330, the one or more processing circuits can provide the ZKP or an indication.

In some implementations, at block 1310, the one or more processing circuits (e.g., response system 130, analysis circuit 136, etc.) can receive or identify cyber resilience data. Receiving or identifying can include accessing structured or unstructured data from one or more sources, such as data repositories, interfaces (e.g., APIs), external systems, distributed ledgers, or encrypted data channels. For example, the one or more processing circuits can receive one or more tokens including cyber resilience data associated with at least one entity from an entity device or third party device (e.g. one or more third party computing systems). In some implementations, receiving or identifying can include extracting security attributes, incident histories, configuration parameters, or safeguard metrics from cyber resilience tokens. In some examples, receiving or identifying can include the one or more processing circuits authenticating the cyber resilience data using cryptographic signatures, hash-based checks, or other data validation protocols. In some implementations, the cyber resilience data received or identified at block 1310 can correspond with at least one posture or compliance parameter of at least one third party. That is, the cyber resilience data can correspond with measurable technical attributes used to determine whether values or conditions are satisfied. In some examples, the one or more processing circuits can retrieve or identify the token based on the at least one posture or compliance parameter. For example, the one or more processing circuits can retrieve an incident token (e.g., incident token 1250) in response to receiving a request to validate an incident history associated with a computing and networking infrastructure of an entity.

In some implementations, the at least one posture or compliance parameter can include metrics related to attestation data, such as cryptographic proofs of implemented safeguards, encryption configurations (e.g., key lengths like 256-bit AES, encryption algorithms such as RSA or ECC), or secure communication protocol compliance (e.g., TLS 1.3). In some implementations, the at least one posture or compliance parameter can include metrics for safeguard data, such as firewall rules, intrusion detection/prevention system (IDS/IPS) configurations, multi-factor authentication (MFA) enforcement, role-based access control (RBAC) policies, or least-privilege access settings. In some implementations, the at least one posture or compliance parameter can include metrics for incident data, such as incident detection times, recovery time objectives (RTOs), response plan execution statuses, or system rollback metrics following a security event. In some implementations, the at least one posture or compliance parameter can include effectiveness data, such as vulnerability scan results, malware detection rates, or compliance with system integrity checks (e.g., secure boot verification or hash-based file integrity monitoring). In some implementations, the posture or compliance parameters can include various data, values, or conditions, such as metrics for protectability data, (e.g., patch management compliance, adherence to security hardening baselines (e.g., CIS or NIST standards), software version control states, configuration alignment with predefined benchmarks, etc.), vulnerability metrics (e.g., number of unresolved vulnerabilities, Common Vulnerability Scoring System (CVSS) scores, statuses of remediation efforts related to identified risks), data exchange validation parameters (e.g., cryptographic handshakes, exchanges of key-value pairs, token integrity checks, compliance with transmission protocols), and/or so on.

In some implementations, at block 1320, the one or more processing circuits can perform a zero-knowledge proof (ZKP) on the cyber resilience data. In some implementations, at block 1320, the one or more processing circuits (e.g., response system 130, analysis circuit 136, etc.) can perform a zero-knowledge proof (ZKP) on the cyber resilience data. Performing a ZKP can include applying transformation logic (e.g., aggregations, cryptographic operations, hashing, etc.) to validate specific attributes, values, or conditions associated with the cyber resilience data and protecting or securing the underlying cyber resilience data. For example, the one or more processing circuits can execute a commitment scheme using a cryptographic hash function (e.g., SHA-256) or using custom transformation logic (e.g., a function, protocol, or framework defined by an entity, intermediary, third party, etc.).

In some implementations, at block 1322, the one or more processing circuits can determine a parameter is satisfied. For example, at block 1322, the one or more processing circuits can determine at least one posture or compliance parameter of the at least one third party is satisfied based on the cyber resilience data. That is, the one or more processing circuits can validate whether the cyber resilience data or at least a portion of the cyber resilience data meets third party standards, requirements, or benchmarks. For example, the one or more processing circuits can determine the at least one posture or compliance parameter is satisfied by extracting values from a safeguard token (e.g., number or type of implemented safeguards in a networking infrastructure) and determining the extracted data complies with third party requirements (e.g., verifying that multi-factor authentication (MFA) enforcement is allowed for all administrative accounts or that intrusion prevention systems (IPS) are actively monitoring network traffic) without exposing the extracted values directly (e.g., safeguarding or protecting the number or type of implemented safeguards from exposure). In some examples, determining that a parameter is satisfied can include comparing the cyber resilience data attributes to expected values or compliance thresholds stored in policy repositories, distributed ledgers, or other secure databases. In some examples, the one or more processing circuits can apply logical operations or conditional checks to determine whether the received data reflects compliance with frameworks or standards (e.g., ISO 27001 or NIST 800-53). For example, if the cyber resilience data includes a cryptographic proof of patch management compliance, the one or more processing circuits can validate the associated timeline and patching frequency against a compliance parameter (e.g., at least 90% entity systems are to be patched) provided by a third party. That is, one or more expected values can include predefined thresholds for compliance (e.g., minimum encryption key lengths, maximum response times, mandated safeguard implementations, etc.) used by the one or more processing circuits to validate whether the received attributes (e.g., hashed attributes) align with the expected values based on a comparison of the entity data or cyber resilience data to the expected values.

In some implementations, at block 1324, the one or more processing circuits can generate a ZKP. That is, the one or more processing circuits can generate at least one ZKP including at least one cryptographic commitment obfuscating the cyber resilience data. For example, the one or more processing circuits can extract relevant attributes from the cyber resilience data, such as security configurations or security controls, safeguard metrics, or incident histories, and/or apply a cryptographic commitment scheme (e.g., Pedersen commitments or Merkle hashing) to securely encode the extracted attributes without exposing their raw values. In some examples, the one or more processing circuits can transform the extracted attributes using aggregation logic, logical operations, or normalization processes. For example, a safeguard attribute, such as the number of implemented intrusion prevention systems (IPS), can be transformed into an aggregated value (e.g., sum or binary pass/fail state) for cryptographic commitment generation. In some examples, the one or more processing circuits can hash the transformed data using secure hash algorithms (e.g., SHA-256, SHA-3, or Blake2) to generate cryptographic outputs. These outputs can serve as inputs to ZKP protocols, such as zk-SNARKs or zk-STARKs, to create verifiable proofs that satisfy the compliance or posture requirements without revealing the actual attributes or data values.

In some implementations, at block 1330, the one or more processing circuits can provide the ZKP or an indication. That is, at block 1330, the one or more processing circuits can provide, to at least one third party computing system of the at least one third party, the at least one ZKP or indication of performance of the at least one ZKP. Providing the ZKP can include securely transmitting the proof, cryptographic commitment, or associated metadata through a communication interface such as an application programming interface (API) configured to provide ZKPs, encrypted communication channels, or distributed ledger frameworks. For example, the one or more processing circuits can provide the ZKP embedded within a data field of a structured data object, such as a cyber resilience token or a proof object, which can include the cryptographic proof, digital signatures, or verification metadata used third party validation (e.g., public parameters). In some examples, the one or more processing circuits can transmit or provide an indication of performance of the at least one ZKP, such as a status flag (e.g., “pass” or “valid”) or a compliance summary. In some examples, the one or more processing circuits can transmit or provide an indication of performance of the at least one ZKP, such as a status flag (e.g., “pass” or “valid”) or a compliance summary. For example, the indication can include a compliance score (e.g., 95% adherence to security policies), a classification level (e.g., “low risk,” “moderate risk”), a timestamped verification status (e.g., “compliant as of [date/time]”), or a summary of validated safeguards (e.g., “MFA enabled, encryption active, IPS operational”). In another example, the indication can include performance metrics, such as a recovery time objective (RTO) verification status, an incident readiness level (e.g., “ready” or “optimized”), or an aggregated safeguard effectiveness rating derived from the ZKP validation.

In some implementations, the one or more processing circuits can provide the ZKP using stateless verification methods facilitated through zero-knowledge proof protocols (e.g., zk-STARKs). For example, a third party verifier can validate the provided ZKP using publicly available parameters, cryptographic keys, or hash values without accessing the original cyber resilience data or maintaining stateful records. In some examples, the ZKP or corresponding indication can be recorded on a distributed ledger (e.g., blockchain). Additionally, the one or more processing circuits can include metadata such as timestamps, entity identifiers, or compliance parameters with the ZKP. For example, when providing a ZKP verifying that at least 90% of systems are patched, the one or more processing circuits can include a compliance timestamp and hash of the associated safeguard token for third party systems to validate the proof. In some examples, the indication of performance can be presented as an API response payload (e.g., including verification results, token identifiers, proof parameters, etc.).

In some implementations, the cyber resilience data corresponds with attestation data, safeguard data, incident data, effectiveness data, or protectability data of the at least one entity, and/or the at least one cryptographic commitment verifies the at least one posture or compliance parameter is satisfied and protects the attestation data, safeguard data, incident data, effectiveness data, or protectability data. That is, the cryptographic commitment can verify compliance or posture parameters based on applying hash-based validation, transformation logic, or commitment schemes (e.g., Pedersen commitments or Merkle trees) to confirm that specific attributes satisfy predefined thresholds or benchmarks. For example, the cryptographic commitment can verify that recovery time objectives (RTOs) are met by comparing cryptographically hashed incident metrics to stored compliance parameters or validating that encryption key lengths match expected standards using hash-derived commitments. Additionally, the cryptographic commitment protects the cyber resilience data by obfuscating the underlying attributes while preserving verifiability. For example, the commitment can encode firewall configuration states or vulnerability remediation metrics as secure hash values such that the underlying data is obfuscated and remains inaccessible outside of a protected environment or database during verification. In some examples, blinding factors or randomized inputs can be applied during the commitment generation process to prevent exposure of sensitive safeguard data, incident details, or configuration parameters to unauthorized systems or entities.

In some implementations, the at least one token includes at least one of a unified attestation token, a unified safeguard token, an incident readiness token, an effectiveness token, or a protectability token, and/or wherein the cyber resilience data obfuscated by the at least one ZKP comprises one or more configurations of security controls, internal compliance reports or assessments, or incident histories and responses. That is, a unified token can include or refer to a data structure encapsulating one or more types of cyber resilience attributes in a single tokenized object. For example, a unified safeguard token can include data or metadata of active security control configurations of an entity, such as multi-factor authentication (MFA) enforcement states, intrusion prevention system (IPS) rules, or port access policies (e.g., port 443 for HTTPS traffic). In some examples, configurations of security controls can include sensitive data defining firewall rules, encryption key configurations (e.g., key lengths, rotation schedules), or endpoint protection settings specifying anti-malware policies and real-time threat monitoring thresholds. In some examples, internal compliance reports or assessments can include outputs from vulnerability scans, security posture audits, or risk assessments that detail unresolved vulnerabilities, configuration gaps, or compliance deviations. In some examples, incident histories and responses can include records of security event logs, incident detection and escalation timelines, specific remediation actions taken, or rollback metrics that detail affected systems, resolution pathways, and/or time to recovery following security incidents.

In some implementations, the one or more processing circuits can receive, via an application programming interface (API), a verification request including the at least one posture or compliance parameter of the at least one third party. For example, the verification request can include a query to validate compliance with encryption protocols (e.g., AES-256 encryption key usage), a query to validate the activation status of safeguards (e.g., intrusion detection systems (IDS)), and/or so on. For example, the API can be a zero-knowledge proof application programming interface (ZKP API) configured to verify that security controls, compliance, or risk level of an organization or entity satisfy parameters or requirements of a third party. For example, the ZKP API can facilitate the exchange of tokens between various nodes, validate the tokens by generating ZKPs corresponding to tokenized content, and/or provide the token or ZKP in response to a request from a third party computing system transmitted to the ZKP API. That is, the ZKP API can receive a message or request to validate a condition associated with configurations, safeguards, or other entity data (e.g., that security controls of a selected type are implemented) and can provide a proof or indication of a proof to validate the condition without transmitting the configurations, safeguards, or other entity data directly to the requestor.

In some implementations, the one or more processing circuits can transmit, via the API, a response to the verification request comprising the at least one ZKP or the indication of performance of the at least one ZKP to a third party computing system of the at least one third party. That is, the API can provide cryptographically verified results of compliance or posture validation in a structured format (e.g., a binary status flag, compliance score, or detailed proof response) without exposing raw attributes or configuration data. In some implementations, the API restricts access between a public environment and the cyber resilience data of a protected environment. That is, the API can enforce data isolation and access control policies (e.g., providing proofs responsive to requests for data) to prevent unauthorized systems in a public computing infrastructure or network (e.g., public environment) from accessing sensitive cyber resilience data managed within a protected infrastructure or network (e.g., an entity or intermediary computing or networking environment, such as a decentralized network, centralized network, data source, etc.). In some implementations, the public environment corresponds to a plurality of third party computing systems. That is, the public environment can include a network or collection of third party computing devices, such as insurer computing systems, vendor computing systems, auditor computing systems, and/or so on (e.g., computing systems of other external entities requesting of compliance, performance, or posture validation).

In some implementations, the protected environment includes the one or more processing circuits and communication is restricted based at least on (i) transmitting the response comprising the ZKP and (ii) protecting the cyber resilience data from the public environment. That is, the protected environment can host the one or more processing circuits, secure repositories, or other components used for processing, validating, and/or storing the cyber resilience data while maintaining isolation from external networks or systems. For example, the protected environment can maintain isolation from a public environment by enforcing communication policies, such as requiring API authentication, encrypted message transmission (e.g., TLS), or digital signatures to verify request origin and integrity. In some examples, the protected environment can employ protections such as an air-gapped infrastructure, role-based access controls (RBAC), or time-bound tokens to maintain privacy of the environment.

In some implementations, determining the at least one posture or compliance parameter is satisfied can be based at least on modeling one or more attributes of the cyber resilience data and one or more values or conditions corresponding with the at least one posture or compliance parameter to determine the one or more attributes satisfy the one or more values or conditions. That is, modeling can include applying one or more computational processes, such as mathematical functions, logical operations, transformation rules, or predictive algorithms, to analyze the relationships between attributes of the cyber resilience data and predefined thresholds, benchmarks, or compliance conditions. For example, the modeling can incorporate attribute aggregation, normalization, weighting, or scoring to derive composite values representing compliance states or posture levels. In some examples, modeling can include mapping the cyber resilience data to a set of rules, frameworks, or risk evaluation models, such as compliance matrices, rule-based systems, or machine learning models trained to evaluate security posture attributes. Additionally, modeling can include applying temporal analyses, such as evaluating data across timelines to identify patterns, trends, or anomalies, or conducting conditional simulations to determine how attributes of the cyber resilience data would satisfy evolving or hypothetical compliance conditions. In some examples, the modeling can include implementing artificial intelligence (AI) techniques or neural networks to process the cyber resilience data, where the neural network can model relationships between complex attributes and compliance conditions by identifying patterns, applying weighted evaluations, or generating predictive outputs to determine whether the attributes satisfy predefined thresholds or benchmarks.

In some implementations, generating the at least one ZKP includes determining, by the one or more processing circuits, one or more attributes of the cyber resilience data corresponding to the at least one posture or compliance parameter. That is, the one or more processing circuits can identify data points, metrics, or parameters within the cyber resilience data that are relevant to validating compliance or posture conditions. For example, the one or more processing circuits can determine encryption attributes, such as encryption key lengths or cryptographic algorithms implemented by an entity, in response to a request to validate a safeguard associated with encryption protocols required for providing a type of protection. For example, the one or more processing circuits can identify safeguard metrics, such as the number of active firewalls or intrusion prevention system (IPS) rules, in response to a request to verify a safeguard associated with encryption protocols implemented by the entity. Identifying or determining can include retrieving or accessing tokens (e.g., from a blockchain, decentralized ledger, etc.). For example, determining can include connecting to various data streams, data sources, or repositories of the at least one entity using a ZKP API, another interface, an endpoint, etc.

In some implementations, generating the at least one ZKP includes applying, by the one or more processing circuits, one or more transformations, logical operations, or aggregations to one or more attributes. That is, the one or more processing circuits can process the attributes by performing operations such as summation, averaging, comparison, normalization, or conditional evaluation to produce intermediate values for proof generation, as described further with regard to FIG. 12. In some implementations, generating the at least one ZKP includes hashing, by the one or more processing circuits, the one or more attributes. For example, the one or more processing circuits can hash encryption key lengths, incident timelines, or system configuration states to produce fixed-length outputs that can be used in the proof without revealing the original attribute values. In some implementations, generating the at least one ZKP includes generating, by the one or more processing circuits, the at least one cryptographic commitment based on the one or more attributes and the one or more transformations, logical operations, or aggregations. The hashed one or attributes can include [[ . . . ]] That is, the one or more processing circuits can combine the hash outputs with transformation results or logical operation outputs using cryptographic commitment schemes, as described in further with regard to FIG. 12.

In some implementations, the one or more processing circuits can validate the at least one ZKP based at least one on cross-referencing the at least one cryptographic commitment with one or more expected values derived from the one or more transformations, logical operations, or aggregations. That is, validation can include comparing the cryptographic commitment generated during proof creation to reference values, policy-defined thresholds, or precomputed benchmarks to confirm that the underlying attributes satisfy the posture or compliance conditions. For example, the one or more processing circuits can validate a cryptographic commitment derived from patch management attributes by cross-referencing it with expected values (e.g., compliance percentages, timelines, etc.) stored in secure repositories or policy databases. In some examples, validation can include confirming that cryptographic commitments correspond to expected outcomes derived from the applied transformations or logical operations. For example, the one or more processing circuits can verify a commitment representing an EDR coverage level or a risk classification by comparing the commitment to predefined values known to satisfy the third party parameter being verified.

In some implementations, generating the at least one ZKP include generating the at least one ZKP includes applying, by the one or more processing circuits, at least one of a zero-knowledge succinct non-interactive arguments of knowledge (zk-SNARKs) protocol or a zero-knowledge scalable transparent arguments of knowledge (zk-STARKS) protocol. That is, the one or more processing circuits can use a zk-SNARKs protocol to generate compact and non-interactive cryptographic proofs that verify whether conditions or compliance parameters are satisfied. That is, the one or more processing circuits can use a zk-SNARKs protocol to generate a cryptographic proof by applying a sequence of mathematical transformations to the cyber resilience data, such as encoding compliance attributes (e.g., encryption key lengths or safeguard activations) into a compressed proof structure. For example, the zk-SNARKs protocol can take a transformed attribute, such as the output of a logical operation indicating multi-factor authentication (MFA) enforcement, and/or produce a succinct proof that can be verified without revealing the original data or intermediate steps. In some examples, the one or more processing circuits can use a zk-STARKs protocol to generate a proof by converting the cyber resilience data into a polynomial representation and validating the results of transformations, logical operations, or aggregations through transparent verification steps. For example, the zk-STARKs protocol can model system-wide compliance metrics, such as aggregated patch statuses or incident response times, as polynomial commitments by encoding the underlying data points (e.g., individual patch compliance percentages or time values) into numerical representations, constructing polynomials that interpolate these numerical values using techniques such as Lagrange interpolation or other polynomial construction methods over a finite field, and/or evaluating relationships or conditions using cryptographic transformations, such as polynomial equality checks or zero-testing.

In some implementations, the one or more processing circuits can generate the at least one token based at least on embedding the at least one ZKP into a structured data object. That is, the one or more processing circuits can construct a data object containing the ZKP alongside associated metadata, such as a reference to the compliance parameter being validated, a timestamp, or identifiers linking the token (e.g., attestation token, protectability token, etc.) to an entity or third party. In some implementations, the one or more processing circuits can, responsive to a data exchange between one or more nodes of a decentralized network, centralized network, or data source, provide the at least one ZKP. That is, a data exchange can include or refer any transmission, retrieval, or sharing of data, proofs, or any messages between computing systems, devices, entities, or third parties across one or more communication channels. For example, a data exchange can include transmitting a request or response, outputting a result of a cyber operation, providing validation results, querying or updating a database, changing a device setting, transmitting cryptographic proofs, interacting with interfaces or APIs, and/or so on. In some implementations, the data exchange corresponds to a transfer of at least a portion of the cyber resilience data. For example, the portion can include any subset, derivative, or representation of the cyber resilience data, such as selected attributes, transformed values, metadata, or cryptographic proofs generated from the data. In some examples, the transfer can include direct or indirect exchanges of portions of the cyber resilience data in varying forms (e.g., summarized, aggregated, hashed, encrypted, or tokenized representations).

### Configuration of Exemplary Implementations

While this specification contains many specific implementation details and implementation details, these should not be construed as limitations on the scope of any inventions or of what can be claimed, but rather as descriptions of features specific to particular implementations and implementations of the systems and methods described herein. Certain features that are described in this specification in the context of separate implementations and implementations can also be implemented and arranged in combination in a single implementation and implementation. Conversely, various features that are described in the context of a single implementation and implementation can also be implemented and arranged in multiple implementations and implementations separately or in any suitable subcombination. Moreover, although features can be described above as acting in certain combinations and even initially claimed as such, one or more features from a claimed combination can in some cases be excised from the combination, and/or the claimed combination can be directed to a subcombination or variation of a subcombination.

Additionally, features described with respect to particular headings can be utilized with respect to and in combination with illustrative implementation described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing can be advantageous. Moreover, the separation of various system components in the implementations and implementations described above should not be understood as requiring such separation in all implementations and implementations, and/or it should be understood that the described program components and systems can generally be integrated together in a single software product or packaged into multiple software products.

Having now described some illustrative implementations, implementations, illustrative implementations, and/or implementations it is apparent that the foregoing is illustrative and not limiting, having been presented by way of example. In particular, although many of the examples presented herein involve specific combinations of method acts or system elements, those acts, and/or those elements can be combined in other ways to accomplish the same objectives. Acts, elements and features discussed only in connection with one implementation and implementation are not intended to be excluded from a similar role in other implementations or implementations.

The phraseology and terminology used herein is for the purpose of description and should not be regarded as limiting. The use of “including” “including” “having” “containing” “involving” “characterized by” “characterized in that” and variations thereof herein, is meant to encompass the items listed thereafter, equivalents thereof, and/or additional items, as well as alternate implementations and implementations consisting of the items listed thereafter exclusively. In one implementation, the systems and methods described herein consist of one, at least one (e.g., each) combination of more than one, or all of the described elements, acts, or components.

Any references to implementations, implementations, or elements or acts of the systems and methods herein referred to in the singular can also embrace implementations and implementations including a plurality of these elements, and/or any references in plural to any implementation, implementation, or element or act herein can also embrace implementations and implementations including only a single element. References in the singular or plural form are not intended to limit the presently disclosed systems or methods, their components, acts, or elements to single or plural configurations. References to any act or element being based on any information, act or element can include implementations and implementations where the act or element is based at least in part on any information, act, or element.

Any implementation disclosed herein can be combined with any other implementation, and/or references to “an implementation,” “some implementations,” “an alternate implementation,” “various implementation,” “one implementation” or the like are not necessarily mutually exclusive and are intended to indicate that a particular feature, structure, or characteristic described in connection with the implementation can be included in at least one implementation. Such terms as used herein are not necessarily all referring to the same implementation. Any implementation can be combined with any other implementation, inclusively or exclusively, in any manner consistent with the aspects and implementations disclosed herein.

Any implementation disclosed herein can be combined with any other implementation, and/or references to “an implementation,” “some implementations,” “an alternate implementation,” “various implementations,” “one implementation” or the like are not necessarily mutually exclusive and are intended to indicate that a particular feature, structure, or characteristic described in connection with the implementation can be included in at least one implementation. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and/or all of the described terms.

Where technical features in the drawings, detailed description or any claim are followed by reference signs, the reference signs have been included for the sole purpose of increasing the intelligibility of the drawings, detailed description, and/or claims. Accordingly, neither the reference signs nor their absence have any limiting effect on the scope of any claim elements.

The systems and methods described herein can be implemented in other specific forms without departing from the characteristics thereof. Although the examples provided herein relate to controlling the display of content of information resources, the systems and methods described herein can include applied to other environments. The foregoing implementations and implementations are illustrative rather than limiting of the described systems and methods. Scope of the systems and methods described herein is thus indicated by the appended claims, rather than the foregoing description, and/or changes that come within the meaning and range of equivalency of the claims are embraced therein.

What is claimed is:

1. A method, comprising:
receiving or identifying, by one or more processing circuits, at least one token comprising cyber resilience data of at least one entity, the cyber resilience data corresponding with at least one posture or compliance parameter of at least one third party;
performing, by the one or more processing circuits, a zero-knowledge proof (ZKP) on the cyber resilience data by:
determining at least one posture or compliance parameter of the at least one third party is satisfied based on the cyber resilience data; and
generating at least one ZKP of the cyber resilience data, wherein the at least one ZKP comprises at least one cryptographic commitment obfuscating the cyber resilience data; and
providing, by the one or more processing circuits to at least one third party computing system of the at least one third party, the at least one ZKP or indication of performance of the at least one ZKP.

2. The method of claim 1, wherein the cyber resilience data corresponds with attestation data, safeguard data, incident data, effectiveness data, or protectability data of the at least one entity, and wherein the at least one cryptographic commitment verifies the at least one posture or compliance parameter is satisfied and protects the attestation data, safeguard data, incident data, effectiveness data, or protectability data.

3. The method of claim 1, wherein the at least one token comprises at least one of a unified attestation token, a unified safeguard token, an incident readiness token, an effectiveness token, or a protectability token, and wherein the cyber resilience data obfuscated by the at least one ZKP comprises one or more configurations of security controls, internal compliance reports or assessments, or incident histories and responses.

4. The method of claim 1, further comprising:
receiving, by the one or more processing circuits via an application programming interface (API), a verification request comprising the at least one posture or compliance parameter of the at least one third party; and
transmitting, by the one or more processing circuits via the API, a response to the verification request comprising the at least one ZKP or the indication of performance of the at least one ZKP to a third party computing system of the at least one third party;
wherein the API restricts access between a public environment and the cyber resilience data of a protected environment, and wherein the public environment corresponds to a plurality of third party computing systems, and wherein the protected environment comprises the one or more processing circuits and communication is restricted based at least on (i) transmitting the response comprising the ZKP and (ii) protecting the cyber resilience data from the public environment.

5. The method of claim 1, wherein determining the at least one posture or compliance parameter is satisfied based at least on:
modeling, by the one or more processing circuits, one or more attributes of the cyber resilience data and one or more values or conditions corresponding with the at least one posture or compliance parameter to determine the one or more attributes satisfy the one or more values or conditions.

6. The method of claim 1, wherein generating the at least one ZKP comprises:
determining, by the one or more processing circuits, one or more attributes of the cyber resilience data corresponding to the at least one posture or compliance parameter;
applying, by the one or more processing circuits, one or more transformations, logical operations, or aggregations to one or more attributes;
hashing, by the one or more processing circuits, the one or more attributes; and
generating, by the one or more processing circuits, the at least one cryptographic commitment based on the one or more attributes and the one or more transformations, logical operations, or aggregations.

7. The method of claim 6, further comprising:
validating, by the one or more processing circuits, the at least one ZKP based at least one on cross-referencing the at least one cryptographic commitment with one or more expected values derived from the one or more transformations, logical operations, or aggregations.

8. The method of claim 6, wherein generating the at least one ZKP comprises:
applying, by the one or more processing circuits, at least one of a zero-knowledge succinct non-interactive arguments of knowledge (zk-SNARKs) protocol or a zero-knowledge scalable transparent arguments of knowledge (zk-STARKS) protocol.

9. The method of claim 1, further comprising;
generating, by the one or more processing circuits, the at least one token based at least on embedding the at least one ZKP into a structured data object; or
responsive to a data exchange between one or more nodes of a decentralized network, centralized network, or data source, providing, by the one or more processing circuits, the at least one ZKP, wherein the data exchange corresponds to a transfer of at least a portion of the cyber resilience data.

10. A system, comprising:
one or more processing circuits configured to:
receive or identify at least one token comprising cyber resilience data of at least one entity, the cyber resilience data corresponding with at least one posture or compliance parameter of at least one third party;
perform a zero-knowledge proof (ZKP) on the cyber resilience data, wherein the one or more processing circuits:
determine at least one posture or compliance parameter of the at least one third party is satisfied based on the cyber resilience data; and
generate at least one ZKP of the cyber resilience data, wherein the at least one ZKP comprises at least one cryptographic commitment obfuscating the cyber resilience data; and
provide, to at least one third party computing system of the at least one third party, the at least one ZKP or indication of performance of the at least one ZKP.

11. The system of claim 10, wherein the cyber resilience data corresponds with attestation data, safeguard data, incident data, effectiveness data, or protectability data of the at least one entity, and wherein the at least one cryptographic commitment verifies the at least one posture or compliance parameter is satisfied and protects the attestation data, safeguard data, incident data, effectiveness data, or protectability data.

12. The system of claim 10, wherein the at least one token comprises at least one of a unified attestation token, a unified safeguard token, an incident readiness token, an effectiveness token, or a protectability token, and wherein the cyber resilience data obfuscated by the at least one ZKP comprises one or more configurations of security controls, internal compliance reports or assessments, or incident histories and responses.

13. The system of claim 10, the one or more processing circuits further configured to:
receive, via an application programming interface (API), a verification request comprising the at least one posture or compliance parameter of the at least one third party; and
transmit, via the API, a response to the verification request comprising the at least one ZKP or the indication of performance of the at least one ZKP to a third party computing system of the at least one third party;
wherein the API restricts access between a public environment and the cyber resilience data of a protected environment, and wherein the public environment corresponds to a plurality of third party computing systems, and wherein the protected environment comprises the one or more processing circuits and communication is restricted based at least on (i) transmitting the response comprising the ZKP and (ii) protecting the cyber resilience data from the public environment.

14. The system of claim 10, wherein to determine the at least one posture or compliance parameter is satisfied, the one or more processing circuits are configured to:
model one or more attributes of the cyber resilience data and one or more values or conditions corresponding with the at least one posture or compliance parameter to determine the one or more attributes satisfy the one or more values or conditions.

15. The system of claim 10, wherein to generate the at least one ZKP, the one or more processing circuits are configured to:
determine one or more attributes of the cyber resilience data corresponding to the at least one posture or compliance parameter;
apply one or more transformations, logical operations, or aggregations to one or more attributes;
hash the one or more attributes; and
generate the at least one cryptographic commitment based on the one or more attributes and the one or more transformations, logical operations, or aggregations.

16. The system of claim 15, the one or more processing circuits further configured to:
validate the at least one ZKP based at least one on cross-referencing the at least one cryptographic commitment with one or more expected values derived from the one or more transformations, logical operations, or aggregations.

17. The system of claim 15, wherein to generate the at least one ZKP, the one or more processing circuits are further configured to:
apply at least one of a zero-knowledge succinct non-interactive arguments of knowledge (zk-SNARKs) protocol or a zero-knowledge scalable transparent arguments of knowledge (zk-STARKS) protocol.

18. The system of claim 10, the one or more processing circuits further configured to:
generate the at least one token based at least on embedding the at least one ZKP into a structured data object; or
responsive to a data exchange between one or more nodes of a decentralized network, centralized network, or data source, provide the at least one ZKP, wherein the data exchange corresponds to a transfer of at least a portion of the cyber resilience data.

19. A non-transitory computer-readable medium (CRM) comprising one or more instructions stored thereon and executable by one or more processors to:
receive or identify at least one token comprising cyber resilience data of at least one entity, the cyber resilience data corresponding with at least one posture or compliance parameter of at least one third party;
perform a zero-knowledge proof (ZKP) on the cyber resilience data by:
determining at least one posture or compliance parameter of the at least one third party is satisfied based on the cyber resilience data; and
generating at least one ZKP of the cyber resilience data, wherein the at least one ZKP comprises at least one cryptographic commitment obfuscating the cyber resilience data; and
provide, to at least one third party computing system of the at least one third party, the at least one ZKP or indication of performance of the at least one ZKP.

20. The non-transitory CRM of claim 19, wherein the cyber resilience data corresponds with attestation data, safeguard data, incident data, effectiveness data, or protectability data of the at least one entity, and wherein the at least one cryptographic commitment verifies the at least one posture or compliance parameter is satisfied and protects the attestation data, safeguard data, incident data, effectiveness data, or protectability data.
